(19) United States
(12) Patent Application Publication
(10) Pub. No.: US 2007/0207298 A1
(43) Pub. Date: Sep. 6, 2007

(54) Optical film, anti-reflection film, polarizing plate and image display device

(75) Inventors: Takato Suzuki, Minami-Ashigara-shi (JP); Tetsuya Asakura, Minami-Ashigara-shi (JP); Jun Watanabe, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/712,544

(22) Filed: Mar. 1, 2007

(30) Foreign Application Priority Data
Mar. 2, 2006 (JP) 2006-056764

(51) Int. Cl. B32B 7/02

(52) U.S. Cl. 428/216

(57) ABSTRACT

An optical film, which comprises: a transparent support; and an optical layer on or above the transparent support, wherein the optical layer contains a thickening agent which shows a viscosity of 10 mPa·sec or more when added to 2-butanone in a content of 3% by mass, and the optical layer has a thickness of 5 μm or more.

### BACKGROUND OF THE INVENTION

1. Field of the Invention

The present invention relates to an optical film, anti-reflection film, a polarizing plate and an image display device using them.

2. Description of the Related Art

In recent years, development of materials using various coating methods has advanced and, particularly, techniques of forming a thin layer of a level of from several μm to several ten nm are required in the field of optical films, printing and photo-lithography. The required coating accuracy has been increased with reduction in film thickness, increase in size of substrates and increase in coating speed. In particular, in the production of optical films, control of film thickness is an extremely important point that dominates optical performance, and there has been an increasing demand for a technique which can realize high-speed coating with maintaining accuracy at a high level.

Of the optical films, an anti-reflection film is generally disposed over the outermost surface of a display device so as to reduce reflectance based on the principle of optical interference for the purpose of preventing reduction of contrast due to reflection of external light or reflection of undesired images in its screen in an image display device such as a cathode ray tube display device (CRT), a plasma display device (PDP), an electroluminescence display (ELD) or a liquid crystal display device (LCD). Also, in order to reduce undesired image reflection, an anti-glare film having formed on the surface thereof fine unevenness is used as one kind of an anti-reflection film over the surface of a display. A film having both anti-glare properties and anti-reflection properties is also being used.

In recent years, with diffusion of display devices having a larger depth and a larger display area than that of conventional CRTs, display devices displaying finer images with more image quality have been desired. Thus, surface uniformity of the anti-reflection film is strongly demanded. The term “surface uniformity” as used herein means that there exist almost no unevenness in optical performance represented by anti-reflection performance and almost no unevenness of physical properties of film such as scratch resistance within the whole screen of the display device. It has also been strongly required in recent years for the display device to be difficultly scratched on the surface thereof, i.e., for the anti-reflection film to have a good scratch resistance.

As processes for producing the anti-reflection film, there is illustrated a process of inorganic vacuum deposition as described with respect to anti-glare, anti-reflection films excellent in gas barrier properties, anti-glare properties and anti-reflection properties using a silicon oxide film formed by CVD. In view of mass productivity, however, a process of producing the anti-reflection film by all-wet coating is advantageous.

However, although the all-wet coating using a solvent is extremely advantageous in view of productivity, it is extremely difficult to maintain drying of the solvent immediately after coating at a constant level, and there tends to result surface non-uniformity. The term “surface non-uniformity” as used herein means drying non-uniformity caused by difference in solvent-drying speed and non-uniformity in thickness caused by drying air.

As means for reducing non-uniformity upon coating, there has been proposed a technique of adding a surfactant or a thickening agent to a coating composition (JP-A-2004-163610).

However, although a uniform film is formed due to leveling effect by adding a surfactant to a coating composition, the surface free energy of a coated film formed after drying becomes so low that there have been problems that, when the surface is stuck onto other material or when the surface is further coated, adhesion at the interface becomes weak and scratch resistance is deteriorated. Also, in the case of adding a thickening agent, addition of a large amount of the thickening agent is required in order to obtain a desired viscosity and, as a result, there has been a problem that the film hardness is decreased. Further, when a thickening agent is added in a large amount to a coating composition containing fine particles for forming an anti-glare film, there has been involved a problem that the surface glistens white all over in a bright room (hereinafter referred to as “white glistening”) in the case of applying the anti-glare film to the surface of a display device.

### SUMMARY OF THE INVENTION

The aspects of the present invention are to provide:

(1) an optical film which achieves both high surface uniformity with decreasing drying unevenness and wind unevenness and sufficient scratch resistance,

(2) an antireflection film which achieves both sufficient anti-reflection ability and scratch resistance in addition to surface uniformity,

(3) a high-speed coating production process which enable to obtain the above antireflection film with high productivity, and

(4) a polarizing plate and an image display device using the optical film or the antireflection film.

The inventors have found that a coating composition can be obtained which can be uniformly coated, which can reduce drying non-uniformity and non-uniformity in thickness caused by drying air, and which ensures film hardness, by using a thickening agent that satisfies specific thickening performance and using as the thickening agent a thixotropic agent or a high molecular polymer having a mass-average molecular mass of from 500,000 to 5,000,000 in terms of polystyrene (hereinafter referred to as “ultra-high molecular mass polymer”). The inventors have also found that an optical film (particularly, anti-reflection film) which does not generate white glistening upon a thickening agent being used can be obtained by controlling the particle size of fine particles and the film thickness within appropriate ranges. Further, the inventors have found a novel process for producing an anti-reflection film having a high surface uniformity with a high productivity by using a coating composition containing the above-mentioned thickening agent and coating plural layers at the same time.

The aspects of the invention can be attained by the optical film, the anti-reflection film, the polarizing plate and the image display device having the following constitutions, respectively.

(1) An optical film, which comprises:

a transparent support; and

an optical layer on or above the transparent support,

wherein the optical layer contains a thickening agent which shows a viscosity of 10 mPa·sec or more when added to 2-butanone in a content of 3% by mass, and

the optical layer has a thickness of 5 μm or more.

(2) The optical film as described in (1) above,

wherein the thickening agent is a thixotropic agent, and

the optical layer contains the thixotropic agent in a content of from 0.01 to 5% by mass.

(3) The optical film as described in (1) above,

wherein the thickening agent is a high molecular mass polymer of from 500,000 to 5,000,000 in mass-average molecular mass, and

the optical layer contains the high molecular polymer in a content of from 0.01 to 5% by mass.

(4) The optical film as described in any of (1) to (3) above,

wherein the optical layer contains light-transmitting particles having an average particle size of from 5 to 15 μm.

(5) The optical film as described in any of (1) to (4) above,

wherein the thickness of the optical layer is from 5 to 20 μm.

(6) The optical film as described in any of (1) to (5) above, which has a surface haze of 7% or less and an internal haze of 30% or less.

(7) An anti-reflection film, which comprises:

an optical film as described in any of (1) to (6) above that comprises a hard coat layer as the optical layer; and

a low refractive index layer on or above the hard coat layer.

(8) A process for producing an optical film, which comprises:

forming an optical film as described in any of (1) to (6) by coating.

(9) A process for producing an anti-reflection film, which comprises:

forming an anti-reflection film as described in (7) above by coating.

(10) The process for producing an anti-reflection film as described in (9) above,

wherein the hard coat layer and the low refractive index layer are formed at once without winding up.

(11) The process for producing an anti-reflection film as described in (10) above,

wherein the hard coat layer is coated on the transparent support using a slot die while the transparent support is allowed to run continuously on a supporting backup roller, and

the low refractive index layer is coated on the hard coat layer using a slide type coating head disposed in a vicinity of a tip of the slot die.

(12) A polarizing plate, which comprises:

a pair of protective films; and

a polarizing film between the pair of protective films,

wherein at least one of the pair of protective films is an optical film as described in any of (1) to (6) above or an optical film produced according to a process for producing an optical film as described in (8) above.

(13) A polarizing plate, which comprises:

a pair of protective films; and

a polarizing film between the pair of protective films,

wherein at least one of the pair of protective films is an anti-reflection film as described in (7) above or an anti-reflection film produced according to a process for producing an optical film as described in (10) or (11) above.

(14) An image display device, which comprises an optical film or an anti-reflection film as described in any of (1) to (7) above, an optical film or an anti-reflection film produced by a process for producing an optical film or an anti-reflection film as described in any of (8) to (11) above or a polarizing plate as described in (12) or (13) above on a viewing side of a display screen.

(15) The image display device as described in (14) above,

wherein a diagonal of the display screen is 20 inches or more.

### BRIEF DESCRIPTION OF THE DRAWINGS

FIG. 1 is a schematic cross-sectional view schematically showing a preferred exemplary embodiment of the invention;

FIG. 2 is a schematic cross-sectional view schematically showing a preferred exemplary embodiment of the invention;

FIG. 3 is a schematic cross-sectional view schematically showing a preferred exemplary embodiment of the invention;

FIG. 4 is a schematic cross-sectional view schematically showing a preferred exemplary embodiment of the invention;

FIG. 5 is a schematic cross-sectional view schematically showing a preferred exemplary embodiment of the invention;

FIG. 6 is a cross-sectional view of a coater 10 using a slot die 13 with which the invention is performed;

FIG. 7A shows a cross section of the slot die 13 of the invention, and FIG. 7B shows a cross section of a conventional slot die 30;

FIG. 8 is a perspective view showing the slot die 13 and portions around it in the coating step performing the invention; and

FIG. 9 is a cross-sectional view showing a pressure-reduced chamber 40 in the vicinity of a web W and the web W (a back plate 40a being integrated with the chamber 40),

wherein (1) denotes support; (2) denotes hard coat layer; (3) denotes middle refractive index layer; (4) denotes high refractive index layer; (5) denotes low refractive index layer; 10 denotes coater; 11 denotes backup roll; W denotes web; 13 denotes slot die; 14 denotes coating solution; 14a denotes bead; 14b denotes coated film; 15, 50 denote pockets; 16, 52 denote slots; 16a, 52a denote slot openings; 17 denotes tip lip; 18 denotes land; 18a denotes upstream side lip land; 18b denotes downstream side lip land; I_{UP} denotes land length of upstream side lip land 18a; I_{LO} denotes land length of downstream side lip land 18b; LO denotes over bite length (difference between the length between downstream lip land 18b and web W and the length between the upstream lip land 18a and web W); G_{L} denotes gap between the tip lip 17 and the web W (gap between the downstream lip land 18b and the web W); 30 denotes conventional slot die; 31a denotes upstream lip land; 31b denotes downstream lip land; 32 denotes pocket; 33 denotes slot; 40 denotes pressure-reduced chamber; 40a denotes back plate; 40b denotes side plate; 51 denotes slide; 55 denotes cover; G_{B} denotes gap between the back plate 40a and the web W; and G_{S} denotes gap between the side plate 40b and the web W.

### DETAILED DESCRIPTION OF THE INVENTION

The invention will be described in more detail below. Additionally, in this specification, in the case where numerals represent physical values or characteristic values, descriptions of “from (numeral 1) to (numeral 2)” mean “equal to (numeral 1) or more and equal to (numeral 2) or less”. Also, in this specification, a description of “(meth)acrylate” means “at least either of acrylate and methacrylate”. The same applies to “(meth)acrylic acid”, etc.

The optical film of the invention (hereinafter, also referred to merely as “film” in some cases) comprises a transparent support having provided thereon an optical layer, which film is characterized in that the optical layer contains a specific thickening agent, a thixotropic agent or an ultra-high molecular mass polymer.

In the invention, the optical layer containing a specific thickening agent, a thixotropic agent or an ultra-high molecular mass polymer is a layer exhibiting optical functions and is particularly preferably an anti-glare layer (light-diffusing layer) or a hard coat layer which is required to have a high surface uniformity.

The thickness of the optical layer is not particularly limited as long as it is 5 μm or more, and is preferably from 5 to 20 μm, more preferably from 8 to 17 μm, still more preferably from 10 to 15 μm. In case when the thickness of the optical layer is less than 5 μm, strength of the optical film can become insufficient, thus such thickness not being preferred.

The particle size of the light-transmitting particles contained in the anti-glare layer is preferably from 5 to 15 μm, more preferably from 5 to 12 μm, still more preferably from 5 to 10 μm. Also, the surface haze of the optical film is preferably 7% or less, more preferably from 1% to 7%, most preferably from 2% to 6.5%. The internal haze of the optical film is 35% or less, preferably 30% or less, more preferably from 1% to 30%, still more preferably from 2% to 25%. Particularly in the case of adding the light-transmitting particles, generation of white glistening can be suppressed even when a thickening agent is used, by adjusting them within the above-described ranges.

The constitution of the optical film of the invention will be described in detail below.

### 1. Layer Structure of the Film

Regarding the film of the invention, a known layer structure may be employed using the above-mentioned optical layer. For example, there are illustrated the following ones as typical examples.

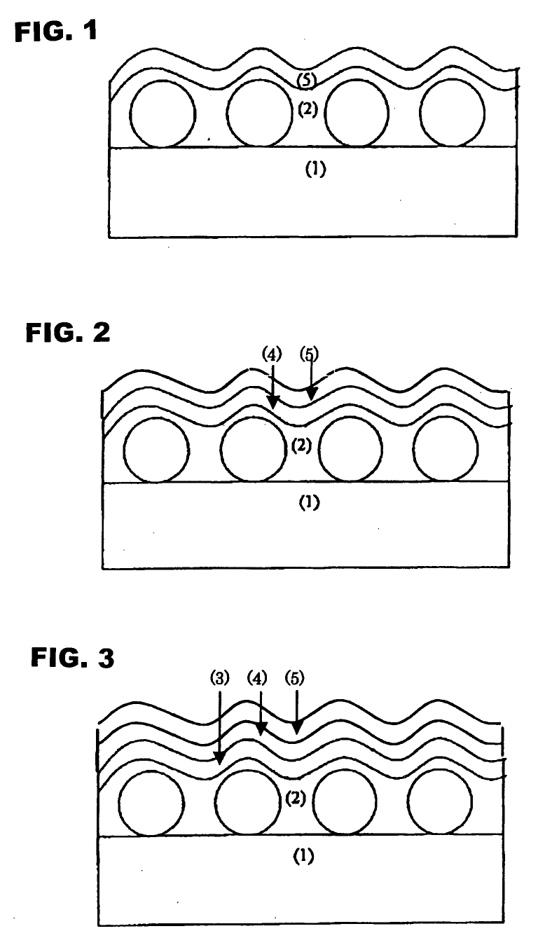

a. transparent support/hard coat layer
b. transparent support/hard coat layer/low refractive index layer (FIG. 1)
c. transparent support/hard coat layer/high refractive index layer/low refractive index layer (FIG. 2)
d. transparent support/hard coat layer/middle refractive index layer/high refractive index layer/low refractive index layer (FIG. 3)

When a low refractive index layer (5) is laminated on a hard coat layer (2) formed on a support (1) by coating as shown in b (FIG. 1), the resulting film can preferably be used as an anti-reflection film. The surface reflection can be reduced by forming the low refractive index layer (5) in a thickness of about ¼ of the wavelength of light on the hard coat layer (2) based on the principle of thin film interference. (Hereinafter, of the optical films of the invention, those films which have an anti-reflection layer (low refractive index layer, middle refractive index layer or high refractive index layer) on the hard coat layer are specifically referred to as “anti-reflection films”.)

Also, when a high refractive index layer (4) and a low refractive index layer (5) are laminated on the hard coat layer (2) formed on the support (1) by coating as shown in c (FIG. 2), the resulting film can preferably be used as an anti-reflection film. Further, the reflectance can be reduced to 1% or less by forming a layer structure wherein the support (1), the hard coat layer (2), the middle refractive index layer (3), the high refractive index layer (4) and the low refractive index layer (5) are disposed in this order as shown in d (FIG. 3).

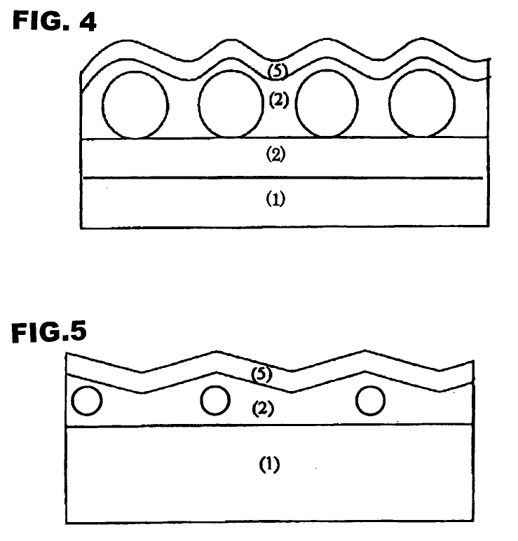

In the constitutions of a to d, the hard coat layer (2) can be an anti-glare layer having anti-glare properties. Anti-glare properties may be imparted by dispersing matt particles (6) as shown in FIG. 4 or by forming the surface profile by a method such as embossing. An anti-glare layer formed by dispersing the matt particles (6) comprises a binder and light-transmitting particles dispersed in the binder. The hard coat layer having anti-glare properties (anti-glare layer) preferably have both anti-glare properties and hard coat properties, and may be constituted by plural layers, for example, two to four layers.

Also, as a layer which may be provided between the transparent support and a layer on the surface side or on the outermost layer, there are illustrated an interference unevenness (rainbow unevenness) preventing layer, an antistatic layer (in the case where there is a demand from the display side to reduce surface resistance value or where deposition of dust on the surface matters), another hard coat layer (in the case where a single hard coat layer or anti-glare layer is insufficient to obtain sufficient hardness), a gas barrier layer, a water-absorbing layer (moisture-proof layer), an adhesion-improving layer and an anti-stain layer (stain-preventing layer).

The refractive index of each layer constituting the anti-glare, anti-reflection film having the anti-reflection layer in accordance with the invention preferably satisfies the following relationship:

refractive index of hard coat layer>refractive index of transparent support>refractive index of low refractive index layer.

Components constituting the optical film of the invention and function of each layer will be described in detail below.

### (Thickening Agent)

The thickening agent to be used in the invention is a compound which shows a viscosity of 10 [mPa·sec] or more at 25° C. when dissolved in a content of 3% by mass in 2-butanone. This viscosity is preferably 20 [mPa·sec] or more. Also, the viscosity of the coating composition is preferably 10 [mPa·sec] or more at 25° C., more preferably 25 [mPa·sec] or more, still more preferably 100 [mPa·sec] or more. (In this specification, mass ratio is equal to weight ratio.)

As to a method of measuring viscosity, viscosity at 60 rpm is measured using a commercially available rotation viscometer. For example, an E model viscometer (VISCONIC, model ED) manufactured by TOKIMEC INC. can be employed.

The thickening agent is not particularly limited as long as it has physical properties satisfying the above-described requirements. Examples thereof are illustrated below. Of them, ultra-high molecular mass polymers and thixotropic agents to be described in the next item and thereafter are particularly preferred.

### Poly-ε-caprolactone

### Poly-ε-caprolactone diol

### Poly-ε-caprolactone triol

### Polyvinyl acetate

### Poly(ethylene adipate)

### Poly(1,4-butylene adipate)

### Poly(1,4-butylene glutarate)

### Poly(1,4-butylene succinate)

### Poly(1,4-butylene terephthalate)

### Poly(ethylene terephthalate)

### Poly(2-methyl-1,3-propylene adipate)

### Poly(2-methyl-1,3-propylene glutarate)

### Poly(neopentylglycol adipate)

### Poly(neopentylglycol sebacate)

### Poly(1,3-propylene adipate)

### Poly(1,3-propylene glutarate)

### Polyvinyl butyral

### Polyvinyl formal

### Polyvinyl acetal

### Polyvinyl propanal

### Polyvinyl hexanal

### Polyvinylpyrrolidone

### Polyacrylic ester

### Polymethacrylic ester

### Cellulose acetate

### Cellulose propionate

### Cellulose acetate butyrate

### (Ultra-high molecular mass polymer)

The high molecular mass polymer of 500,000 to 5,000,000 in mass-average molecular mass (in some cases referred to as “ultra-high molecular mass polymer) in accordance with the invention will be described in detail below.

The value of mass-average molecular mass of the ultra-high molecular mass polymer in accordance with the invention is a molecular mass in terms of polystyrene measured by means of a GPC analyzer using columns of TSK gel GMHxL, TSK gel G4000HxL and TSK gel G2000HxL (all manufactured by Toso K.K.) and using tetrahydrofuran (THF) as a solvent and a differential refractometer for detection. The measurement was conducted at 40° C. using a solution of from 0.01 to 1% by mass, preferably from 0.03 to 0.5% by mass, in concentration of solids in a solvent soluble in THF.

The ultra-high molecular mass polymer which can be used in the invention is not limited as to its structure. Any of polyesters, polyamides and polyimides obtained by polycondensation reaction, polymers obtained by addition polymerization reaction of ethylenically unsaturated monomers, and polymers obtained by polyaddition reaction, addition condensation reaction or ring-opening polymerization can be used.

Of these reactions, addition polymerization reaction which proceeds in a chain-like manner is advantageous for obtaining a high molecular mass polymer and, as to type of polymerization, any of radical polymerization, cationic polymerization and anionic polymerization may be utilized. As the ultra-high molecular mass polymer to be used in the invention, a polymer which can be obtained by the addition polymerization process and which contains a repeating unit derived from an ethylenically unsaturated monomer is preferred. The polymer may be a polymer obtained from any one monomer freely selected from the monomer group illustrated below or a copolymer obtained from plural monomers. Usable monomers are not particularly limited, and those which can undergo usual radical polymerization, cationic polymerization or anionic polymerization can favorably be used.

### Monomer Groups

### (1) Alkenes

Ethylene, propylene, 1-butene, isobutene, 1-hexene, 1-dodecene, 1-octadecene, 1-eicosene, hexafluoropropene, vinylidene fluoride, chlorotrifluoroethylene, 3,3,3-trifluoropropylene, tetrafluoroethylene, vinyl chloride, vinylidene chloride, etc.

### (2) Dienes

1,3-Butadiene, isoprene, 1,3-pentadiene, 2-ethyl-1,3-butadiene, 2-n-propyl-1,3-butadiene, 2,3-dimethyl-1,3-butadiene, 2-methyl-1,3-pentadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chlorobutadiene, 2-fluoro-1,3-butadiene, 2,3-dichloro-1,3-butadiene, 1,1,2-trichloro-1,3-butadiene, 2-cyano-1,3-butadiene, 1,4-divinylcyclohexane, etc.

### (3) Derivatives of α,β-Unsaturated Carboxylic Acids

(3a) Alkyl Acrylates

Methyl acrylate, ethyl acrylate, n-propyl acrylate, isopropyl acrylate, n-butyl acrylate, isobutyl acrylate, sec-butyl acrylate, tert-butyl acrylate, amyl acrylate, n-hexyl acrylate, cyclohexyl acrylate, 2-ethylhexyl acrylate, n-octyl acrylate, tert-octyl acrylate, dodecyl acrylate, phenyl acrylate, benzyl acrylate, 2-chloroethyl acrylate, 2-bromoethyl acrylate, 4-chlorobutyl acrylate, 2-cyanoethyl acrylate, 2-acetoxyethyl acrylate, methoxybenzyl acrylate, 2-chlorocyclohexyl acrylate, furfuryl acrylate, tetrahydrofurfuryl acrylate, 2-methoxyethyl acrylate, ω-methoxypolyethylene glycol acrylate (addition mol number of polyoxyethylene: n=2 to 100), 3-methoxybutyl acrylate, 2-ethoxyethyl acrylate, 2-butoxyethyl acrylate, 2-(2-butoxyethoxy)ethyl acrylate, 1-bromo-2-methoxyethyl acrylate, 1,1-dichloro-2-ethoxyethyl acrylate, glycidyl acrylate, etc.

(3b) Alkyl Methacrylates

Methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methoacrylate, n-hexyl methacrylate, cyclohexyl methacrylate, 2-ethylhexyl methacrylate, n-octyl methacrylate, stearyl methacrylate, benzyl methacrylate, phenyl methacrylate, allyl methacrylate, furfuryl methacrylate, tetrahydrofurfuryl methacrylate, cresyl methacrylate, naphthyl methacrylate, 2-methoxyethyl methacrylate, 3-methoxybutyl methacrylate, ω-methoxypolyethylene glycol methacrylate (addition mol number of polyoxyethylene: n=2 to 100), 2-acetoxyethyl methacrylate, 2-ethoxyethyl methacrylate, 2-butoxyethyl methacrylate, 2-(2-butoxyethoxy)ethyl methacrylate, glycidyl methacrylate, 3-trimethoxysilylpropyl methacrylate, allyl methacrylate, 2-ospcyanatoethyl methacrylate, etc.

(3c) Diesters of Unsaturated Polycarboxylic Acids

Dimethyl maleate, dibutyl maleate, dimethyl itaconate, dibutyl itaconate, dibutyl crotonate, dihexyl crotonate, diethyl fumarate, dimethyl fumarate, etc.

(3e) Amides of α,β-Unsaturated Carboxylic Acids

N,N-Dimethylacrylamide, N,N-diethylacrylamide, N-n-propylacrylamide, N-tert-butylacrylamide, N-tert-octyl-methacrylamide, N-cyclohexylacrylamide, N-phenylacrylamide, N-(2-acetoacetoxyethyl)acrylamide, N-benzylacrylamide, N-acryloylmorpholine, diacetoneacrylamide, N-methylmaleimide, etc.

### (4) Unsaturated Nitriles

Acrylonitrile, methacrylonitrile, etc.

### (5) Styrene and Derivatives Thereof

Styrene, vinyltoluene, ethylstyrene, p-tert-butylstyrene, methyl p-vinylbenzoate, α-methylstyrene, p-chloromethylstyrene, vinylnaphthalene, p-methoxystyrene, p-hydroxymethylstyrene, p-acetoxystyrene, etc.

### (6) Vinyl Esters

Vinyl acetate, vinyl propionate, vinyl butyrate, vinyl isobutyrate, vinyl benzoate, vinyl salicylate, vinyl chloroacetate, vinyl methoxyacetate, vinyl phenylacetate, etc.

### (7) Vinyl Ethers

Methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, n-dodecyl vinyl ether, n-eicosyl vinyl ether, 2-ethylhexyl vinyl ether, cyclohexyl vinyl ether, fluorobutyl vinyl ether, fluorobutoxyethyl vinyl ether, etc.

### (8) Other Polymerizable Monomers

N-vinylpyrrolidone, methyl vinyl ketone, phenyl vinyl ketone, methoxyethyl vinyl ketone, 2-vinyloxazoline, 2-isopropenyloxazoline, etc.

Also, as preferred examples of the ultra-high molecular mass polymers, there are illustrated polymers having polymerization units represented by the following formula [I]:

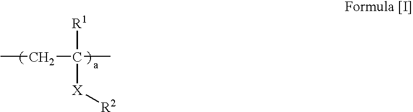

In the formula [I], X represents a single bond or a divalent linking group represented by *—COO—**, *—OCO—**, *—CON(R³)—** or *—O—**, with a divalent linking group being preferred. Here, * represents a position at which the linking group is connected to the carbon atom, and ** represents a position at which the linking group is connected to R².

R¹ represents a hydrogen atom, an alkyl group containing from 1 to 8 carbon atoms, a fluorine atom or a chlorine atom, more preferably a hydrogen atom, an alkyl group containing from 1 to 4 carbon atoms or a fluorine atom, still more preferably a hydrogen atom or a methyl group.

R² and R³ each independently represents a hydrogen atom, a straight-chain, branched or cyclic alkyl group containing from 1 to 20 carbon atoms and optionally having a substituent, an alkyl group containing a poly(alkyleneoxy) group or an aromatic group containing from 6 to 30 carbon atoms and optionally having a substituent, preferably a straight-chain, branched or cyclic alkyl group containing from 1 to 12 carbon atoms and optionally having a substituent or an aromatic group containing from 6 to 20 carbon atoms and optionally having a substituent. a represents a mass ratio of each polymerization unit and, when the polymer comprises a single kind of monomer, a represents 100.

Also, a copolymer obtained by using two or more kinds of monomers different from each other in any of R¹, R², R³ and X in the formula [I] may be used.

Substituents which R² and R³ may optionally have are not particularly limited and are exemplified by a halogen atom (fluorine, chlorine, bromine, etc.), a hydroxyl group, a mercapto group, a carboxyl group, an epoxy group, an alkyl group (methyl, ethyl, i-propyl, propyl, t-butyl, etc.), an aryl group (phenyl, naphthyl, etc.), an aromatic hetero ring group (furyl, pyrazolyl, pyridyl, etc.), an alkoxy group (methoxy, ethoxy, i-propoxy, hexyloxy, etc.), an aryloxy group (phenoxy, etc.), an alkylthio group (methylthio, ethylthio, etc.), an arylthio group (phenylthio, etc.), an alkenyl group (vinyl, 1-propenyl, etc.), an acyloxy group (acetoxy, acryloyloxy, methacryloyloxy, etc.), an alkoxycarbonyl group (methoxycarbonyl, ethoxycarbonyl, etc.), an aryloxycarbonyl group (phenoxycarbonyl, etc.), a carbamoyl group (carbamoyl, N-methylcarbamoyl, N,N-dimethylcarbamoyl, N-methyl-N-octylcarbamoyl, etc.), an acylamino group (acetylamino, benzoylamino, acrylamino, methacrylamino, etc.), etc. These substituents may further be substituted.

Specific examples of the ultra-high polymer having the polymerization unit represented by the formula [I] are illustrated below which, however, do not limit the invention in any way.

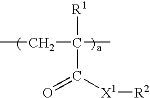

| | R¹ | X¹ | R² | Mw |
|---|---|---|---|---|
| P-1 | H | 0 | C2H5 | 8.8 × 10⁵ |
| P-2 | H | 0 | (n)C4H9 | 7.9 × 10⁵ |
| P-3 | H | 0 | (n)C8H17 | 9.1 × 10⁵ |
| P-4 | H | NH | (t)C4H9 | 6.2 × 10⁵ |
| P-5 | H | N-(n)C4H9 | (n)C4H9 | 7.7 × 10⁵ |
| P-6 | CH₃ | 0 | C2H5 | 1.0 × 10⁶ |
| P-7 | CH₃ | 0 | (n)C4H9 | 1.3 × 10⁶ |
| P-8 | CH₃ | 0 | (i)C4H9 | 1.5 × 10⁶ |
| P-9 | CH₃ | 0 | (t)C4H9 | 1.8 × 10⁶ |
| P-10 | CH₃ | 0 | —CH2CH(C2H5)(n)C4H9 | 8.1 × 10⁶ |
| P-11 | CH₃ | 0 | cyclohexyl | 9.7 × 10⁵ |
| P-12 | CH₃ | 0 | benzyl | 6.1 × 10⁵ |
| P-13 | CH₃ | 0 | (n)C12H25 | 1.0 × 10⁶ |
| P-14 | CH₃ | NH | (t)C4H9 | 7.3 × 10⁵ |
| P-15 | CH₃ | NH | (n)C6H13 | 5.9 × 10⁵ |
| P-16 | CH₃ | N-(n)C6H13 | (n)C6H13 | 8.6 × 10⁵ |
| P-17 | F | 0 | C2H5 | 1.0 × 10⁶ |
| P-18 | F | 0 | (t)C4H9 | 9.2 × 10⁶ |

| | Structure | Mw |
|---|---|---|
| P-19 | 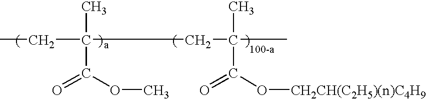 | 8.9 × 10⁵a = 30 |
| P-20 | 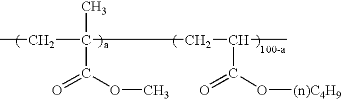 | 1.0 × 10⁶a = 25 |
| P-21 | 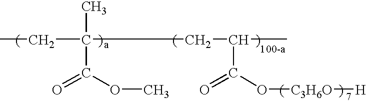 | 6.7 × 10⁶a = 90 |
| P-22 | 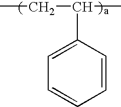 | 1.1 × 10⁶ |
| P-23 | 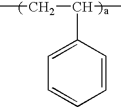 | 2.8 × 10⁶ |
| P-24 | 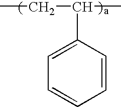 | 4.3 × 10⁶ |
| P-25 | 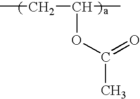 | 8.1 × 10⁵ |
| P-26 | 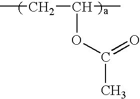 | 1.0 × 10⁶ |
| P-27 | 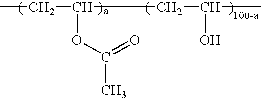 | 8.1 × 10⁵a = 95 |
| P-28 | 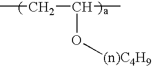 | 5.3 × 10⁵ |
| P-29 | 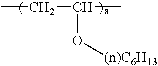 | 8.0 × 10⁵ |
| P-30 | 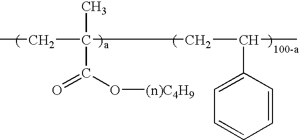 | 7.9 × 10⁵ |

Additionally, in the above table, a = 50 with P-30.

In the above chemical formulae, a represents a mass ratio of each polymerization unit and, with polymers comprising a single kind of monomer, a represents 100.

Polymerization processes for forming the ultra-high molecular mass polymer are not particularly limited but, as a preferred process, there is illustrated a living polymerization process wherein an active species is not deactivated. However, it has been known that, in conducting living polymerization, there exist such restrictions regarding production of the polymer as that chemical species which can deactivate the active species such as water, a nucleophilic species and oxygen must be sufficiently removed from the reaction system and that, since the reaction is a reaction in a solution, the viscosity of the reaction solution rapidly increases with generation of the high-molecular mass polymer. In view of less restrictions regarding production of the polymer, general radical polymerization reaction is preferred, and a solution polymerization process, an emulsion polymerization process, a suspension polymerization process or a bulk polymerization process can be employed. The radical polymerization process is described in, for example, “Kobunshi Kagaku Jikkenho” compiled by Kobunshi Gakkai (Tokyo Kagaku Dojin, 1981). Of the above-described processes, the solution polymerization process involves the problem that, when an ultra-high molecular mass polymer is synthesized by the solution polymerization process, the viscosity of the reaction solution so rapidly increases that it tends to become difficult to handle the reaction solution. On the other hand, the emulsion polymerization process is generally an advantageous process for obtaining the ultra-high molecular mass polymer, and is a preferred process for synthesizing the ultra-high molecular mass polymer to be used in the invention. Processes for synthesizing the ultra-high molecular mass polymer by emulsion polymerization are disclosed in, for example, JP-A-5-214006, JP-A-2000-256424 and JP-A-2001-106715, and ultra-high molecular mass polymers obtained by those processes can also be used as the ultra-high molecular mass polymer of the invention.

Monomers to be used for the emulsion polymerization are not particularly limited, and any monomer that can undergo emulsion polymerization can be used. In view of handling ease, monomers having a glass transition temperature (Tg) of room temperature or higher are preferred. However, the monomers are not particularly limited only to them. Also, in order to conduct emulsion polymerization, it is preferred for the monomer to be soluble in water to some extent. However, monomers having an extremely low solubility in water can undergo emulsion polymerization by adding a solvent which is soluble in water and which can dissolve the monomer, such as an alcohol. Further, even monomers which are solid at room temperature can be subjected to emulsion polymerization by using them in the form of a solution in a water-soluble solvent.

Therefore, the aforementioned monomers can preferably be used. Of them, acrylic acid derivatives, methacrylic acid derivatives, styrenes and vinyl esters are more preferred, with acrylic acid derivatives and methacrylic acid derivatives being still more preferred.

The ultra-high molecular mass polymer of the invention is characterized in that, in comparison with a low-molecular mass polymer of less than 100,000 in molecular mass, it can provide a large thickening effect in a small addition amount. It has generally been known that the relation between the intrinsic viscosity of a polymer and the molecular mass of the polymer is represented by the following formula, which teaches that the intrinsic viscosity increases exponentially as the molecular mass increases (for example, “Kobunshi Kagaku Joron 2^{nd} ed.”, pp. 51-55).

[η]=KM^{a} (wherein M represents a molecular mass, and a represents a constant determined by the kind of polymer)

Accordingly, the ultra-high molecular mass polymer of the invention can provide a large thickening effect even when added in a small amount to the coating composition. A coating composition is prepared for the purpose of realizing a certain function and, with an additive such as a thickening agent, a smaller addition amount thereof serves to more reduce its influences on a function to be realized, thus the ultra-high molecular mass polymer of the invention being said to be extremely advantageous in this point.

The mass-average molecular mass of the ultra-high molecular mass polymer of the invention is preferably from 500,000 to 4,000,000, more preferably from 600,000 to 3,000,000, still more preferably from 700,000 to 2,500,000.

As the molecular mass of the polymer increases, the viscosity largely increases when the polymer is added only in a small amount. Not only the molecular mass but the fact that the polymer spreads in the solution upon dissolution are considered to be important factors for the large increase in viscosity. It can be understood that the large effect of the ultra-high molecular mass polymer on the increase in viscosity for the increase in concentration of the solution thereof is based on the above-described factors. The ultra-high molecular mass polymer of the invention has a viscosity of 10 [mPa·sec] or more when dissolved in 2-butanone in a concentration of 3% by mass, more preferably 20 [mPa·sec] or more.

In the case of adding the ultra-high molecular mass polymer of the invention to a coating composition for forming an optical layer which constitutes an optical film, the addition amount thereof is preferably from 0.01 to 5% by mass, more preferably from 0.03 to 4% by mass, still more preferably from 0.05 to 3% by mass, in terms of solid component. Also, the ultra-high molecular mass polymers of the invention may be added independently or in combination of two or more kinds thereof. Addition of the ultra-high molecular mass polymer in an excess amount results in a too high viscosity of the coating composition, leading to deteriorated coating properties, thus excess addition not being preferred. On the other hand, when added in an amount of less than 0.01% by mass, the ultra-high molecular mass fails to exhibits its effect. An optical layer formed from the above-mentioned coating composition contains the ultra-high molecular mass polymer in an amount within the above-described range.

The solubility of the ultra-high molecular mass polymer of the invention in 2-butanone at 25 C is preferably 2% by mass or more, more preferably 5% by mass or more, still more preferably 10% by mass or more.

It is also possible to simultaneously add a polymer having a smaller molecular mass than that of the ultra-high molecular mass polymer of the invention. In this case, the mass-average molecular mass calculated as a mixture of the higher molecular mass component and the lower molecular mass component might be less than 500,000, and the invention includes such cases. That is, in the case where plural peaks are observed in the molecular mass distribution obtained by GPC analysis, it suffices that the mass-average molecular mass of at least one peak is from 500,000 to 5,000,000.

### (Thixotroic Agent)

The thixotropic agent to be used in the invention means a material which imparts thixotropic properties to the coating composition. The thixotropic agent is not particularly limited, and known ones may be used. Examples thereof include inorganic compounds such as calcium stearate, zinc stearate, aluminum stearate, aluminum oxide, zinc oxide, magnesium oxide, glass, diatomaceous earth, titanium oxide, zirconium oxide, silicon dioxide, talc, mica, feldspar, kaolinite (kaoloin clay), pyrophyllite (agalmatolite clay), sericite, bentonite, smectite.vermiculite (e.g., montmorillonite, beidellite, nontronite or saponite), organic bentonite and inorganic bentonite, fatty acid amide wax, polyethylene oxide, acrylic resin, amine salts of high-molecular polyester, salts of straight-chain polyaminoamide and high-molecular acid polyester, an amide solution of polycarboxylic acid, alkylsulfonic acid salts and alkylallylsulfonic acid salts. These may be used independently or in combination of two or more thereof. Examples of commercially available inorganic thixotropic agents include Crown Clay, Burgess Clay #60, Burgess Clay KF, Optiwhite (these being manufactured by Shiraishi Kogyo K.K.), Kaolin JP-100, NN Kaolin Clay, ST Kaolin Clay, Hardsil (these being manufactured by Tsuchiya Kaolin Kogyo K.K.), ASP-072, Satenton Plus, Translink 37, Hydrous Delami NCD (these being manufactured by Engelhard K.K.), SY Kaolin, OS Clay, HA Clay, MC Hard Clay (these being manufactured by Maruo Calcium K.K.), Lucentite SWN, Lucentite SAN, Lucentite STN, Lucentite SEN, Lucentite SPN (these being manufactured by CO-OP CHEMICAL CO., LTD.), Smecton (KUNIMINE INDUSTRIES CO., LTD.), Ben-Gel, Ben-Gel FW, S-Ben, S-Ben 74, Organite, Organite T (these being manufactured by HOJUN K.K.), Hodaka-jirushi, Olben, 250M, Bentone 34, Bentone 38 (these being manufactured by WILBER-ELLIS CO.), Raponite, Raponite RD, and Raponite RDS (these being manufactured by Nippon Silica Kygyo K.K.). Examples of commercially available organic thixotropic agents include Disperlon #6900-20X, Disperlon #4200, Disperlon KS-873N, Disperlon #1850 BYK-405, BYK-410 (manufactured by Pick Chemie Japan Co.), Primal Rw-12W (manufactured by Rohm and Haas Company), A-S-AT-20S, A-S-AT-350F, A-S-AD-10A and A-S-AD-160 (these being manufactured by Ito Seiyu K.K.). These compounds may be being dispersed in a solvent.

In view of coating properties onto a transparent support in the optical film of the invention, preferred examples of the thixotropic agent are silicate compounds represented by xM(I)₂O.ySiO₂ (including those wherein M has an oxidation number of 2 or 3, i.e., M(II)O or M(III)₂O₃). More preferred examples of the thixotropic agent are swellable layered clay minerals such as hectorite, bentonite, smectite and vermiculite. As particularly preferred examples of the thixotropic agent, amine-modified silicate minerals (organic smectite; interlayer cations such as sodium being replaced by an organic amine compound) can favorably be used. For example, there are illustrated those prepared by replacing sodium ion in sodium magnesium silicate (hectorite) by the following ammonium ion.

Examples of the ammonium ion include monoalkyltrimethylammonium ion having an alkyl chain containing from 6 to 18 carbon atoms, dialkyldimethylammonium ion, trialkylmethylammonium ion, dipolyoxyethylene coconut oil alkylmethylammonium ion having from 4 to 18 oxyethylene unit chains, bis(2-hydroxyethyl) coconut oil alkylmethylammonium ion, and polyoxypropylenemethyldiethylammonium ion having from 4 to 25 oxypropylene unit chain. These ammonium ions may be used independently or in combination of two or more thereof.

As a process for producing the amine-modified sodium magnesium silicate mineral wherein sodium ion in sodium magnesium silicate is replaced by ammonium ion, sodium magnesium silicate is dispersed in water and, after sufficient stirring, the dispersion is allowed to stand for 16 hours or more to prepare a 4% by mass dispersion. Under stirring, a desired ammonium salt is added to the dispersion in an amount of from 30% by mass to 200% by mass based on sodium magnesium silicate. After the addition, cation-exchange occurs, and hectorite containing the ammonium salt between layers becomes water-insoluble to form a precipitate. The resulting precipitate is collected by filtration, and dried to obtain the amine-modified silicate mineral. Upon preparation, the mixture may be heated.

As commercially available products of the amine-modified silicate minerals, there are illustrated Lucentite SAN, Lucentite STN, Lucentite SEN and Lucentite SPN (these being manufactured by CO-OP CHEMICAL CO., LTD.). These may be used independently or in combination of two or more thereof.

The value showing thixotropic properties (hereinafter referred to as “thixotropy index”) can be represented in terms of the viscosity ratio obtained by changing the rotation number of a rotation viscometer. As a means for measuring the thixotropy index, a commercially available rotation viscometer can be used. For example, a model-B viscometer manufactured by Tokimec INC. can be employed. The thixotropy index of the coating composition of the invention is preferably from 1.1 to 5.0 in terms of the ratio of viscosity for 60 rpm to that for 6 rpm at 25° C. When this index is in the range of from 1.1 to 5.0, no sagging and non-uniform coating result, and good surface properties are obtained, thus such index being preferred. The content of the thixotropic agent in the optical layer is preferably from 0.01% by mass to 5% by mass, more preferably from 0.05% by mass to 4% by mass, most preferably from 0.1% by mass to 3% by mass. When the content is less than 0.1% by mass, thixotropic properties are difficult to appear whereas, when the content is more than 5% by mass, there results a too high viscosity.

Other components to be used in the optical layer of the optical film of the invention will be described below.

### 1-(1) Monomer Binder

The optical layer of the invention can be formed by cross-linking reaction or polymerization of an ionization radiation-curable compound. That is, it can be formed by coating a coating composition containing an ionization radiation-curable, multi-functional monomer or a multi-functional oligomer as a binder on a transparent support, and cross-linking or polymerizing the multi-functional monomer or the multi-functional oligomer.

As the functional group of the ionization radiation-curable, multi-functional monomer or multi-functional oligomer, photo-polymerizable functional groups, electron beam-polymerizable functional groups and radiation-polymerizable functional groups are preferred. Of these, photo-polymerizable functional groups are more preferred.

Examples of the photo-polymerizaable functional group include unsaturated functional groups such as a (meth)acryloyl group, a vinyl group, a styryl group and an allyl group, with a (meth)acryloyl group being preferred.

Specific examples of the photo-polymerizable multi-functional monomer having the photo-polymerizable functional groups include:

(meth)acrylic acid diesters such as neopentylglycol diacrylate, 1,6-hexanediol di(meth)acrylate and propylene glycol di(meth)acrylate;
(meth)acrylic acid diesters of polyoxyalkyleneglycol such as triethylene glycol di(meth)acrylate, dipropylene glycol di(meth)acrylate, polyethylene glycol di(meth)acrylate and polypropylene glycol di(meth)acrylate;
(meth)acrylic acid diesters of polyhydric alcohol such as pentaerythritol di(meth)acrylate; and
(meth)acrylic acid diesters of ethylene oxide adduct or propylene oxide adduct such as 2,2-bis{4-acryloxy.diethoxy}phenyl}propane and 2,2-bis {4-(acryloxy.polypropoxy)phenyl}propane.

Further, epoxy (meth)acrylates, urethane (meth)acrylates and polyester (meth)acrylates can preferably be used as the photo-polymerizable multi-functional monomers.

Among them, esters between a polyhydric alcohol and (meth)acrylic acid are preferred. Multi-functional monomers having 3 or more (meth)acryloyl groups within the molecule are more preferred. Specifically, there are illustrated trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaderythritol triacrylate, (di)pentaerythritol pentaacrylate, (di)pentaerythritol tetra(meth)acrylate, (di)pentaerythritol hexa(meth)acrylate, tripentaerythritol triacrylate and tripentaerythritol hexatriacrylate. As has been described hereinbefore, in this specification, the terms “(meth)acrylate”, “(meth)acrylic acid” and “(meth)acryloyl” mean “acrylate or methacrylate”, “acrylic acid or methacrylic acid” and “acryloyl or methacryloyl”, respectively.

As the photo-polymerizable, multi-functional monomer to be used in the coating composition of the invention, urethane (meth)acrylate is also preferred.

Urethane (meth)acrylate to be used in the coating composition of the invention has preferably at least one, more preferably 4 or more, still more preferably 6 or more (meth)acryloyl groups bound to the main chain of the oligomer.

As specific examples of the urethane (meth)acrylate, there can be illustrated compounds represented by the following formula (II):

Yᵣ—R⁷—O—CO—NH—R⁶—NH—CO—O—R⁸—Yₛ (II)

In formula (II), R⁶ represents a divalent organic group, and is selected from among divalent organic groups having a molecular mass of usually from 14 to 10,000, preferably from 76 to 500.

R⁷ and R⁸ represent a (r+1)-valent organic group and a (s+1)-valent organic group, respectively, and are preferably selected from among chain-like, branched or cyclic saturated hydrocarbon groups and unsaturated hydrocarbon groups.

Y represents a mono-valent organic group having within the molecule a polymerizable unsaturated group which undergoes inter-molecular cross-linking reaction in the presence of an active radical species.

r and s each independently represents an integer of preferably from 1 to 20, more preferably from 1 to 10, particularly preferably from 1 to 5.

In the formula, R⁷ and R⁸, and Yᵣ and Yₛ may be the same or different from each other.

Examples of the urethane (meth)acrylate to be used in the invention include Beamset 102, 502H, 505A-6, 510, 550B, 551B, 575, 575CB, EM-90, EM92 (these being manufactured by ARAKAWA CHEMICAL INDUSTRIES, LTD.), Photomer 6008, 6210 (these being manufactured by Sannopco K.K.), NK Oligo U-2PPA, U-4HA, U-6HA, H-15HA, UA-32PA, U-324A, U-4H, U-6H (these being manufactured by Shin-Nakamura Kagaku Kogyo K.K.), Aronix M-1100, M-1200, M-1210, M-1310, M-1600, M-1960 (these being manufactured by Toagosei Co., Ltd.), AH-600, AT606, UA-306H (these being manufactured by Kyoeisha Kagaku K.K.), KAYARAD UX-2201, UX-2301, UX-3204, UX-3301, UX-4101, UX-6101, UX-7101 (these being manufactured by Nippon Kayaku), Shiko UV1700B, UV-3000B, UV-6100B, UV-6300B, UV-7000, UV-2010B (these being manufactured by Nippon Synthetic Chemical Industry Co.), Art Resin UN-1255, UN-5200, HDP-4T, HMP-2, UN-901T, UN-3320HA, UN-3320HB, UN-3320HC, UN-3320HS, H-61, HDP-M20 (these being manufactured by Negami Kogyo Co.), Ebecryl 6700, 204, 205, 220, 254, 1259, 1290K, 1748, 2002, 2220, 4833, 4842, 4866, 5129, 6602 and 8301 (these being manufactured by Daicel-UCB Company, Ltd.).

As the monomer binder, a monomer having different refractive index can be used in order to control the refractive index of the layer. Examples having a particularly high refractive index include bis(4-methacryloylthiophenyl)sulfide, vinylnaphthalene, vinylphenylsulfide and 4-mathacryloxyphenyl 4′-methoxyphenyl thioether.

Also, dendorimers described in, for example, JP-A-2005-76005 and JP-A-2005-36105 and norbornene ring-containing monomers described in, for example, JP-A-2005-60425 can be used.

The multi-functional monomers may be used in combination of two or more thereof.

Polymerization of these monomers having ethylenically unsaturated groups can be performed by irradiation with an ionization radiation or heating in the presence of a photo radical initiator or a thermal radical initiator.

It is preferred to use a photo polymerization initiator for the polymerization reaction of the photo-polymerizable multi-functional monomer. As the photo polymerization initiator, photo radical polymerization initiators and photo cation polymerization initiators are preferred, with photo radical polymerization initiators being particularly preferred.

### 1-(2) Polymer Binder

In the invention, a polymer or a cross-linked polymer can be used as the binder. The cross-linked polymer preferably has an anionic group. Cross-linked polymers having an anionic group have a structure wherein the main chain of a polymer having an anionic group is cross-linked.

Examples of the main chain of the polymer include polyolefin (saturated hydrocarbon), polyether, polyurea, polyurethane, polyester, polyamine, polyamide and melamine resin. Polyolefin main chain, polyether main chain and polyurea main chain are preferred, polyolefin main chain and polyether chain are more preferred, and polyolefin main chain are most preferred.

The polyolefin main chain comprises a saturated hydrocarbon. The polyolefin main chain is obtained by addition polymerization reaction of the unsaturated polymerizable group. In the polyether main chain, repeating units are connected to each other through ether bond (—O—). The polyether main chain is obtained by, for example, ring-opening polymerization reaction of epoxy group. In the polyurea main chain, repeating units are connected to each other through urea bond (—NH—CO—NH—). The polyurea main chain is obtained by, for example, polycondensation reaction between isocyanago group and amino group. In the polyurethane main chain, repeating units are connected to each other through urethane bond (—NH—CO—O—). The polyurethane main chain is obtained by, for example, polycondensation reaction between isocyanago group and hydroxyl group (including N-methylol group). In the polyester main chain, repeating units are connected to each other through ester bond (—CO—O—). The polyester main chain is obtained by, for example, polycondensation reaction between carboxyl group (including acid halide group) and hydroxyl group (including N-methylol group). In the polyamine main chain, repeating units are connected to each other through imino bond (—NH—). The polyamine main chain is obtained by, for example, ring-opening polymerization reaction of ethyleneimine group. In the polyamide main chain, repeating units are connected to each other through amido bond (—NH—CO—). The polyamide main chain is obtained by, for example, reaction between isocyanato group and carboxyl group (including acid halide group). The melamine resin main chain is obtained by, for example, polycondensation reaction between triazine group (e.g., melamine) and aldehydo group (e.g., formaldehyde). Additionally, with the melamine resin, the main chain itself has a cross-linked structure.

The anionic group is connected to the main chain by connecting it to the polymer main chain directly or via a linking group. The anionic group is preferably connected to the main chain via a linking group.

Examples of the anionic group include a carboxylic acid group (carboxyl), a sulfonic acid group (sulfo) and a phosphoric acid group (phosphono), with a sulfonic acid group and a phosphoric acid group being preferred.

The anionic group may be in a salt form. A cation forming a salt with the anionic group is preferably an alkali metal ion. Also, proton of the anionic group may be dissociated.

The linking group connecting the anionic group and the main chain of the polymer is preferably a divalent group selected from among —CO—, —O—, an alkylene group, an arylene group and a combination thereof.

The cross-linked structure is a structure wherein two or more main chains are chemically (preferably covalently) connected to each other. It is preferred that three or more main chains are covalently connected to each other. The cross-linked structure preferably comprises a group having 2 or more valences selected from among —CO—, —O—, —S—, nitrogen atom, phosphorus atom, an aliphatic residue, an aromatic residue and a combination thereof.

The cross-linked polymer having anionic group is preferably a repeating unit having an anionic group and a repeating unit having a cross-linked structure. The content of the repeating unit having an anionic group in the copolymer is preferably from 2 to 96% by mass, more preferably from 4 to 94% by mass, most preferably from 6 to 92% by mass. The repeating unit may have two or more anionic groups. The content of the repeating unit having a cross-linked structure in the copolymer is preferably from 4 to 98% by mass, more preferably from 6 to 96% by mass, most preferably from 8 to 94% by mass.

The repeating unit of the cross-linked polymer having anionic group may have both then anionic group and the cross-linked structure. Also, other repeating unit (repeating unit having neither anionic group nor cross-linked structure) may be contained.

As other repeating unit, a repeating unit having an amino group or a quaternary ammonium group and a repeating unit having a benzene ring are preferred. The amino group or the quaternary ammonium group functions to maintain the dispersion state of inorganic particles like the anionic group. Additionally, the amino group, the quaternary ammonium group and the benzene ring can exhibit the same effect when contained in the anionic group-having repeating unit or the repeating unit having a cross-linked structure.

In the repeating unit having an amino group or a quaternary ammonium group, the amino group or the quaternary ammonium group is connected to the main chain of the polymer directly or through a linking group. It is preferred for the amino group or the quaternary ammonium group to be connected to the main chain as a side chain through the linking group. The amino group or the quaternary ammonium group is preferably a secondary amino group, a tertiary amino group or a quaternary ammonium group, more preferably a tertiary amino group or a quaternary ammonium group. The group connected to the nitrogen atom of the secondary amino group, the tertiary amino group or the quaternary ammonium group is preferably an alkyl group, more preferably an alkyl group having from 1 to 12 carbon atoms, still more preferably an alkyl group having from 1 to 6 carbon atoms. The counter ion for the quaternary ammonium group is preferably a halide ion. The linking group connecting the amino group or the quaternary ammonium group to the polymer main chain is preferably a divalent group selected from among —CO—, —NH—, —O—, an alkylene group, an arylene group and the combination thereof. In the case where the cross-linked polymer having an anionic group contains a repeating unit having the amino group or the quaternary ammonium group, the content thereof is preferably from 0.06 to 32% by mass, more preferably from 0.08 to 30% by mass, most preferably from 0.1 to 28% by mass.

### 1-(3) Fluorine-Containing Polymer Binder

In the invention, among the polymer binders, a fluorine-containing copolymer compound can be used particularly in the low refractive index layer.

As the fluorine-containing vinyl monomers, there are illustrated fluoroolefins (e.g., fluoroethylene, vinylidene fluoride, tetrafluoroethylene and hexafluoropropylene), partially or completely fluorinated alkyl ester derivatives of (meth)acrylic acid (e.g., Viscoat 6FM (trade name; manufactured by Osaka Organic Chemical Industry Ltd.) and R-2020 (trade name; manufactured by Daikin Industries) and completely or partially fluorinated vinyl ethers, with perfluoroolefins being preferred. In view of refractive index, solubility, transparency and availability, hexafluoropropylene is particularly preferred. The refractive index of the resulting polymer can be reduced by increasing the formulation ratio of the fluorine-containing vinyl monomers, though film strength is reduced. In the invention, it is preferred to introduce the fluorine-containing vinyl monomer so that the content of fluorine of the copolymer of the invention becomes from 20 to 60% by mass, more preferably from 25 to 55% by mass, particularly preferably from 30 to 50% by mass.

As constituting units for imparting cross-linkable properties, there are mainly illustrated units of the following groups (A), (B) and (C).

### (A): Constituting units obtained by polymerization of a monomer previously having a self-cross-linkable functional group within the molecule, such as glycidyl (meth)acrylate or glycidyl vinyl ether.

(B): Constituting units obtained by polymerization of a monomer having a carboxyl group, a hydroxyl group, an amino group or a sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid).
(C): Constituting units obtained by reacting a compound having a group capable of reacting with a functional group of (A) or (B) within the molecule and, in addition, a cross-linkable functional group with the constituting unit (A) or (B) described above (e.g., a constituting unit which can be synthesized by a technique of, for example, acting acryloyl chloride on hydroxyl group).

With the constituting unit (C), the cross-linkable functional group is preferably a photo-polymerizable group. Here, examples of the photo-polymerizable group include a (meth)acryloyl group, an alkenyl group, a cinnamoyl group, a cinnamylideneacetyl group, a benzalacetophenone group, a styrylpyridine group, an α-phenylmaleimido group, a phenylazido group, a sulfonylazido group, a carbonylazido group, a diazo group, an o-quinonediazido group, a furylacryloyl group, a coumarin group, a pyrone group, an anthracene group, a benzophenone group, a stilbene group, a dithiocarbamato group, a xanthato group, a 1,2,3-thiadiazole group, a cyclopropenyl group and an azadioxabicyclo group. Not only one but two or more of these groups may be contained. Of these, a (meth)acryloyl group and a cinnamoyl group are preferred, and a (meth)acryloyl group is particularly preferred.

As specific processes for preparing the photo-polymerizable group-containing copolymer, there can be illustrated the following processes which, however, are not limitative at all.

a. A process of reacting a copolymer containing a hydroxyl group and a cross-linkable functional group with (meth)acryloyl chloride to conduct esterification.
b. A process of reacting a copolymer containing a hydroxyl group and a cross-linkable functional group with a (meth)acrylic ester containing an isocyanato group to conduct urethanization.
c. A process of reacting a copolymer containing an epoxy group and a cross-linkable functional group with a (meth)acrylic acid to conduct esterification.
d. A process of reacting a copolymer containing a carboxyl group and a cross-linkable functional group with a (meth)acrylic acid containing an epoxy group to conduct esterification.

Additionally, the introduction amount of the photo-polymerizable group can arbitrarily be controlled and, in view of stability of a coated film surface properties, reduction of surface troubles in the co-presence of inorganic particles and improvement of film strength, it is also preferred to leave a definite amount of carboxyl group or hydroxyl group.

With copolymers useful for the invention, other vinyl monomers may properly be copolymerized in view of various points such as adhesion properties to a substrate, Tg of a resulting polymer (contributing to film hardness), solubility into a solvent, transparency, slipping properties and dust-proof and stain-proof properties, in addition to the repeating unit derived from the fluorine-containing vinyl monomer and the repeating unit having a (meth)acryloyl group in the side chain. These vinyl monomers may be used in combination of two or more thereof according to the purpose, and are preferably introduced in a total content of from 0 to 65 mol %, more preferably from 0 to 40 mol %, particularly preferably from 0 to 30 mol %, based on the copolymer.

Usable vinyl monomers are not particularly limited, and are exemplified by olefins (e.g., ethylene, propylene, isoprene, vinyl chloride and vinylidene chloride), acrylates (e.g., methyl acrylate, ethyl acrylate, 2-ethylhexyl acrylate and 2-hydroxyethyl acrylate), methacrylates (e.g., methyl methacrylate, ethyl methacrylate, butyl methacrylate and 2-hydroxyethyl methacrylate), styrene derivatives (e.g., styrene, p-hydroxymethylstyrene and p-methoxystyrene), vinyl ethers (e.g., methyl vinyl ether, ethyl vinyl ether, cyclohexyl vinyl ether, hydroxyethyl vinyl ether and hydroxybutyl vinyl ether), vinyl esters (e.g., vinyl acetate, vinyl propionate and vinyl cinnamate), unsaturated carboxylic acids (e.g., acrylic acid, methacrylic acid, crotonic acid, maleic acid and itaconic acid), acrylamides (e.g., N,N-dimethylacrylamide, N-tert-butylacrylamide and N-cyclohexylacrylamide), methacrylamides (e.g., N,N-dimethylmethacrylamide) and acrylonitrile.

Fluorine-containing polymers particularly useful in the invention are random copolymers of a perfluoroolefin and a vinyl ether or a vinyl ester. It is particularly preferred for the polymers to have a group which is cross-linkable by itself (e.g., a radical-reactive group such as a (meth)acryloyl group or a ring-opening polymerizable group such as an oxetanyl group). The polymerization unit having such cross-linkable group accounts for preferably 5 to 70 mol %, particularly preferably 30 to 60 mol %, of the whole polymerization units of the polymer. As preferred polymers, there can be mentioned those which are described in JP-A-2002-243907, JP-A-2002-372601, JP-A-2003-26732, JP-A-2003-222702, JP-A-2003-294911, JP-A-2003-329804, JP-A-2004-4444 and JP-A-2004-45462.

Also, for the purpose of imparting stain-proof properties to the fluorine-containing polymer of the invention, it is preferred to introduce thereinto a polysiloxane structure. Methods for introducing the polysiloxane structure are not particularly limited, but a method of introducing a polysiloxane block copolymer component by using a silicone-macroazo initiator as is described in, for example, JP-A-6-93100, JP-A-11-189621, JP-A-11-228631 and JP-A-2000-313709, and a method of introducing a polysiloxane graft copolymerization component by using a silicone macromer as is described in JP-A-2-251555 and JP-A-2-308806 are preferred. As particularly preferred compounds, there can be illustrated polymers described in Examples 1, 2 and 3 in JP-A-11-189621 or copolymers A-2 and A-3 described in JP-A-2-251555. These polysiloxane components account for preferably 0.5 to 10% by mass, particularly preferably 1 to 5% by mass, of the polymer.

The molecular mass of the fluorine-containing polymer which can preferably be used in the invention is preferably 5,000 or more, more preferably from 10,000 to 500,000, most preferably from 15,000 to 200,000 in terms of mass-average molecular mass. It is also possible to improve surface properties and scratch resistance of the coated film by using in combination polymers different from each other in mass-average molecular mass.

A curing agent having a polymerizable unsaturated group may properly be used in combination with the polymer as described in JP-A-10-25388 and JP-A-2000-17028. It is also preferred to use a fluorine-containing, multi-functional polymerizable unsaturated group in combination with the polymer as described in JP-A-2002-145952. Examples of the multi-functional polymerizable unsaturated compound include those multi-functional monomers which have heretofore been described with respect to the monomer binders. These compounds exhibit large effects on improvement of scratch resistance particularly when a compound having a polymerizable unsaturated group is used in the main chain of the polymer, thus being preferred.

### 1-(4) Organosilane Compounds

In view of scratch resistance, it is preferred for at least one of the layers constituting the film of the invention to contain at least one component of a hydrolyzate and/or a partial condensate of an organosilane compound, so-called “sol component” (hereinafter in some cases referred to like this), in the coating solution for forming the layer.

In particular, with an anti-reflection film, in order to obtain both anti-reflection ability and scratch resistance, it is particularly preferred to incorporate the sol component in both the low refractive index layer and the optical layer. This sol component is condensed in a drying step and a heating step after coating the coating solution, thus forming a part of the binder of the above-mentioned layers. Also, in the case where the cured product has a polymerizable unsaturated bond, a binder having a three dimensional structure is formed by irradiation with actinic light.

The organosilane compound is preferably a compound represented by the following formula 1.

(R¹)ₘ—Si(X)₄₋ₘ Formula 1

In the above formula 1, R¹ represents a substituted or unsubstituted alkyl group or a substituted or unsubstituted aryl group. As the alkyl group, an alkyl group having from 1 to 30 carbon atoms is preferred, an alkyl group having from 1 to 16 carbon atoms is more preferred, and an alkyl group having from 1 to 6 carbon atoms is particularly preferred. Specific examples of the alkyl group include methyl, ethyl, propyl, isopropyl, hexyl, decyl and hexadecyl. Examples of the aryl group include phenyl and naphthyl, with a phenyl group being preferred.

X represents a hydroxyl group or a hydrolyzable group and is preferably exemplified by an alkoxy group (preferably an alkoxy group having from 1 to 5 carbon atoms; e.g., a methoxy group or an ethoxy group), a halogen atom (e.g., Cl, Br or I) and R²COO (wherein R² is preferably a hydrogen atom or an alkyl group having from 1 to 6 carbon atoms; e.g., CH₃COO or C₂H₅COO). X preferably represents an alkoxy group, particularly preferably a methoxy group or an ethoxy group.

m represents an integer of from 1 to 3, preferably 1 or 2.

When plural Xs exist, the plural Xs may be the same or different from each other.

Substituents contained in R¹ are not particularly limited and are exemplified by a halogen atom (e.g., fluorine, chlorine or bromine), a hydroxyl group, a mercapto group, a carboxyl group, an epoxy group, an alkyl group (e.g., methyl, ethyl, i-propyl, propyl or t-butyl), an aryl group (e.g., phenyl or naphthyl), an aromatic hetero ring group (e.g., furyl, pyrazolyl or pyridyl), an alkoxy group (e.g., methoxy, ethoxy, i-propoxy or hexyloxy), an aryloxy group (e.g., phenoxy), an alkylthio group (methylthio or ethylthio), an arylthio group (e.g., phenylthio), an alkenyl group (e.g., vinyl or 1-propenyl), an acyloxy group (acetoxy, acryloyloxy or methacryloyloxy), an alkoxycarbonyl group (e.g., methoxycarbonyl or ethoxycarbonyl), an aryloxycarbonyl group (e.g., phenoxycarbonyl), a carbamoyl group (carbamoyl, N-methylcarbamoyl, N,N-dimethylcarbamoyl or N-methyl-N-octylcarbamoyl) and an acylamino group (acetylamino, benzoylamino, acrylamino or methacrylamino). These substituents may further be substituted.

R¹ is preferably a substituted alkyl group or a substituted aryl group.

Also, as the organosilane compound, organosilane compounds which have a vinyl-polymerizable substituent and which are represented by the following formula 2 are preferred.

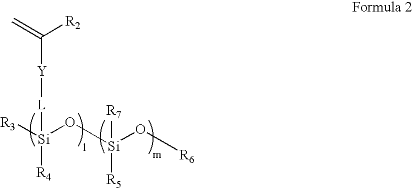

In the above formula 2, R₂ represents a hydrogen atom, a methyl group, a methoxy group, an alkoxycarbonyl group, a cyano group, a fluorine atom or a chlorine atom. As the alkoxycarbonyl group, a methoxycarbonyl group and an ethoxycarbonyl group are illustrated. A hydrogen atom, a methyl group, a methoxy group, a methoxycarbonyl group, a cyano group, a fluorine atom and a chlorine atom are preferred, and a hydrogen atom, a methyl group, a methoxycarbonyl group, a fluorine atom and a chlorine atom are more preferred, and a hydrogen atom and a methyl group are particularly preferred.

Y represents a single bond, *—COO—**, *—CONH—** or *—O—**, preferably a single bond, *—COO—** or *—CONH—**, still more preferably a single bond or *—COO—**, and *—COO—** is particularly preferred. * represents a position at which Y is connected to ═C(R₂)—, and ** represents a position at which Y is connected to L.

L represents a divalent linking chain. Specifically, a substituted or unsubstituted alkylene group, a substituted or unsubstituted arylene group, a substituted or unsubstituted alkylene group having a linking group in the interior thereof (e.g., ether, ester or amide), and a substituted or unsubstituted arylene group having a linking group in the interior thereof (e.g., ether, ester or amide) are mentioned. Of these, a substituted or unsubstituted alkylene group, a substituted or unsubstituted arylene group and an alkylene group having a linking group in the interior thereof are preferred, an unsubstituted alkylene group, an unsubstituted arylene group and an alkylene group having an ether or ester linking group in the interior thereof are more preferred, and an unsubstituted alkylene group and an alkylene group having an ether or ester linking group in the interior thereof are particularly preferred. Examples of the substituent include halogen, a hydroxyl group, a mercapto group, a carboxyl group, an epoxy group, an alkyl group and an aryl group, and these substituents may further be substituted.

1 (representing a number satisfying the formula of l=100−m) and m each independently represents a molar ratio, with m representing a number of from 0 to 50. m represents more preferably a number of from 0 to 40, particularly preferably a number of from 0 to 30.

R₃ to R₅ each preferably represents a halogen atom, a hydroxyl group, an unsubstituted alkoxy group or an unsubstituted alkyl group. R₃ to R₅ each more preferably represents a chlorine atom, a hydroxyl group, an unsubstituted alkoxy group having from 1 to 6 carbon atoms, more preferably a hydroxyl group or an alkoxy group having from 1 to 3 carbon atoms, particularly preferably a hydjroxyl group or a methoxy group.

R₆ represents a hydrogen atom, an alkyl group, an alkoxy group, an alkoxycarbonyl group, a cyano group, a fluorine atom or a chlorine atom. As the alkyl group, a methyl group and an ethyl group are mentioned and, as the alkoxy group, a methoxy group and an ethoxy group are mentioned and, as the alkoxycarbonyl group, a methoxycarbonyl group and an ethoxycarbonyl group are mentioned. Of these, a hydrogen atom, a methyl group, a methoxy group, a methoxycarbonyl group, a cyano group, a fluorine atom and a chlorine atom are preferred, a hydrogen atom, a methyl group, a methoxycarbonyl group, a fluorine atom and a chlorine atom are more preferred, and a hydrogen atom and a methyl group are particularly preferred.

R₇ is more preferably a hydroxyl group or an unsubstituted alkyl group, still more preferably a hydroxyl group or an alkyl group containing from 1 to 3 carbon atoms, and particularly preferably a hydroxyl group or a methyl group.

Compounds represented by the formula 1 may be used in combination of two or more thereof. In particular, compounds of the formula 2 are synthesized from at least one of the compounds of the formula 1. Specific examples of the compounds of the formula 1 and starting materials for the compounds represented by the formula 2 are shown below which, however, do not limit the invention in any way.

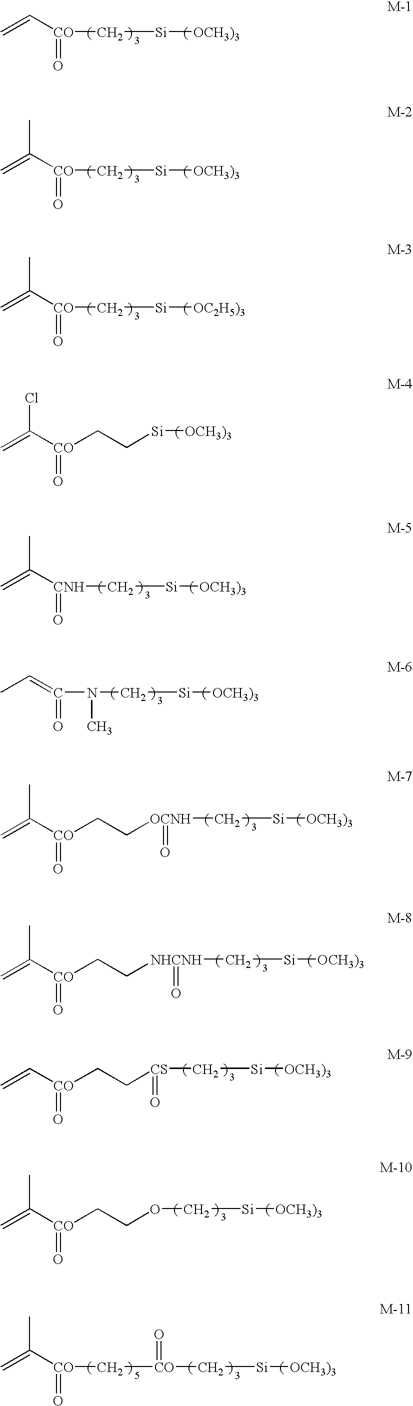

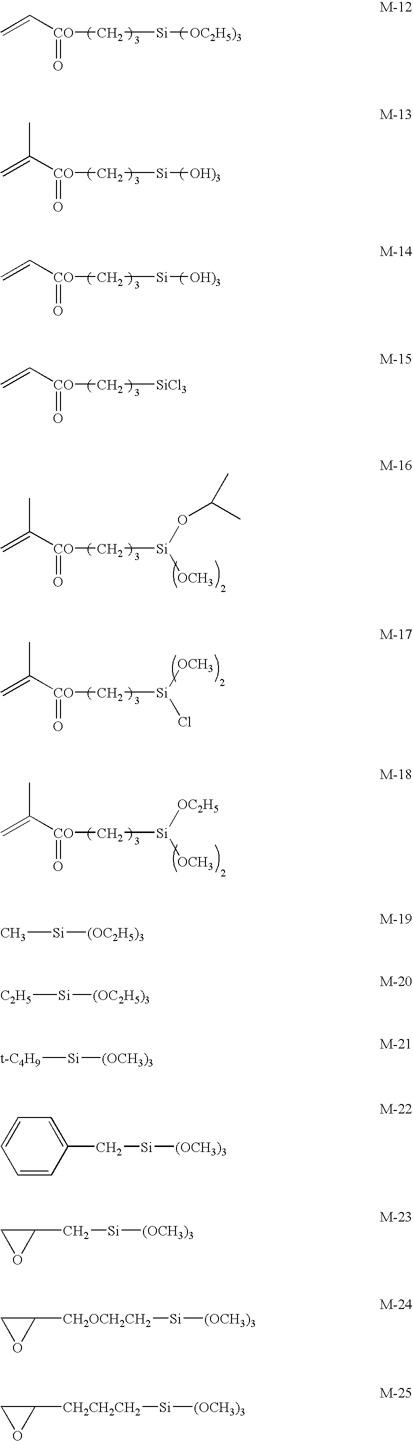

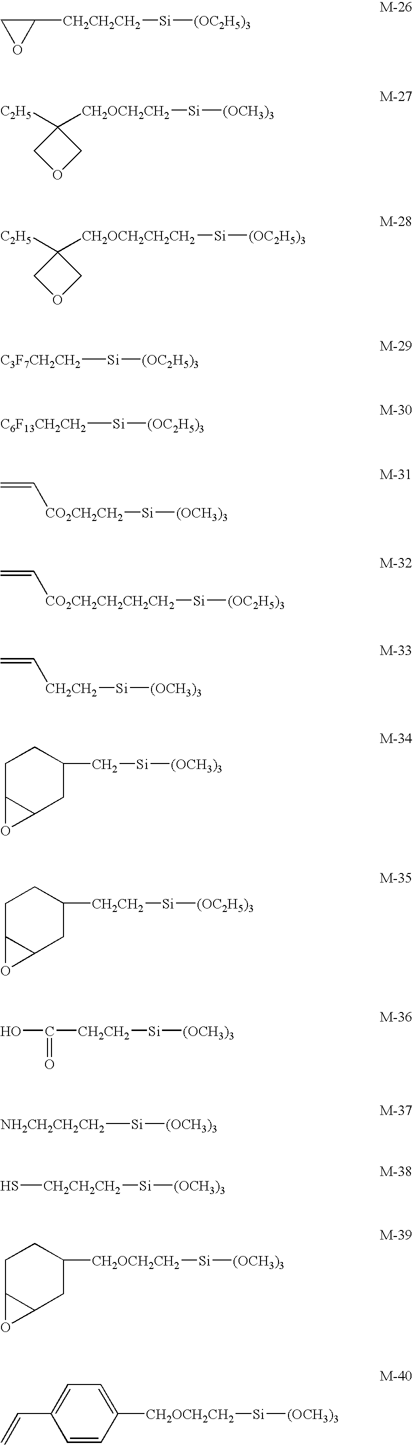

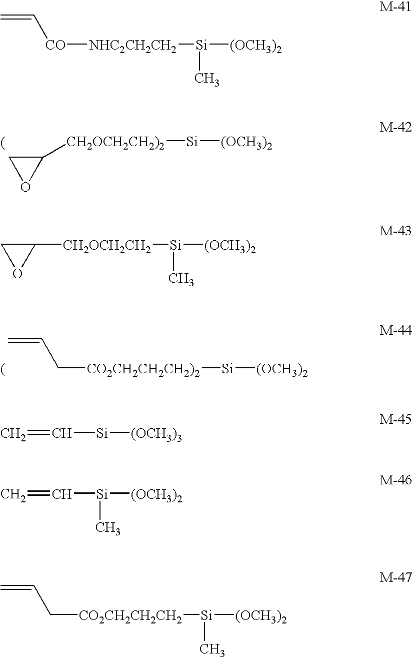

M-48 Methyltrimethoxysilane

Of these, (M-1), (M-2) and (M-25) are particularly preferred as the organosilane containing a polymerizable group.

In order to obtain desired effects, the content of the organosilane having a vinyl polymerizable group in the hydrolyzate and/or the partial condensate of organosilane is preferably from 30% by mass to 100% by mass, more preferably from 50% by mass to 100% by mass, still more preferably from 70% by mass to 95% by mass. In the case where the content of the organosilane having a vinyl polymerizable group is less than 30% by mass, there arise such problems as that solids are formed, that the solution becomes turbid, that the pot life is deteriorated, that the molecular mass becomes difficult to control (the molecular mass increases) and that improvement of performance (for example, scratch resistance of the anti-reflection film) is difficult to attain after polymerization treatment due to the less content of the polymerizable group, thus such content not being preferred.

In the case of synthesizing the compound represented by the formula 2, it is preferred to select one of (M-1) and (M-2) as the organosilane having a vinyl polymerizable group and select one from among (M-19) to (M-21) and (M-48) as the organosilane not having a vinyl polymerizable group and use them in combination thereof in amounts described above.

With the hydrolyzate of organosilane and the partial condensate thereof, it is preferred to suppress volatile properties of at least either of them in order to stabilize a coated layer. Specifically, the vaporization amount per 1 hour at 105° C. is preferably 5% by mass or less, more preferably 3% by mass or less, particularly preferably 1% by mass or less.

The sol component to be used in the invention is prepared by hydrolyzing and/or partially condensing organosilane.

The hydrolytic condensation reaction is performed by adding water in an amount of from 0.05 to 2.0 mols, preferably from 0.1 to 1.0 mol, per mol of the hydrolyzable group (X) and stirring the solution in the presence of a catalyst to be used in the invention at 25 to 100° C.

With at least either of the hydrolyzate and the partial condensate of organosilane, the mass-average molecular mass of either of the hydrolyzate and the partial condensate of the organosilane having a vinyl polymerizable group is preferably from 450 to 20,000, more preferably from 500 to 10,000, still more preferably from 550 to 5,000, still more preferably from 600 to 3,000, with components of less than 300 in molecular mass being removed.

Of the components of 300 or more in molecular mass in the hydrolyzate and/or the partial condensate of organosilane, components having a molecular mass larger than 20,000 preferably amount to 10% by mass or less, more preferably 5% by mass or less, still more preferably 3% by mass or less. In the case where the content exceeds 10% by mass, a cured film obtained by curing a curable composition containing such hydrolyzate and/or partial condensate of organosilane can have deteriorated transparency and deteriorated adhesion to a substrate.

Here, the mass-average molecular mass and the molecular mass are values in terms of polystyrene measured by means of a GPC analyzer using columns of TSK_{gel} GMH_{X}L, TSK_{gel}, G4000H_{X}L and TSK_{gel} G2000H_{X}L (these being trade names and manufactured by TOSOH CORPORATION and using THF as a solvent and a differential refractometer for detection, and the content is a value in terms of an area % of a peak in the aforesaid molecular mass range, taking a peak area of components of 300 or more in molecular mass as 100%.

The polydispersity (mass-average molecular mass/number-average molecular mass) is preferably from 3.0 to 1.1, more preferably from 2.5 to 1.1, still more preferably from 2.0 to 1.1, particularly preferably from 1.5 to 1.1.

²⁹Si-NMR analysis of the hydjrolyzate and the partial condensate of organosilane reveals that X in the formula 1 is in a state of being condensed in the form of —Osi.

In this case, the condensation ratio α is represented by the following numeral formula (II):

α=(T3×3+T2×2+T1×1)/3/(T3+T2+T1+T0) formula (II):

wherein T3 represents the case where three bonds of Si are condensed in the form of —OSi, T2 represents the case where two bonds of Si are condensed in the form of —Osi, T1 represents the case where one bond of Si is condensed in the form of —OSi, and T0 represents the case where Si is not condensed at all. The condensation ratio is preferably from 0.2 to 0.95, more preferably from 0.3 to 0.93, particularly preferably from 0.4 to 0.9.

In the case where the condensation ratio is less than 0.1, hydrolysis or condensation is insufficient and the content of monomer components increases, thus curing becoming insufficient. On the other hand, when the ratio exceeds 0.95, hydrolysis or condensation proceeds so much that the hydrolysable groups are consumed and, therefore, mutual action among the binder polymer, the resin substrate and the inorganic particles would be reduced. Thus, even when used, they difficultly provide sufficient effects.

The hydrolyzate and the partial condensate of the organosilane compound to be used in the invention will be described in detail below.

The hydrolysis reaction of organosilane and the subsequent condensation reaction are generally conducted in the presence of a catalyst. Examples of the catalyst include inorganic acids such as hydrochloric acid, sulfuric acid and nitric acid; organic acids such as oxalic acid, acetic acid, butyric acid, maleic acid, citric acid, formic acid, methanesulfonic acid and toluenesulfonic acid; inorganic bases such as sodium hydroxide, potassium hydroxide and ammonia; organic bases such as triethylamine and pyridine; metal alkoxides such as aluminum triisopropoxide, zirconium tetrabutoxide, tetrabutyl titanate and dibutyltin dilaurate; metal chelate compounds having a metal such as Zr, Ti or Al as a central metal; and F-containing compounds such as KF and NH₄F.

The above-described catalysts may be used independently or in combination of two or more thereof.

Hydrolysis and condensation reaction of organosiloxane can be conducted in the absence of a solvent or in a solvent but, in order to uniformly mix the components with each other, use of an organic solvent is preferred. As such organic solvent, alcohols, aromatic hydrocarbons, ethers, ketones and esters are preferred.

The solvent is preferably a solvent which can dissolve both the organosilane and the catalyst. In view of production steps, it is preferred to use the organic solvent as a coating solution or as a part of the coating solution, and the solvent is preferably a solvent which, in the case of mixing with other materials such as a fluorine-containing polymer, does not suffer reduction in solubility or dispersibility.

Of the solvents, alcohols are exemplified by mono-hydric or dihydric alcohols. As the monohydric alcohols, saturated aliphatic alcohols having from 1 to 8 carbon atoms are preferred.

Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Also, specific examples of the aromatic hydrocarbons include benzene, toluene and xylene, specific examples of the ethers include tetrahydrofuran and dioxane, specific examples of the ketones include acetone, methyl ethyl ketone, methyl isobutyl ketone, diisobutyl ketone and cyclohexanone, specific examples of the esters include ethyl acetate, propyl acetate, butyl acetate and propylene carbonate.

These organic solvents may be used independently or in combination of two or more thereof. The concentration of solid components in the reaction is not particularly limited, but is usually in the range of from 1% to 100%.

Usually, the reaction is conducted by adding water in an amount of from 0.05 to 2 mols, preferably from 0.1 to 1 mol, per mol of the hydrolysable group of organosilane and stirring the mixture in the presence or absence of the solvent and in the presence of the catalyst at 25 to 100° C.

In the invention, it is preferred to conduct the hydrolysis by stirring at 25 to 100° C. in the presence of at least one of metal chelate compounds wherein a metal selected from among Zr, Ti and Al exists as a central metal and both an alcohol represented by the formula of R³OH (wherein R³ represents an alkyl group containing from 1 to 10 carbon atoms) and a compound represented by the formula of R⁴COCH₂COR⁵ (wherein R4 represents an alkyl group containing from 1 to 10 carbon atoms, and R⁵ represents an alkyl group containing from 1 to 10 carbon atoms or an alkoxy group containing from 1 to 10 carbon atoms) exist as ligands. In the case of using a F-containing compound as the catalyst, polymerization degree can be controlled by selecting the amount of water since the F-containing compound has the ability of completing the hydrolysis and the condensation. Thus, the F-containing compound is preferred because it enables one to attain any molecular mass. That is, in order to prepare an organosilane hydrolyzate/partial condensate having an average polymerization degree of M, it suffices to use (M-1) mols of water per M mols of the hydrolysable organosilane.

As the metal chelate compound, any metal chelate compound wherein a metal selected from among Zr, Ti and Al exists as a central metal and both an alcohol represented by the formula of R³OH (wherein R³ represents an alkyl group containing from 1 to 10 carbon atoms) and a compound represented by the formula of R⁴COCH₂COR⁵ (wherein R4 represents an alkyl group containing from 1 to 10 carbon atoms, and R⁵ represents an alkyl group containing from 1 to 10 carbon atoms or an alkoxy group containing from 1 to 10 carbon atoms) exist as ligands can preferably be used with no particular restrictions, as described above. Two or more metal chelate compounds within this category may be used in combination thereof. As the metal chelate compound to be used in the invention, those which are selected from the compound groups represented by the formulae of Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂ are preferred. They function to accelerate condensation reaction of the aforesaid hydrolyzate and partial condensate of the organosilane compound.

R³s and R⁴s in the metal chelate compound may be the same or different, and each independently represents an alkyl group containing from 1 to 10 carbon atoms, specifically, an ethyl group, a n-propyl group, an i-propyl group, a n-butyl group, a sec-butyl group, a t-butyl group, a n-pentyl group or a phenyl group. Also, R5 represents the same alkyl group containing from 1 to 10 carbon atoms as described above or an alkoxy group containing from 1 to 10 carbon atoms such as a methoxy group, an ethoxy group, a n-propoxy group, an i-propoxy group, a n-butoxy group, a sec-butoxy group or a t-butoxy group. p1, p2, q1, q2, r1 and r2 in the metal chelate compound each independently represents an integer determined to satisfy the formulae of p1+p2=4, q1+q2=4, and r1+r2=3.

Specific examples of the metal chelate compound include zirconium chelate compounds such as tri-n-butoxyethylacetoacetate zirconium, di-n-butoxybis(ethylacetoacetato)zirconium, n-butoxytris(ethylacetoacetato)zirconium, tetrakis(n-propylacetoacetato)zirconium, tetrakis(acetylacetoacetato)zirconium and tetrakis(ethylacetoacetato)zirconium; titanium chelate compounds such as diisopropoxybis(ethylacetoacetato)titanium, diisopropoxybis(acetylacetonato)titanium and diisopropoxybis(acetylacetone)titanium; and aluminum chelate compounds such as diisopropoxyethylacetoacetate aluminum, diisopropoxyacetylacetonate aluminum, isopropoxybis(ethylacetoacetato)aluminum, isopropoxybis(acetylacetonato)aluminum, tris(ethylacetoacetato)aluminum, tris(acetylacetonato)aluminum and monoacetylacetonatobis(ethylacetoacetato)aluminum.

Of these metal chelate compounds, tri-n-butoxyethylacetoacetate zirconium, diisopropoxybis(acetylacetonato)titanium, diisopropoxyethylacetoacetate aluminum and tris(ethylacetoacetato)aluminum are preferred. These metal chelate compounds can be used independently or in combination of two or more thereof. It is also possible to use a partial hydrolyzate of the metal chelate compound.

The metal chelate compound is used in an amount of preferably from 0.01 to 50% by mass, more preferably from 0.1 to 50% by mass, still more preferably from 0.5 to 10% by mass, based on the organosilane compound. When used in the above-mentioned range, the metal chelate compounds accelerate the condensation reaction of the organosilane compounds, provide the coated film with good durability, and provide a composition containing both the hydrolyzate and partial condensate of the organosilane compound and the metal chelate compound with good storage stability.

To the coating solution to be used in the invention is preferably added at least either of a β-diketone compound and a β-keto ester compound, in addition to the above-described sol component and the metal chelate compound. More detailed descriptions are given below.

β-diketone compounds and β-keto ester compounds to be used in the invention are at least either of the β-diketone compounds and β-keto ester compounds represented by the formula of R4COCH2COR5, and function as agents for improving stability of the composition to be used in the invention. That is, they are considered to coordinate to the metal atom in the metal chelate compound (at least any one of the zirconium compounds, titanium compounds and aluminum compounds) to thereby suppress condensation reaction of the hydrolyzate and the partial condensate of the organosilane compound, thus functioning to improve storage stability of the resulting composition. R⁴ and R⁵ constituting the β-diketone compounds and the β-keto ester compounds are the same as R⁴ and R⁵ which constitute the metal chelate compounds.

Specific examples of the β-diketone compounds and the β-keto ester compounds include acetylacetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 2,5-heptane-dione, 2,4-octane-dione, 2,4-nonane-dione and 5-methylhexane-dione. Of these, ethyl acetoacetate and acetylacetone are preferred, and acetylacetone is particularly preferred. These β-diketone compounds and β-keto ester compounds may be used independently or in combination of two or more thereof. In the invention, the β-diketone compounds and the β-keto ester compounds are used in an amount of preferably 2 mols or more, more preferably from 3 to 20 mols, per mol of the metal chelate compound. A good storage stability is given to the composition by adding them in an amount of 2 mols or more.

The content of the hydrolyzate and partial condensate of the organosilane compound is preferably small with an anti-reflection film having a comparatively small thickness, and is preferably large with a hard coat layer or an anti-glare layer having a large thickness. In consideration of exhibition of the effect, refractive index, shape and surface properties of the film, the content is preferably from 0.1 to 50% by mass, more preferably from 0.5 to 30% by mass, most preferably from 1 to 15% by mass, based on the mass of the total solid components in the layer containing it (layer to which it is added).

### 1-(5) Initiators

Polymerization of various monomers having an ethylenically unsaturated group can be conducted by irradiation with ionization radiation or by heating in the presence of a photo radical initiator or a thermal radical initiator.

In preparing the film of the invention, a photo initiator and a thermal initiator can be used in combination.

### <Photo Initiators>

As the photo radical initiators, there are illustrated acetophenones, benzoins, benzophenones, phosphine oxides, ketals, anthraquinones, thioxanthones, azo compounds, peroxides (e.g., JP-A-2001-139663), 2,3-dialkyldiones, disulfide compounds, fluoroamine compounds, aromatic sulfoniums, roffin dimmers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxxydimethylphenyl ketone, 1-hydroxydimethyl-p-isopropylphenyl ketone, 1-hydroxycyclohexylphenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-t-butyl-dichloroacetophenone.

Examples of the benzoins include benzoin, benzoin methyl ether, benzoin ethyl ether, benzoin isopropyl ether, benzyldimethylketal, benzoin benzenesulfonate, benzoin toluenesulfonate, benzoin methyl ether, benzoin ethyl ether and benzoin isopropyl ether.

Examples of the benzophenones include benzophenone, hydroxybenzophenone, 4-benzoyl-4′-methyldiphenylsulfide, 2,4-dichlorobenzophenone, 4,4-dichlorobenzophenone and p-chlorobenzophenone, 4,4′-dimethylaminobenzophenone (Michler's ketone) and 3,3′,4,4′-tetra(t-butylperoxycarbonyl)benzophenone.

As the borates, there are illustrated, for example, organic borate compounds described in Japanese Patent No. 2,764,769, JP-A-2002-116539, and Kunz, Martin, Rad Tech' 98. Proceeding April pp. 19-22, 1998, Chicago. For example, there are illustrated compounds described in paragraphs [0022] to [0027] in JP-A-2002-116539. As other organic boron compounds, there are specifically illustrated organic boron-transition metal coordination complexes described in JP-A-6-348011, JP-A-7-128785, JP-A-7-140589, JP-A-7-306527 and JP-A-7-292014. Specific examples thereof include ion complexes with cationic dyes.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic acid esters and cyclic active esters.

Specifically, compounds 1 to 21 described in Examples of JP-A-2000-80068 are particularly preferred.

Examples of the onium salts include aromatic diazonium salts, aromatic iodonium salts and aromatic sulfonium salts.

As specific examples of the active halogens, there are illustrated compounds described in Wakabayashi et al., Bull Chem. Soc. Japane, vol. 42, p. 2924 (1969), U.S. Pat. No. 3,905,815, JP-A-5-27830, and M. P. Hutt, Journal of Heterocyclic Chemistry, vol. 1 (No.3), (1970). In particular, oxazole compounds substituted by a trihalomethyl group, and s-triazine compounds can be mentioned. More preferably, there are illustrated s-triazine derivatives wherein at least one mono-, di- or tri-halogen-substituted methyl group is bound to the s-triazine ring. As specific examples thereof, s-triazine and oxathiazole compounds are known, with 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis8trichloromethl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole being included. Specifically, compounds described in JP-A-58-15503, pp. 14-30, JP-A-55-77742, pp. 6-10, compounds No.1 to No.8 described in JP-B-60-27673, p. 287, compounds No.1 to 17 described in JP-A-60-239736, pp. 443-444 and compounds No.1 to 19 described in U.S. Pat. No. 4,701,399 are particularly preferred.

Examples of the inorganic complexes include bis(η5-2,4-cyclopentadien-1-yl)-bis(2,6-difluoro-3-(1H-pyrrol-1-yl)-phenyl)titanium.

Examples of the coumarin include 3-ketocoumarin.

These photo initiators may be used independently or in combination thereof.

Also, various examples are described in Saishin UV Koka Gijutsu, K.K.Gijutsu Joho Kyokai, 1991, p. 159 and Shigaisen Koka System written by Kiyomi Kato and published by Sogo Gijutsu Center in 1989, pp. 65-148, and are useful in the invention.

As commercially available photo radical initiators, KAYACURE (DETX-S, BP-100, BDMK, CTX, BMS, 2-EAQ, ABQ, CPTX, EPD, ITX, QTX, BTC, MCA, etc.) manufactured by Nippon Kayaku, IRGACURE (651, 184, 500, 819, 907, 369, 1173, 1870, 2959, 4265, 4263, etc.) manufactured by Ciba Specialty Chemicals, Esacure (KIP100F, KB1, EB3, BP, X33, KTO46, KT37, KIPI150, TZT, etc.) manufactured by Sartomer Co. and combinations thereof can be mentioned as preferred examples.

The photo polymerization initiator is used in an amount of from 0.1 to 15 parts by mass, more preferably from 1 to 10 parts by mass, per 100 parts by mass of the multi-functional monomer.

### <Photo Sensitizers>

In addition to the photo polymerization initiator, a photo sensitizer may be used. Examples of the photo sensitizer include n-butylamine, triethylamine, tri-n-butylphosphine, Michler's ketone and thioxanthone.

Further, one or more aids such as azide compounds, thiourea compounds and mercapto compounds may be used in combination with the photo sensitizers.

Examples of commercially available photo sensitizers include KAYACURE (DMBI, EPA), etc.

### <Thermal Initiators>

As the thermal initiators, organic or inorganic peroxides, organic azo and diazo compounds can be used.

Specific examples of the organic peroxides include benzoyl peroxide, halogenobenzoyl peroxide, lauroyl peroxide, acetyl peroxide, dibutyl peroxide, cumene hydroperoxide and butyl hydroperoxide, specific examples of the inorganic peroxides include hydrogen peroxide, ammonium persulfate and potassium persulfate, specific examples of the azo compounds include 2,2′-azobis(isobutyronitrile), 2,2′-azobis(propionitrile) and 1,1′-azobis(cyclohexanecarbonitrile), and specific examples of the diazo compounds include diazoaminobenzene and p-nitrobenzenediazonium.

### 1-(6) Cross-Linkable Compounds

In the case where monomers or polymer binders constituting the invention fail to have a sufficient curability by themselves, necessary curability can be imparted by compounding a cross-linkable compound.

For example, in the case where the polymer itself has hydroxyl groups, it is preferred to use various amino compounds as curing agents. The amino compounds to be used as cross-linkable compounds are compounds which contain, in total, two or more of either or both of hydroxyalkylamino group and alkoxyalkylamino group and, specifically, melamine series compounds, urea series compounds, benzoguanamine series compounds and glycol urea series compounds can be mentioned.

The melamine series compounds are generally known as compounds having a skeleton wherein nitrogen atoms are bound to a triazine ring and, specifically, melamine, alkylated melamine, methylolmelamine and alkoxylated methylmelamine can be mentioned, with those which have, in total, two or more of either or both of methylol group and alkoxylated methyl group within the molecule being preferred. Specifically, methylolmelamine obtained by reacting melamine and formaldehyde under a basic condition, alkoxylated methylmelamine and the derivatives thereof are preferred. Particularly, in view of imparting good storage stability and good reactivity to the curable resin composition, alkoxylated methylmelamine is preferred. The methylolmelamine and alkoxylated methylmelamine to be used as the cross-linkable compounds are not particularly limited, and various resinous materials obtained by processes described in, for example, Plastic Koza [8], Urea•melamine Jushi (Nikkan Kogyo Shinbunsha) can be employed.

Also, as the urea series compounds, there can be illustrated, in addition to urea, polymethylolurea, its derivative of alkoxylated methylurea, methylolurone having a urone ring and alkoxylated methylurone. Regarding compounds such as the urea derivatives, various resinous materials described in the above literature can also be employed.

### 1-(7) Curing Catalysts

In the film of the invention, a radical or an acid generated by irradiation with ionization radiation or heat can be used.

### <Thermal Acid Generators>

Specific examples of the thermal acid generators include various aliphatic sulfonic acids and the salts thereof, various aliphatic carboxylic acids such as citric acid, acetic acid and maleic acid and the salts thereof, various aromatic carboxylic acids such as benzoic acid and phthalic acid and the salts thereof, alkylbenzenesulfonic acids and the ammonium or amine salts thereof, various metal salts, and phosphates of phosphoric acid and organic acid.

As commercially available materials, there are illustrated Catalyst 4040, Catalyst 4050, Catalyst 600, Catalyst 602, Catalyst 500, Catalyst 296-9 (these being manufactured by Nihon Cytec Industries Inc.), NACURE series 155, 1051, 5076, 4054J and their blocked types of NACURE series 2500, 5225, X49-110, 3525 and 4167 (these being manufactured by King Industries, Inc.

The amount of the thermal acid generator to be used is preferably from 0.01 to 10 Parts by mass, more preferably from 0.1 to 5 parts by mass, per 100 parts by mass of the curable resin composition. When the addition amount is within this range, there results a curable resin composition having good storage stability, and a coated film formed from it has good scratch resistance.

### <Light-Sensitive Acid Generators and Photo Acid Generators>

Further, photo acid generators which can be used as photo polymerization initiators will be described in detail below.

As the acid generators, there are illustrated known compounds such as known acid generators used in photo initiators for photo cationic polymerization, photo color-extinguishing agents (e.g., dyes), photo color-changing agents or micro-resists and mixtures thereof. Also, as the acid generators, there are illustrated, for example, organic halogen compounds, disulfone compounds and onium compounds. Of these, specific examples of the organic halogen compounds and disulfone compounds are the same as those which have heretofore been described as radical-generating compounds.

As the light-sensitive acid generators, there can be illustrated, for example, (1) various onium salts such as iodonium salts, sulfonium salts, phosphonium salts, diazonium salts, ammonium salts and pyridinium salts; (2) sulfone compounds such as β-keto esters, β-sulfonylsulfones and α-diazo compounds thereof; (3) sulfonic esters such as alkylsulfonic esters, haloalkylsulfonic esters, arylsulfonic esters and iminosulfonates; (4) sulfonamide compounds and (5) diazomethane compounds.

The onium compounds include diazonium salts, ammonium salts, iminium salts, phosphonium salts, iodonium salts, sulfonium salts, arsonium salts and selenonium salts. Of these, diazonium salts, iodonium salts, sulfonium salts and iminium salts are preferred in view of photo sensitivity of photo polymerization initiation and material stability of the compound. For example, there are illustrated compounds described in paragraphs [0058] to [0059] in JP-A-2002-29162.

The amount of the light-sensitive acid generator to be used is preferably from 0.01 to 10 parts by mass, more preferably from 0.1 to 5 parts by mass, per 100 parts by mass of the curable resin composition.

Besides, regarding specific compounds and methods for using them, reference to the contents described in, for example, JP-A-2005-43876 can be made.

### 1-(8) Light-Transmitting Particles

The optical layer of the optical film of the invention contains light-transmitting particles (preferably light-transmitting resin particles). The average particle size of the light-transmitting particles is preferably from 5 to 15μ, more preferably from 5 to 12 μm, still more preferably from 5 to 10 μm. These are used for the purpose of scattering external light reflected on the display surface to weaken the light or enlarging the viewing angle (particularly downward viewing angle) of a liquid crystal display device to make it difficult that, even when viewing angle in the viewing direction is changed, reduction in contrast, black-white reversal or change in hue is difficult to occur. In the case where the average particle size is within the above-described range, the particles give a screen excellent blackness and less image roughness due to adequate anti-glare properties, and can reduce fine uneven luminance called dazzling with a highly fine display caused by the surface roughness. The particle size distribution is measured according to the Coulter counter method.

In order to exhibit the light-diffusing effect and anti-glare properties, the light-transmitting particles are required to have the above-described average particle size and, in addition, it is necessary to adjust the difference in refractive index between the particles and the binder to be used. Specifically, the difference in refractive index between the light-transmitting particles and the binder is preferably from 0 to 0.2, more preferably from 0.001 to 0.1, particularly preferably from 0.001 to 0.05, as an absolute value.

Here, the refractive index of the binder can be quantitatively evaluated by measuring directly by means of an Abbe's refractometer or by measuring spectral reflection spectrum or spectral ellipsometry. The refractive index of the light-transmitting particles is measured by dispersing the light-transmitting particles in an equal amount in solvents whose refractive indexes are varied by varying mixing ratio of two solvents different from each other in refractive index, measuring turbidity of individual dispersions, and measuring the refractive index of a solvent in which the particles give the minimum turbidity using the Abbe's refractometer.

The addition amount of the light-transmitting particles for the binder is in the range of preferably from 2 to 40% by mass, particularly preferably from 4 to 25% by mass, based on the mass of the whole solid components in the anti-glare alyer. The coating amount of the light-transmitting particles is preferably from 10 mg/m² to 10,000 mg/m², more preferably from 50 mg/m² to 4,000 mg/m². The light-transmitting particles can be selected from among the resin particles to be described hereinafter according to desired refractive index and average particle size.

As preferred specific examples of the resin particles in accordance with the invention, there are illustrated, for example, cross-linked polymethyl methacrylate particles, cross-linked methyl methacrylate-styrene copolymer particles, cross-linked polystyrene particles, cross-linked methyl methacrylate-methyl acrylate copolymer particles and cross-linked acrylate-styrene copolymer particles. Further, there are preferably illustrated so-called surface-modified particles obtained by chemically connecting a compound containing a fluorine atom, a silicon atom, a carboxyl group, a hydroxyl group, an amino group, a sulfonic acid group or a phosphoric acid group to the surface of the above-mentioned resin particles. Of these, cross-linked styrene particles, cross-linked polymethyl methacrylate particles and cross-linked methyl methacrylate-styrene copolymer particles are preferred. Further, particles having a higher cross-linked degree are more desired, and particles obtained by cross-linking the monomer composition containing a cross-linking agent in a content of 1 mol % or more per mol of the whole monomers before synthesizing the particles are preferred, with the content being more preferably 3 mols % or more.

As processes for producing the light-transmitting resin particles, there can be illustrated a suspension polymerization process, a soap-free emulsion polymerization process, a dispersion polymerization process and a seed polymerization process, and the particles may be produced by any of these processes. With respect to these production processes, reference may be made to, for example, descriptions in Kobunshi Gosei no Jikkenho (written by Takayuki Otsu and Masaetsu Kinoshita and published by Kagaku Dojin-sha), p. 30 and pp. 146-147; processes described in Gosei Kobunshi, vol. 1, pp. 246-290, and vol. 3 pp. 1-108; and processes described in Japanese Patent Nos. 2,543,503, 3,508,304, 2,746,275, 3,521,560, 3,580,320, JP-A-10-1561, JP-A-7-2908, JP-A-5-297506 and JP-A-2002-145919.

Regarding the particle size distribution of the light-transmitting resin particles, mono-disperse particles are preferred in view of the haze value, control of diffusibility and uniformity of coated surface properties. For example, when particles having a particle size larger than the average particle size by 20% or more are specified as coarse particles, the proportion of the coarse particles is preferably 1% or less, more preferably 0.1% or less, still more preferably 0.01% or less, based on the number of total particles. As a method for obtaining particles having such particle size distribution, it is effective to conduct classification after preparation or synthesis reaction of the particles, and particles with a desired particle size distribution can be obtained by increasing the number of repeating classification or by intensifying the degree of classification.

In conducting classification, it is preferred to employ a method such as an air classification method, a centrifugal classification method, a sedimentation classification method, a filtration classification method and an antistatic classification method.

The shape of the resin particles may be true sphere or amorphous.

The particle size distribution of the particles is measured according to the Coulter counter method, and the measured distribution is converted to a particle number distribution. The average particle size is calculated based on the thus obtained particle number distribution.

Also, two kinds of light-transmitting particles different in particle size may be used in combination thereof. It is possible to impart anti-glare properties by light-transmitting particles having a larger particle size and reduce rough feel of the surface by light-transmitting particles having a smaller particle size.

Also, the density of the light-transmitting particles is preferably from 10 to 1,000 mg/m², more preferably from 100 to 700 mg/m².

### 1-(9) Inorganic Particles

In the invention, various inorganic particles can be used in various layers to be formed on the transparent support in order to improve physical properties such as hardness and optical properties such as reflectance and scattering properties.

As the inorganic particles, there are illustrated oxides of at least one metal selected from among silicon, zirconium, titanium, aluminum, indium, zinc, tin and antimony. Specific examples thereof include ZrO₂, TiO₂, Al₂O₃, In₂O₃, ZnO, SnO₂, Sb₂O₃ and ITO. Besides, BaSO₄, CaCO₃, talc and kaolin are included.

Regarding the particle size of the inorganic particles to be used in the invention, the particles are preferably atomized as fine as possible in a dispersing medium. The mass-average particle size is from 1 to 200 nm, preferably from 5 to 150 nm, more preferably from 10 to 100 nm, particularly preferably from 10 to 80 nm. Atomizing the inorganic particles to a particle size of 100 nm or less enables one to form a layer which does not spoil transparency. The particle size of the inorganic particles can be measured according to a light-scattering method or by means of an electron microscope.

The specific area of the inorganic particles is preferably from 10 to 400 m²/g, more preferably from 20 to 200 m²/g, most preferably from 30 to 150 m²/g.

The inorganic particles to be used in the invention are preferably added to a coating solution for forming a layer wherein they are used as dispersion in a dispersing medium.

The dispersing medium for the inorganic particles to be used is preferably a liquid having a boiling point of from 60 to 170° C. Examples of the dispersing medium include water, alcohols (e.g., methanol, ethanol, isopropanol, butanol and benzyl alcohol), ketones (e.g., acetone, methyl ethyl ketone, methyl isobutyl ketone and cyclohexanone), esters (e.g., methyl acetate, ethyl acetate, propyl acetate, butyl acetate, methyl formate, ethyl formate, propyl formate and butyl formate), aliphatic hydrocarbons (e.g., hexane and cyclohexane), halogenated hydrocarbons (e.g., methylene chloride, chloroform and carbon tetrachloride), aromatic hydrocarbons (e.g., benzene, toluene and xylene), amides (e.g., dimethylformamide, dimethylacetamide and N-methylpyrrolidone), ethers (e.g., diethyl ether, dioxane and tetrahydrofuran) and ether alcohols (e.g., 1-methoxy-2-propanol). Of these, toluene, xylene, methyl ethyl ketone, methyl isobutyl ketone, cyclohexanone and butanol are particularly preferred.

Particularly preferred dispersing media are methyl ethyl ketone, methyl isobutyl ketone and cyclohexanone.

The inorganic particles are dispersed by using a dispersing machine. Examples of the dispersing machine include a sand grinder mill (e.g., a pinned bead mill), a high-speed impeller mill, a pebble mill, a roller mill, an attritor and a colloid mill, with a sand grinder mill and a high-speed impeller mill being particularly preferred. Also, previous dispersing treatment may be performed. Examples of dispersing machines to be used for the previous dispersing treatment include a ball mill, a three-rod mill, a kneader and an extruder.

### <High Refractive Index Particles>

For the purpose of increasing refractive index of a layer constituting the invention, a cured product of a composition wherein inorganic particles having a high refractive index are dispersed in monomers, an initiator and a silicon compound substituted by an organic group is preferably used.

As the inorganic particles in this case, ZrO₂ and TiO₂ are particularly preferably used in view of refractive index. Fine particles of ZrO₂ are most preferred for increasing the refractive index of the hard coat layer, whereas fine particles of TiO₂ are most preferred as particles for the high refractive index layer and the middle refractive index layer.

As the TiO₂ particles, inorganic particles containing TiO₂ as a major component and further containing at least one element selected from among cobalt, aluminum and zirconium are particularly preferred. The term “major component” as used herein means a component whose content (% by mass) is the largest among components constituting the particles.

The particles in the invention containing TiO₂ as a major component have a refractive index of preferably from 1.90 to 2.80, more preferably from 2.10 to 2.80, most preferably from 2.20 to 2.80.

The mass-average particle size of the primary particles of the particles containing TiO₂ as a major component is preferably from 1 to 200 nm, more preferably from 1 to 150 nm, still more preferably from 1 to 100 nm, particularly preferably from 1 to 80 nm.

Regarding the crystal structure of the particles containing TiO₂ as a major component, it is preferred for rutile structure, rutile/anatase mixed crystal structure, anatase structure or amorphous structure to constitute a major component. In particular, it is preferred for rutile structure to constitute a major component. The term “major component” as used herein means a component whose content (% by mass) is the largest among components constituting the particles.

The photo-catalytic activity of TiO₂ can be suppressed by incorporating at least one element selected from among Co (cobalt), Al (aluminum) and Zr (zirconium) in the particles containing TiO₂ as a major component, thus weatherability of the film of the invention being improved. A particularly preferred element is Co (cobalt). It is also preferred to use two or more of them in combination.

The inorganic particles containing TiO₂ as a major component may have a core/shell structure formed by surface treatment as described in JP-A-2001-166104.

The addition amount of the inorganic particles in the layer is preferably from 10 to 90% by mass, more preferably from 20 to 80% by mass, based on the total mass of the binder. Two or more kinds of inorganic particles may be used in the layer.

### <Low Refractive Index Particles>

Inorganic particles to be incorporated in the low refractive index layer preferably have a low refractive index and are exemplified by fine particles of magnesium fluoride or silica. In view of refractive index, dispersion stability and cost, fine particles of silica are preferred.

The average particle size of the silica fine particles is preferably from 30% to 150%, more preferably from 35% to 80%, still more preferably from 40% to 60%, of the thickness of the low refractive index layer. That is, when the thickness of the low refractive index layer is 100 nm, the particle size of silica fine particles is preferably from 30 nm to 150 nm, more preferably from 35 nm to 80 nm, still more preferably from 40 nm to 60 nm.

Here, the average particle size of inorganic particles is measured according to the Coulter counter method.

In case when the particle size of silica fine particles is too small, there results less effect of improving scratch resistance whereas, when too large, fine unevenness is formed on the surface of the low refractive index layer, leading to deteriorated appearance such as blackness and deteriorated integral reflectance. The silica fine particles may be crystalline or amorphous, and may be mono-disperse particles or agglomerated particles. As to shape, spherical particles are most preferred, though amorphous particles involve no problems.

It is also preferred to use at least one kind of silica fine particles having an average particle size of less than 25% of the thickness of the low refractive index layer (hereinafter referred to as “smaller particle size silica fine particles”) in combination with the silica fine particles having the above-mentioned particle size (hereinafter referred to as “larger particle size silica fine particles”).

Since the smaller particle size silica fine particles can exist in spaces left between the larger particle size silica fine particles, the smaller particle size silica fine particles can contribute as particle size-maintaining agent for the larger particle size silica fine particles.

In the case where the thickness of the low refractive index layer is 100 nm, the average particle size of the smaller particle size silica fine particles is preferably from 1 nm to 20 nm, more preferably from 5 nm to 15 nm, particularly preferably from 10 nm to 15 nm. Use of such silica fine particles is preferred in the point of cost on starting materials and effects as the particle size-maintaining agent.

The coated amount of the low refractive index particles is preferably from 1 mg/m² to 100 mg/m², more preferably from 5 mg/m² to 80 mg/m², still more preferably from 10 mg/m² to 60 mg/m². In case when the coated amount is too small, there results a reduced effect of improving scratch resistance whereas, in case when the coated amount is too large, there result fine unevenness on the surface of the low refractive index layer, leading to deteriorated appearance such as blackness and deteriorated integral reflectance.

### <Hollow Silica Particles>

For the purpose of more reducing the refractive index, use of hollow silica fine particles is preferred.

The hollow silica fine particles have a refractive index of preferably from 1.15 to 1.40, more preferably from 1.17 to 1.35, most preferably from 1.17 to 1.30. Here, the refractive index means a refractive index as whole particles, and does not mean the refractive index of the silica forming the shell of the hollow silica particles. The hollow ratio, x, represented by the following numerical formula (VIII):

x=(4πa³/3)/(4πb³/3)×100 (numerical formula VIII)

(wherein a represents a radius of the hollow sphere within the particle, and b represents an outer radius of the shell of the particle)
is preferably from 10 to 60%, more preferably from 20 to 60%, most preferably from 30 to 60%. In case when the hollow ratio is increased to make the hollow silica particles less refractive, there results a thin shell having small particle strength. Therefore, in view of scratch resistance, particles having a refractive index of less than 1.15 are not preferred.

Processes for producing the hollow silica are described in, for example, JP-A-2001-233611 and JP-A-2002-79616. Particles having a hollow within a shell whose fine pores are clogged are particularly preferred. Additionally, the refractive index of these hollow silica particles can be calculated according to the method described in JP-A-2002-79616.

The coated amount of the hollow silica is preferably from 1 mg/m² to 100 mg/m², more preferably from 5 mg/m² to 80 mg/m², still more preferably from 10 mg/m² to 60 mg/m². In the case where the coated amount is 1 mg/m² or more, there result an effect of reducing the refractive index and an effect of improving scratch resistance and, in the case where the coated amount is 100 mg/m² or less, formation of fine unevenness on the surface of the low refractive index layer is prevented, leading to improved appearance such as blackness and improved integral reflectance.

The average particle size of the hollow silica is preferably from 30% to 150%, more preferably from 35% to 80%, still more preferably from 40% to 60%, of the thickness of the low refractive index layer. That is, when the thickness of the low refractive index layer is 100 nm, the particle size of hollow silica is preferably from 30 nm to 150 nm, more preferably from 35 nm to 100 nm, still more preferably from 40 nm to 65 nm.

In case when the particle size of the hollow silica fine particles is too small, the proportion of the hollow portion is decreased and reduction of the refractive index can not be attained whereas, when too large, fine unevenness is formed on the surface of the low refractive index layer, leading to deteriorated appearance such as blackness and deteriorated integral reflectance. The silica fine particles may be crystalline or amorphous, and may be mono-disperse particles or agglomerated particles. As to shape, spherical particles are most preferred, though amorphous particles involve no problems.

Also, two or more kinds of hollow silica particles different in the average particle size may be used in combination. Here, the average particle size of hollow silica can be determined from a photograph of an electron microscope.

In the invention, the specific surface are of the hollow silica is preferably from 20 to 300 m²/g, more preferably from 30 to 120 m²/g, most preferably from 40 to 90 m²/g. The surface area can be determined according to BET method using nitrogen.

In the invention, silica particles without hollow can be used in combination with the hollow silica. The particle size of silica particles without hollow is preferably from 30 nm to 150 nm, more preferably from 35 nm to 100 nm, most preferably from 40 nm to 80 nm.

### 1-(10) Electrically Conductive Particles

Various electrically conductive particles can be used for imparting electro-conductivity to the film of the invention.

The electrically conductive particles are preferably formed from an oxide or nitride of a metal. Examples of the metal oxide or metal nitride include tin oxide, indium oxide, zinc oxide and titanium nitride. Tin oxide and indium oxide are particularly preferred. The electrically conductive particles contain these metal oxides or metal nitrides as major component and may further contain other elements. The term “major component” means a component whose content (% by mass) is the largest among components constituting the particles. Examples of other elements include Ti, Zr, Sn, Sb, Cu, Fe, Mn, Pb, Cd, As, Cr, Hg, Zn, Al, Mg, Si, P, S, B, Nb, In, V and halogen atom. In order to enhance electro-conductivity of tin oxide and indium oxide, it is preferred to add Sb, P, B, Nb, In, V and halogen atom. Sb-containing tin oxide (ATO) and Sn-containing indium oxide (ITO) are particularly preferred. The content of Sb in ATO is preferably from 3 to 20% by mass. The content of Sn in ITO is preferably from 5 to 20% by mass.

The average particle size of primary particles of the electrically conductive inorganic particles to be used in the antistatic layer is preferably from 1 to 150 nm, more preferably from 5 to 100 nm, most preferably from 5 to 70 nm. The average particle size of the electrically conductive inorganic particles in the antistatic layer to be formed is from 1 to 200 nm, preferably from 5 to 150 nm, still more preferably from 10 to 100 mm, most preferably from 10 to 80 nm. The average particle size of the electrically conductive inorganic particles is an average particle size based on mass of the particles and can be measured by a light-scattering method or from a photograph of an electron microscope.

The specific surface are of the electrically conductive inorganic particles is preferably from 10 to 400 m²/g, more preferably from 20 to 200 m²/g, most preferably from 30 to 150 m²/g.

The electrically conductive inorganic particles may be subjected to surface treatment. The surface treatment is performed by using an inorganic compound or an organic compound. Examples of the inorganic compounds to be used for the surface treatment include alumina and silica, with silica being particularly preferred. Examples of the organic compounds to be used for the surface treatment include polyol, alkanolamine, stearic acid, silane coupling agent and titanate coupling agent, with silane coupling agent being most preferred. Two or more surface treatments can be performed in combination.

As to shape of the electrically conductive inorganic particles, rice grain-like particles, spherical particles, cubic particles, spindle-like particles or amorphous particles are preferred.

Two or more kinds of electrically conductive particles may be used in one, two or more layers.

The content of the electrically conductive inorganic particles in the antistatic layer is preferably from 20 to 90% by mass, more preferably from 25 to 85% by mass, still more preferably from 30 to 80% by mass.

The electrically conductive inorganic particles can be used in a form of dispersion for forming the antistatic layer.

### 1-(11) Surface-Treating Agents

The inorganic particles to be used in the invention may be subjected to a physical surface treatment such as plasma discharge treatment or corona discharge treatment or a chemical surface treatment with a surfactant or a coupling agent in a dispersion or a coating solution in order to stabilize dispersion or enhance affinity or binding properties for a binder component.

Such surface treatment can be performed by using a surface-treating agent of an inorganic compound or an organic compound. Examples of the inorganic compound to be used for the surface treatment include cobalt-containing inorganic compounds (e.g., CoO₂, CoO₃ and Co₃O₄), aluminum-containing inorganic compounds (e.g., Al₂O₃ and Al(OH)₃), zirconium-containing inorganic compounds (e.g., ZrO₂ and Zr(OH)₄), silicon-containing inorganic compounds (e.g., SiO₂) and iron-containing inorganic compounds (e.g., Fe₂O₃).

Cobalt-containing inorganic compounds, aluminum-containing inorganic compounds and zirconium-containing inorganic compounds are particularly preferred, with cobalt-containing inorganic compounds, Al(OH)₃ and Zr(OH)₄ being most preferred.

Examples of the organic compound to be used for the surface treatment include polyols, alkanolamines, stearic acid, silane coupling agents and titanate coupling agents, with silane coupling agents being most preferred. It is particularly preferred to subject the inorganic particles to surface treatment with at least one of silane coupling agents (organosilane compounds), partially hydrolyzed products and condensates thereof.

Examples of the titanate coupling agent include metal alkoxides such as tetramethoxytitanium, tetraethoxytitanium and tetraisopropoxytitanium, and Plainact (e.g., KR-TTS, KR-46B, KR-55 or KR-41B; manufactured by Ajinomoto Co., Inc.).

As the organic compounds to be used for the surface treatment are preferably polyols, alkanolamines and organic compounds having an anionic group, particularly preferably organic compounds having a carboxyl group, a sulfonic acid group or a phosphoric acid group. Stearic acid, lauric acid, oleic acid, linoleic acid and linolenic acid are preferably used.

The organic compounds to be used for the surface treatment preferably further have a cross-linkable or polymerizable functional group. The cross-linkable or polymerizable functional groups are an ethylenically unsaturated group which can undergo addition reaction or polymerization reaction by a radical species (e.g., a (meth)acryl group, an allyl group, a styryl group or a vinyloxy group), a cation-polymerizable group (e.g., an epoxy group, an oxetanyl group or a vinyloxy group) and a polycondensation-reactive group (a hydrolysable silyl group or an N-methylol group), with a group having an ethylenically unsaturated group being preferred.

These surface treatments can be employed in combination of two or more thereof. It is particularly preferred to use an aluminum-containing inorganic compound and a zirconium-containing inorganic compound in combination.

With inorganic particles of silica, use of a coupling agent is particularly preferred. As the coupling agent, an alkoxymetal compound (e.g., a titanium coupling agent or a silane coupling agent) is preferably used. Of them, treatment with a silane coupling agent is particularly effective.

The coupling agent is used as a surface-treating agent for inorganic fillers of the low refractive index layer in order to previously conduct surface treatment prior to preparation of a coating solution for forming the layer. It is preferred to incorporate the agent by adding it as an additive upon preparing a coating solution for the layer.

The silica fine particles are preferably dispersed in a medium prior to the surface treatment in order to reduce load of the surface treatment.

As surface-treating agents and specific catalyst compounds for the surface treatment to be preferably used in the invention, there can be illustrated, for example, those organosilane compounds and catalysts which are described in WO2004/017105.

### 1-(12) Dispersing Agents

Various dispersing agents can be used for dispersing particles to be used in the invention.

The dispersing agent preferably further has a cross-linkable or polymerizable functional group. Examples of the cross-linkable or polymerizable functional groups include an ethylenically unsaturated group which can undergo addition reaction or polymerization reaction by a radical species (e.g., a (meth)acryl group, an allyl group, a styryl group or a vinyloxy group), a cation-polymerizable group (e.g., an epoxy group, an oxetanyl group or a vinyloxy group) and a polycondensation-reactive group (a hydrolysable silyl group or an N-methylol group), with a functional group having an ethylenically unsaturated group being preferred.

Use of a dispersing agent having an anionic group is preferred for dispersing inorganic particles, particularly inorganic particles having TiO₂ as a major component. Dispersing agents having an anionic group and a cross-linkable or polymerizable functional group are more preferred, and dispersing agents having the cross-linkable or polymerizable functional group in the side chain are particularly preferred.

As the anionic group, groups having an acidic proton such as a carboxyl group, a sulfonic acid group (sulfo group), a phosphoric acid group (phosphono group) and a sulfonamido group or the salts thereof are effective. Of these, a carboxyl group, a sulfonic acid group, a phosphoric acid group and the salts thereof are preferred, with a carboxyl group and a phosphoric acid group being particularly preferred. The number of the anionic groups contained per molecule of the dispersing agent is preferably 2 or more on the average, more preferably 5 or more, particularly preferably 10 or more, though plural kinds of anionic groups may be contained. Also, plural kinds of anionic groups may be contained per molecule of the dispersing agent.

In the dispersing agent having the anionic group in the side chain, the content of repeating unit containing the anionic group is in the range of from 10⁻⁴ to 100 mol %, preferably from 1 to 50 mol %, particularly preferably from 5 to 20 mol %, of the whole repeating units.

The dispersing agent preferably further contains a cross-linkable or polymerizable group. Examples of the cross-linkable or polymerizable functional group include an ethylenically unsaturated group which can undergo addition reaction or polymerization reaction by a radical species (e.g., a (meth)acryl group, an allyl group, a styryl group or a vinyloxy group), a cation-polymerizable group (e.g., an epoxy group, an oxetanyl group or a vinyloxy group) and a polycondensation-reactive group (a hydrolysable silyl group or an N-methylol group), with a functional group having an ethylenically unsaturated group being preferred.

The number of the cross-linkable or polymerizable groups contained in one molecule of the dispersion is preferably 2 or more on the average, more preferably 5 or more, particularly preferably 10 or more. Also, plural kinds of cross-linkable or polymerizable groups may be contained per molecule of the dispersing agent.

As repeating units having an ethylenically unsaturated group in the side chain which exist in a preferred dispersing agent to be used in the invention, a poly-1,2-butadiene or poly-1,2-isoprene structure or repeating units of (meth)acrylic ester or amide to which a specific residue (R group in —COOR or —CONHR) can be utilized. Examples of the specific residue (group R) include —(CH₂)ₙ—CR²¹═CR²²R²³, —(CH₂O)ₙ—CH₂CR²¹═CR²²R²³, —(CH₂CH₂O)ₙ—CH₂CR²¹═CR²²R²³, —(CH₂)ₙ—NH—CO—O—CH₂CR²¹═CR²²R²³, —(CH₂)ₙ—O—CO—CR²¹═CR²²R²³ and —CH₂CH₂O)₂—X (wherein R²¹ to R²³ each independently represents a hydrogen atom, a halogen atom, an alkyl group containing from 1 to 20 carbon atoms, an aryl group, an alkoxy group or an aryloxy group, R²¹ and R²² or R²³ may be connected to each other to form a ring, n represents an integer of from 1 to 10, and X represents a dicyclopentadienyl residue). Specific examples of R of the ester residue include —CH₂CH═CH₂ (corresponding to the allyl (meth)acrylate polymer described in JP-A-64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue). Specific examples of R of the amide residue include —CH₂CH═CH₂, —CH₂CH₂—Y (wherein Y represents a 1-cyclohexenyl residue), —CH₂CH₂—OCO—CH═CH₂, —CH₂CH₂—OCO—C(CH₃)═CH₂.

With the dispersing agent having the ethylenically unsaturated group, a free radical (a polymerization-initiating radical or a growing radical in the course of polymerization of a polymerizable compound) adds to the unsaturated bond group to cause addition polymerization directly between molecules or through polymerization chain of the polymerizable compound to form cross-linkage between molecules, thus curing being performed. Or, an atom of a molecule (for example, a hydrogen atom on the carbon atom adjacent to an unsaturated bond group) is withdrawn by a free radical to generate a polymer radical, and the polymer radicals thus formed are connected to each other for form cross-linkage between the molecules, thus curing being performed.

The mass-average molecular mass (Mw) of the dispersing agent having both an anionic group and, in the side chain, a cross-linkable or polymerizable functional group is not particularly limited, but is preferably 1,000 or more, more preferably from 2,000 to 100,000, still more preferably from 5,000 to 200,000, particularly preferably from 10,000 to 100,000.

The unit having the cross-linkable or polymerizable functional group may constituted all repeating units except for the anionic group-containing repeating unit, and is preferably from 5 to 50 mol %, particularly preferably from 5 to 30 mol %, of the whole repeating units.

The dispersing agent may be a copolymer with other appropriate monomer other than the monomer having a cross-linkable or polymerizable functional group and an anionic group. The copolymerization component is not particularly limited, and is selected in view of various points such as dispersion stability, compatibility with other monomer components and strength of a formed film. Preferred examples thereof include methyl (meth)acrylate, n-butyl (meth)acrylate, t-butyl (meth)acrylate, cyclohexyl (meth)acrylate and styrene.

The form of the dispersing agent is not particularly limited, but a block copolymer or a random copolymer is preferred, with a random copolymer being preferred in view of synthesizing ease.

The amount of the dispersing agent to be used for the inorganic particles is in the range of preferably from 1 to 50% by mass, more preferably from 5 to 30% by mass, most preferably from 5 to 20% by mass. Also, two or more kinds of the dispersing agents may be used in combination.

### 1-(13) Stain-Proof Agents

Preferably, known silicone series or fluorine series stain-proof agents or slipping agents are properly added to the film of the invention, particularly to the uppermost layer thereof for the purpose of imparting properties such as stain-proof properties, water resistance, chemical resistance and slipping properties.

In the case of adding these additives, they are added in a content of preferably from 0.01 to 20% by mass, more preferably from 0.05 to 10% by mass, particularly preferably from 0.1 to 5% by mass, based on the mass of the total solid components of the low refractive index layer.

As preferred examples of the silicone series compounds, there are illustrated those compounds which contain plural dimethylsilyloxy units as repeating units and which have substituents at the ends and/or side chains thereof. Other structural units than dimethylsilyloxy may be contained in the chains of the compounds containing dimethylsilyloxy as repeating unit. The substituents may be the same or different from each other, and plural substituents are preferably contained. Preferred examples of the substituents include groups containing an acryloyl group, a methoacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group. The molecular mass is not particularly limited, but is preferably 100,000 or less, more preferably 50,000 or less, particularly preferably from 3,000 to 30,000, most preferably from 10,000 to 20,000. The content of silicon atom in the silicone series compound is not particularly limited, and is preferably 18.0% by mass or more, particularly preferably from 25.0 to 37.8% by mass, most preferably from 30.0 to 37.0% by mass. Preferred examples of the silicone series compounds include X-22-174DX, X-22-2426, X-22-164B, X22-164C, X-22-170DX, X-22-176D, X-22-1821 (these being trade names) manufactured by Shin-Etsu Chemical Co., Ltd., FM-0725, FM-7725, FM-4421, FM-5521, FM-6621, FM-1121 (these being trade names) manufactured by Chisso Corp., DMS-U22, RMS-033, RMS-083, UMS-182, DMS-H21, DMS-H31, HMS-301, FMS121, FMS123, FMS131, FMS141 and FMS221 (these being trade names) manufactured by Gelest, which, however, are not limitative at all.

As the fluorine series compounds, compounds having a fluoroalkyl group are preferred. The fluoroalkyl group contains preferably from 1 to 20 carbon atoms, more preferably from 1 to 10 carbon atoms, and may be of a straight-chain structure (e.g., —CF₂CF₃, —CH₂(CF₂)₄H, —CH₂(CF₂)₈CF₃ or —CH₂CH₂(CF₂)₄H), a branched structure (e.g., CH(CF₃)₂, CH₂CF(CF₃)₂, CH(CH₃)CF₂CF₃ or CH(CH₃)(CF₂)₅CF₂H) or a alicyclic structure (having preferably a 5- or 6-membered ring, e.g., a perfluorocyclohexyl group, a perfluorocyclopentyl group or an alkyl group substituted by these groups) and may have an ether bond (e.g., CH₂OCH₂CF₂CF₃, CH₂CH₂OCH₂C₄F₈H, CH₂CH₂OCH₂CH₂C₈F₁₇ or CH₂CH₂OCF₂CF₂OCF₂CF₂H). Two or more of the fluoroalkyl groups may be contained in one and the same molecule.

The fluorine series compound preferably further contains a substituent which contributes to formation of bond with the low refractive index layer film or compatibility. Plural substituents, which may be the same or different, are preferably contained in the compound. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine series compound may be a polymer or oligomer with a fluorine atom-free compound and is not particularly limited as to its molecular mass. The content of fluorine atom in the fluorine series compound is not particularly limited, but is preferably 20% by mass or more, particularly preferably from 30 to 70% by mass, most preferably from 40 to 70% by mass. Preferred examples of the fluorine series compound include R-2020, M-2020, R-3833, M-3833 (these being trade names) manufactured by Daikin Industries, Megafac F-171, F-172, F-179A and Defencer MCF-300 (these being trade names) manufactured by Dainippon Ink & Chemicals, Inc.

Known cationic surfactants, dust-proof agents such as polyoxyalkylene series compounds, and antistatic agents may properly be added for the purpose of imparting properties such as dust-proof properties and antistatic properties. These dust-proof agents and antistatic agents may be incorporated as part of the functions of the structural units in the aforesaid silicone series compounds or the fluorine series compounds. In the case of adding these compounds as additives, the addition amount is in the range of preferably from 0.01 to 20% by mass, more preferably from 0.05 to 10% by mass, particularly preferably from 0.1 to 5% by mass, based on the mass of the whole solid components of the low refractive index layer. Preferred examples of the compound include Megafac F-150 (trade name) manufactured by Dainippon Ink & Chemicals, Inc. and SH-3748 (trade name) manufactured by Dow Corning Toray Co., Ltd. which, however, are not limitative at all.

### 1-(14) Surfactants

With the film of the invention, a fluorine-containing surfactant and/or a silicone series surfactant is preferably contained in a coating composition for forming the anti-glare layer thereof in order to ensure uniform surface properties free of coating unevenness, drying unevenness and dot defects. In particular, the fluorine-containing surfactants can preferably be used because they can provide the effect of removing troubles with surface properties such as coating unevenness, drying unevenness and dot defects when added in less amounts. Productivity can be enhanced by providing adaptability for high-speed coating with improving uniformity of surface properties.

Preferred examples of the fluorine-containing surfactants include fluoro-aliphatic group-containing copolymers (also abbreviated as “fluorine-containing polymers”). As the fluorine-containing polymers, acrylic resins and methacrylic resins containing the repeating unit of the following (i) and copolymers thereof with a viny monomer copolymerizable therewith (e.g., a monomer of the following (ii)) are useful.

(i) Fluoroaliphatic group-containing monomers represented by the following formula (A):

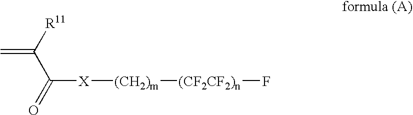

In the formula (A), R¹¹ represents a hydrogen atom or a methyl group, X represents an oxygen atom, a sulfur atom or —N(R¹²), m represents an integer of 1 to 6, and n represents an integer of 2 to 4. R¹² represents a hydrogen atom or an alkyl group containing from 1 to 4 carbon atoms, specifically a methyl group, an ethyl group, a propyl group or a butyl group, preferably a hydrogen atom or a methyl group. X preferably represents an oxygen atom.

(ii) Monomers copolymerizable with above-described (i) and represented by the following formula (B):

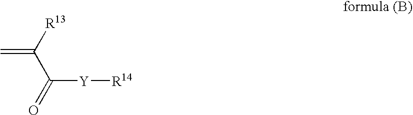

In the formula (B), R¹³ represents a hydrogen atom or a methyl group, Y represents an oxygen atom, a sulfur atom or —N(R¹⁵)—, R¹⁵ represents a hydrogen atom or an alkyl group containing from 1 to 4 carbon atoms, specifically a methyl group, an ethyl group, a propyl group or a butyl group, preferably a hydrogen atom or a methyl group. Y preferably represents an oxygen atom, —N(H)— or —N(CH₃)—.

R¹⁴ represents a straight-chain, branched or cyclic alkyl group containing from 4 to 20 carbon atoms and optionally having a substituent. Examples of the substituent for the alkyl group of R¹⁴ include a hydroxyl group, an alkylcarbonyl group, an arylcarbonyl group, a carboxyl group, an alkyl ether group, an aryl ether group, a halogen atom (e.g., a fluorine atom, a chlorine atom or a bromine atom), a nitro group, a cyano group and an amino group which, however, are not limitative at all. As the straight-chain, branched or cyclic alkyl group containing from 4 to 20 carbon atoms, a straight-chain or branched butyl group, pentyl group, hexyl group, heptyl group, octyl group, nonyl group, decyl group, undecyl group, dodecyl group, tridecyl group, tetradecyl group, pentadecyl group, octadecyl group or eicosanyl group, a monocyclic cycloalkyl group such as a cyclohexyl group or a cycloheptyl group, and polycyclic cycloalkyl group such as a bicycloheptyl group, a bicyclodecyl group, a tricycloundecyl group, a tetracyclododecyl group, an adamantly group, a norbornyl group or a tetracyclodecyl group can preferably be used.

The content of the fluoroaliphatic group-containing monomer represented by the formula (A) to be used in the fluorine-containing polymer used in the invention is from 10 mol % or more, preferably from 15 to 70 mol %, more preferably from 20 to 60 mol %, based on the mass of monomers of the fluorine-containing polymer.

The mass-average molecular mass of the fluorine-containing polymer to be used in the invention is preferably from 3,000 to 100,000, more preferably from 5,000 to 80,000.

Further, the addition amount of the fluorine-containing polymer to be used in the invention is in the range of preferably from 0.001 to 5% by mass, more preferably from 0.005 to 3% by mass, still more preferably from 0.01 to 1% by mass, based on the coating solution. In the case where the addition amount of the fluorine-containing polymer is within the above-described range, there result good drying properties of the coated film and good performance as a coated film (e.g., reflectance and scratch resistance).

### 1-(16) Coating Solvents

As a solvent to be used in a coating composition for forming each layer of the invention, various solvents can be used which are selected from the standpoints that individual components can be dissolved or dispersed, that uniform surface properties can easily be formed in the coating step and the drying step, that solution stability can be ensured, and that saturated vapor pressure thereof is appropriate.

Two or more solvents may be used in combination. Particularly, in view of drying load, it is preferred to use a solvent having a boiling point under ordinary pressure at room temperature of 100° C. or less as a major component and containing, for adjusting drying speed, a solvent having a boiling point of 100° C. or more in a small amount.

Examples of the solvent having a boiling point of 100° C. or less include hydrocarbons such as hexane (b.p. 68.7° C.), heptane (98.4° C.), cyclohexane (80.7° C.) and benzene (80.1° C.), halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.), ethers such as diethyl ether (34.6° C.), diisopropyl ether (68.5 C), dipropyl ether (90.5 C) and tetrahydrofuran (66° C.), esters such as ethyl formate (54.2 C), methyl acetate (57.8° C.), ethyl acetate (77.1° C.) and isopropyl acetate (89° C.), ketones such as acetone (56.1° C.) and 2-butanone (=methyl ethyl ketone; 79.6° C.), alcohols such as methanol (64.5° C.), ethanol (78.3° C.), 2-propanol (82.4° C.) and 1-propanol (97.2° C.), cyano compounds such as acetonitrile (81.6° C.) and propionitrile (97.4° C.), and carbon disulfide (46.2° C.). Of these, ketones and esters are preferred, and ketones are particularly preferred. Of the ketones, 2-butanone is particularly preferred.

Examples of the solvent having a boiling point of 100° C. or higher include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (=MIBK, 115.9° C.), 1-butanol (117.7° C.), N,N-dimethylformamide (153° C.), N,N-dimethylacetamide (166° C.) and dimethylsulfoxide (189° C.), with cyclohexanone and 2-methyl-4-pentanone being preferred.

### 1-(17) Others

In addition to the above-described components, resins, coupling agents, coloration-preventing agents, coloring agents (pigments and dyes), antifoaming agents, leveling agents, fire-retardants, UV ray-absorbing agents, infrared ray-absorbing agents, adhesion-imparting agents, polymerization inhibitors, antioxidants and surface-improving agents may be added to the film of the invention.

### 1-(18) Supports

The support of the film of the invention is not particularly limited and is exemplified by a transparent resin film, a transparent resin plate, a transparent resin sheet and a transparent glass. As the transparent resin film, there may be used a cellulose acylate film (e.g., a cellulose triacetate film (refractive index: 1.48), a cellulose diacetate film, a cellulose acetate butyrate film or a cellulose acetate propionate film), a polyethylene terephthalate film, a polyether sulfone film, a polyacrylic resin film, a polyurethane series resin film, a polyester film, a polycarbonate film, a polysulfone film, a polyether film, a polymethylpentene film, a polyether ketone film and a (meth)acrylonitrile film.

As to the thickness of the support, a support having a thickness of from about 25 μm to about 1,000 μm can usually be used, with the thickness being preferably from 25 μm to 250 μm, more preferably from 30 μm to 90 μm.

As the width of the support, a support of any width may be used but, in view of handling, yield and productivity, a support of from 100 to 5,000 mm is usually used, with the width being preferably from 800 to 3,000 mm, more preferably from 1,000 to 2,000 mm.

The surface of the support is preferably smooth, and the average roughness Ra is preferably 1 μm or less, more preferably from 0.0001 to 0.5 μm, still more preferably from 0.001 to 0.1 μm.

### <Cellulose Acylate Film>

Of the above-mentioned various films, a cellulose acylate film generally used as a protective film for a polarizing plate is preferred because it has a high transparency and a less optical birefringence and can be produced with ease.

Regarding the cellulose acylate film, various improving techniques have been known for improving its mechanical properties, transparency and smoothness, and the technique described in Kokai Giho 2001-1745 can be applied to the film of the invention as a known technique.

In the invention, a celluloe triacetate film is particularly preferred among cellulose acylate films, and cellulose acetate of from 59.0 to 61.5% in acetylation degree is preferably used. The term “acetylation degree” as used herein means the amount of acetic acid bound to a unit mass of cellulose. The acetylation degree is determined according to the measurement and calculation of acetylation degree described in ASTM:D-817 (Method of testing cellulose acetate, etc.).

The viscosity-average polymerization degree (DP) of the cellulose acylate is preferably 250 or more, more preferably 290 or more.

Also, the cellulose acylate to be used in the invention preferably has a value of Mw/Mn (Mw: mass-average molecular mass; Mn: number-average molecular mass) determined by gel permeation chromatography of approximately 1.0, in other words, a narrow molecular mass distribution. Specifically, the value of Mw/Mn is preferably from 1.0 to 1.7, more preferably from 1.3 to 1.65, most preferably from 1.4 to 1.6.

Generally, hydroxyl groups at 2, 3 and 6 positions of cellulose are not uniformly acylated each with a substitution degree of ⅓ of the whole substitution degree, but a substitution degree at the 6-position hydroxyl group tends to be smaller. In the invention, it is preferred that the substitution degree at the 6-position hydroxyl group of cellulose is larger than the substitution degrees at 2- and 3-positions.

It is preferred that the hydroxyl group at the 6-position is substituted by an acyl group with a substitution degree of 32% or more, more preferably 33% or more, particularly preferably 34% or more, based on the total substitution degree. Further, it is preferred that the substitution degree of the 6-position acyl group of cellulose acylate is 0.88 or more. The hydroxyl group at the 6-position may be substituted by an acyl group having 3 or more carbon atoms such as a propionyl group, a butyroyl group, a valeroyl group, a benzoyl group or an acryloyl group other than an acetyl group. The substitution degree at each position can be determined by measurement of NMR.

In the invention, cellulose acetate obtained by the process described in JP-A-11-5851, paragraphs [0043] to [0044], [Example], [Synthesis Example 1], paragraphs [0048] to [0049], [Synthesis Example 2], and paragraphs [0051] to [0052], [Synthesis Example 3] can be used.

### <Polyethylene Terephthalate Film>

In the invention, a polyethylene terephthalate film is also preferably used since it has excellent transparency, mechanical strength, smoothness, chemical resistance and moisture resistance and, in addition, it is inexpensive.

In order to more improve adhesion strength between the transparent plastic film and a hard coat layer to be provided thereon, it is more preferred that the transparent plastic film is a film having been subjected to a treatment of imparting readily adhering properties to the film.

As a PET film having a readily adhering layer for optical use, COSMOSHINE A4100 and A4300 manufactured by TOYOBO CO., LTD. can be mentioned.

### 2. Film-Forming Layers

Next, layers forming the film of the invention will be described below.

### 2-(1) Hard Coat Layer

In order to impart physical strength to the film of the invention, a hard coat layer is formed preferably on one side of the transparent support.

Preferably, a low refractive index layer is provided on the hard coat layer and, more preferably, a middle refractive index layer and a high refractive index layer are provided between the hard coat layer and the low refractive index layer to constitute an anti-reflection film.

The hard coat layer may be constituted by two or more laminated layers.

The refractive index of the hard coat layer in the invention is in the range of preferably from 1.48 to 2.00, more preferably from 1.5 to 1.90, still more preferably from 1.5 to 1.60, based on optical design for obtaining an anti-reflection film. In the invention, since at least one low refractive index layer is provided on the hard coat layer, anti-reflection ability tends to be decreased when the refractive index is smaller than the range, whereas tint of the reflected light tends to be strengthened when the refractive index is larger than the range.

The thickness of the hard coat layer is usually from about 5 μm to about 50 μm, preferably from 8 μm to 17 μm, still more preferably from 10 μm to 15 μm, in view of imparting enough durability and impact resistance to the film.

Also, the strength of the hard coat layer is preferably H or more, still more preferably 2H or more, most preferably 3H or more, according to the pensile hardness test.

Further, regarding the amount of abrasion of a test piece after Taber abrasion test according to JIS K5400, a hard coat layer having a smaller abrasion amount is more preferred.

The hard coat layer is formed preferably by cross-linking reaction of polymerization reaction of a compound curable with ionization radiation. For example, it can be formed by coating on a transparent support a coating composition containing a multi-functional monomer or multi-functional oligomer which can be cured by ionization radiation, and performing cross-linking reaction or polymerization reaction of the multi-functional monomer or multi-functional oligomer.

As the functional group of the ionization radiation-curable, multi-functional monomer or multi-functional oligomer, those functional groups which can be polymerized by light, electron beams or radiation are preferred, with photo-polymerizable functional groups being particularly preferred.

As the photo-polymerizable functional groups, there are illustrated unsaturated polymerizable functional groups such as a (meth)acryloyl group, a vinyl group, a styryl group and an allyl group. Of these, a (meth)acryloyl group is preferred.

To the binder of the hard coat layer may be added a high refractive index monomer or inorganic particles, or both of them, for the purpose of controlling the refractive index of the hard coat layer. The inorganic particles have the effect of suppressing curing contraction due to the cross-linking reaction in addition to the effect of controlling the refractive index. In the invention, a mixture of a polymer produced by polymerization of the multi-functional monomer and/or the high refractive index monomer and the inorganic particles dispersed therein is referred to as a binder.

The surface haze of the hard coat layer is preferably 7% or less, more preferably from 1% to 7%, still more preferably from 2% to 6.5%. In this region, both anti-glare properties and suppression of white blurring can be obtained, thus such region being preferred.

In the case where a pattern of a liquid crystal panel, color unevenness, luminance unevenness and dazzling are intended to be made difficult to observe or where a function of enlarging the viewing angle is intended to impart, by internal scattering of the hard coat layer, the internal haze value (a value obtained by subtracting the surface haze value from the whole haze value) is preferably 35% or less, more preferably from 1% to 30%, still more preferably from 2% to 25%.

As to the surface unevenness state of the hard coat layer, the center-line average roughness (Ra), for example, of the properties showing surface roughness is preferably made 0.10 μm or less in order to obtain a clear surface for the purpose of maintaining clearness of an image. Ra is more preferably 0.09 μm, still more preferably 0.08 μm or less. In the film of the invention, the surface unevenness is dominated by the surface roughness of the hard coat layer, and hence the center-line average roughness of the anti-reflection film can be made within the above-described range by controlling the center-line roughness of the hard coat layer.

In order to maintain sharpness of an image, it is preferred to adjust clearness of a transmitted image as well as to adjust the surface unevenness. The clearness of a transmitted image of a clear anti-reflection film is preferably 60% or more. The clearness of a transmitted image is generally an indicator showing the degree of blurring of an image viewed through a film. A larger value of the clearness shows that an image viewed through the film is clearer and better. The clearness of a transmitted image is preferably 70% or more, more preferably 80% or more.

### 2-(2) Anti-Glare Layer

The hard coat layer can impart anti-glare properties due to surface scattering to the film in addition to hard coat properties for improving scratch resistance of the film (hereinafter, this constituent layer is referred to as “anti-glare layer”).

As methods for forming the anti-glare layer, there have been known a method of laminating a matted shaping film having fine unevenness on the surface as described in JP-A-6-16851, a method of forming the anti-glare layer by curing contraction of an ionization radiation-curable resin caused by difference in irradiation amount of ionization radiation as described in JP-A-2000-206317, a method of forming unevenness on a coated film surface by solidifying a system of light-transmitting particles and a light-transmitting resin while gelling by reducing the mass ratio of the light-transmitting resin to a good solvent by drying as described in JP-A-2000-338310, and a method of forming unevenness on the surface by applying pressure from outside as described in JP-A-2000-275404, and these known methods can be utilized.

The anti-glare layer to be used in the invention preferably contains, as necessary components, a binder capable of imparting hard coat properties, matt particles for imparting anti-glare properties (preferably light-transmitting particles) and a solvent, with the surface unevenness being formed by projections of the light-transmitting particles themselves or projections formed by aggregates of plural particles.

The anti-glare layer formed by dispersion of the light-transmitting particles comprises a binder and the light-transmitting particles dispersed therein. The anti-glare layer having anti-glare properties preferably has both anti-glare properties and hard coat properties.

Preferred specific examples of the matt particles (light-transmitting particles) include particles of inorganic compounds such as silica particles and TiO₂ particles; and resin particles such as acryl particles, cross-linked acryl particles, polystyrene particles, cross-linked styrene particles, melamine resin particles and benzoquanamine resin particles. Of these, cross-linked styrene particles, cross-linked aryl particles and silica particles are preferred.

As to shape of the matt particles, either of spherical particles and amorphous particles may be used.

Also, two or more kinds of matt particles different from each other in particle size may be used in combination thereof. It is possible to impart anti-glare properties by particles of the larger particle size and optical properties by other particles of the smaller particle size. For example, in the case of sticking an anti-glare, anti-reflection film onto a highly fine display of 133 ppi or more, there arises in some cases a trouble with display image quality, called “dazzling”. “Dazzling” is caused by unevenness on the surface of the anti-glare, anti-reflection film which unevenness enlarges or contracts pixels to spoil uniformity of luminance. This can markedly be reduced by using matt particles having a particle size smaller than the matt particles for imparting anti-glare properties and having a refractive index different from that of the binder.

### 2-(3) High Refractive Index Layer and Middle Refractive Index Layer

A high refractive index layer and a middle refractive index layer may be provided in the film of the invention to enhance anti-reflection properties.

In this specification, this high refractive index layer and the middle refractive index layer are in some cases inclusively referred to as high refractive index layers hereinafter. Additionally, in the invention, “high”, “middle” and “low” of the high refractive index layer, middle refractive index layer and low refractive index layer mean relative relation of the layers with respect to refractive index magnitude. As to relation with the transparent support, the refractive indexes thereof preferably satisfy the relation of transparent support>low refractive index layer and high refractive index layer>transparent support.

Also, in this specification, the high refractive index layer, the middle refractive index layer and the low refractive index layer are in some cases inclusively referred to as anti-reflection layers.

In order to constitute the low refractive index layer on the high refractive index layer to prepare an anti-reflection film, the refractive index of the high refractive index layer is preferably from 1.55 to 2.40, more preferably from 1.0 to 2.20, still more preferably from 1.65 to 2.10, most preferably from 1.80 to 2.00.

In the case of forming the middle refractive index layer, the high refractive index layer and the low refractive index layer in this order from the support by coating, the refractive index of the high refractive index layer is preferably from 1.65 to 2.40, more preferably from 1.70 to 2.20. The refractive index of the middle refractive index layer is adjusted to be a value between the refractive index of the low refractive index layer and the refractive index of the high refractive index layer. The refractive index of the middle refractive index layer is preferably from 1.55 to 1.80.

Inorganic particles containing TiO₂ as a major component to be used in the high refractive index layer and the middle refractive index layer are used in a state of dispersion in the middle refractive index layer and the middle refractive index layer.

In dispersing the inorganic particles, they are dispersed in a dispersing medium in the presence of a dispersing agent.

The high refractive index layer and the middle refractive index layer are formed preferably by preparing a coating composition for forming the high refractive index layer or the middle refractive index layer by preferably further adding a binder precursor for forming a matrix (e.g., multi-functional monomer or multi-functional oligomer which can be cured by ionization radiation to be described hereinafter) and a photo-polymerization initiator to a dispersion of the inorganic particles in a dispersing medium, coating the coating composition for forming the high refractive index layer or the middle refractive index layer on a transparent support and performing cross-linking reaction or polymerization reaction of the ionization radiation-curable compound (e.g., a multi-functional monomer or a multi-functional oligomer).

Further, the binder of the high refractive index layer and the middle refractive index layer is preferably subjected to the cross-linking reaction or polymerization reaction with a dispersing agent simultaneously with or after coating of the layer.

In the binder of the thus-formed high refractive index layer and the middle refractive index layer, the above-described preferred dispersing agent and the ionization radiation-curable multi-functional monomer or oligomer undergo cross-linking reaction or polymerization reaction to form a binder wherein the anionic group of the dispersing agent is taken. Further, the anionic group of the binder of the high refractive index layer and the middle refractive index layer functions to maintain the dispersion state of the inorganic particles, and the cross-linked or polymerized structure imparts film-forming properties to the binder, thus physical properties, chemical resistance and weatherability of the high refractive index layer and the middle refractive index layer being improved.

The binder of the high refractive index layer is added in a content of from 5 to 80% by mass based on the mass of solid components of the coating composition for forming the layer.

The content of the inorganic particles in the high refractive index layer is preferably from 10 to 90% by mass, more preferably from 15 to 80% by mass, particularly preferably from 15 to 75% by mass, based on the mass of the high refractive index layer. Two or more kinds of inorganic particles may be used in combination within the high refractive index layer.

In the case of providing a low refractive index layer on the high refractive index layer, the refractive index of the high refractive index layer is preferably higher than the refractive index of the transparent support.

In the high refractive index layer can also preferably be used a binder obtained by cross-linking or polymerization reaction of an ionization radiation-curable compound containing an aromatic ring, an ionization radiation-curable compound containing a halogen other than fluorine (e.g., Br, I or Cl) or an ionization radiation-curable compound containing an atom such as S, N or P.

The film thickness of the high refractive index layer can properly be designed according to the use. In the case of using the high refractive index layer as an optical interference layer to be described hereinafter, the thickness is preferably from 30 to 200 nm, more preferably from 50 to 170 nm, particularly preferably from 60 to 150 nm.

In the case where particles for imparting anti-glare properties are not incorporated, the lower the haze of the high refractive index layer, the more preferred. It is preferably 5% or less, more preferably 3% or less, particularly preferably 1% or less.

The high refractive index layer is constituted directly on the transparent support or via other layer.

### 2-(4) Low Refractive Index Layer

In order to reduce the reflectance of the film of the invention, it is necessary to use a low refractive index layer.

The refractive index of the low refractive index layer is preferably from 1.20 to 1.46, more preferably from 1.25 to 1.46, particularly preferably from 1.30 to 1.46.

The thickness of the low refractive index layer is preferably from 50 to 200 nm, more preferably from 70 to 100 nm. The haze of the low refractive index layer is preferably 3% or less, more preferably 2% or less, most preferably 1% or less. The specific strength of the low refractive index layer is preferably H or more, more preferably 2H or more, most preferably 3H or more, according to the pensile hardness test.

Also, in order to improve stain-proof properties of the optical film, the contact angle of the surface for water is preferably 90° or more, more preferably 95° or more, particularly preferably 100° or more.

A curable composition for forming the low refractive index layer preferably contains (A) the fluorine-containing polymer, (B) inorganic particles and (C) an organosilane compound.

A binder is used in the low refractive index layer for dispersing and fixing the fine particles of the invention. As the binder, those binders which have been described with respect to the hard coat layer can be used, and a fluorine-containing polymer having itself a low refractive index or a fluorine-containing sol-gel material is preferably used. As the fluorine-containing polymer or the fluorine-containing sol-gel, those materials which can be cross-linked by heat or ionization radiation and which form a low refractive index layer having a surface kinetic friction coefficient of from 0.03 to 0.30 and a contact angle for water of from 85 to 120° are preferred.

### 2-(5) Antistatic Layer and Electrically Conductive Layer

In the invention, to provide an antistatic layer is preferred in view of preventing static electricity on the film surface. As methods for forming the antistatic layer, there can be illustrated conventionally known methods such as a method of coating an electrically conductive coating solution containing electrically conductive fine particles and a reactive curable resin and a method of forming an electrically conductive thin film by vacuum deposition or sputtering of a metal or a metal oxide capable of forming a transparent film. The electrically conductive layer can be formed directly on the support or via a primer layer which strengthen adhesion to the support. It is also possible to use the antistatic layer as part of the anti-reflection layer. With this embodiment, in the case where the antistatic layer is used as a layer near the outermost layer, an antistatic layer having a small thickness suffices to obtain sufficient antistatic properties.

The thickness of the antistatic layer is preferably from 0.01 to 10 μm, more preferably from 0.03 to 7 μm, still more preferably from 0.05 to 5 μm. The surface resistance of the antistatic layer is preferably from 10⁵ to 10¹² Ω/sq, more preferably from 10⁵ to 10⁹ Ω/sq, most preferably from 10⁵ to 10⁸ Ω/sq. The surface resistance of the antistatic layer can be measured by the 4-probe method.

The antistatic layer is preferably substantially transparent. Specifically, the haze of the antistatic layer is preferably 10% or less, more preferably 5% or less, still more preferably 3% or less, most preferably 1% or less. The transmittance for light of 550 nm in wavelength is preferably 50% or more, more preferably 60% or more, still more preferably 65% or more, most preferably 70% or more.

The antistatic layer of the invention has an excellent strength. Specifically, the strength of the antistatic layer is preferably H or more, more preferably 2H or more, still more preferably 3H or more, most preferably 4H or more, in terms of pencil strength under a load of 1 kg.

### 2-(6) Stain-Proof Layer

A stain-proof layer can be provided on the outermost surface of the film of the invention. The stain-proof layer functions to reduce surface energy of the anti-reflection layer to make it difficult for hydrophilic or oleophilic stain to deposit thereon.

The stain-proof layer can be formed by using a fluorine-containing polymer or a stain-proof agent.

The thickness of the staqin-proof layer is preferably from 2 to 100 nm, more preferably from 5 to 30 nm.

### 2-(7) Layer for Preventing Interference Unevenness (Rainbow Unevenness)

In the case where there exists a substantial difference in refractive index (0.03 or more in refractive index) between the transparent support and the hard coat layer or between the transparent support and the anti-glare layer, a reflected light is generated at the transparent support/hard coat layer interface or the transparent support/anti-glare layer interface. This reflected light interferes with a reflected light at the surface of the anti-reflection layer to generate in some cases interference unevenness due to slight unevenness of thickness of the hard coat layer (or the anti-glare layer). In order to prevent such interference unevenness, an interference unevenness-preventing layer having a middle refractive index np and having a thickness satisfying the following formula can be provided, for example, between the transparent support and the hard coat layer (or the antiglare layer):

d_{P}=(2N−1)×λ/(4n_{P})

wherein λ represents a wavelength of visible light of any value in the range of from 450 to 650 nm, and N represents a natural number.

In the case of sticking the anti-reflection film onto an image display, there is a case where a tackifier layer (or an adhesive layer) is laminated on the opposite side of the transparent support to the anti-reflection layer-laminated side. In such embodiment, in the case where there exists a substantial difference in refractive index (0.03 or more in refractive index) between the transparent support and the tackifier layer (or the adhesive layer), a reflected light is generated at the transparent support/tackifier layer (or adhesive layer). This reflected light interferes with a reflected light at the surface of the anti-reflection layer to generate in some cases interference unevenness due to unevenness of thickness of the support or the hard coat layer as is the same as described above. It is possible to provide the same interference unevenness-preventing layer as described above on the opposite side of the transparent support to the anti-reflection layer-laminated side in order to prevent such interference unevenness.

Additionally, regarding the interference unevenness-preventing layer, detailed description is given in JP-A-2004-345333, and the interference unevenness-preventing layer introduced there can also be employed in the invention.

### 2-(8) Readily Adhering Layer

A readily adhering layer can be provided by coating in the film of the invention. The readily adhering layer means, for example, a layer imparting the function of readily adhering properties between a protective layer for a polarizing plate and a layer adjacent thereto or between the hard coat layer and the support.

As the treatment for imparting readily adhering properties, there can be illustrated a treatment of providing a readily adhering layer on a transparent plastic film by using a readily adhering adhesive comprising a polyester, an acrylic ester, polyurethane, polyethyleneimine or a silane coupling agent.

Examples of the readily adhering layer to be preferably used in the invention include a layer containing a high molecular compound which has —COOM group (wherein M represents a hydrogen atom or a cation). In a preferred embodiment, a layer containing a —COOM group-having high molecular compound is provided on the film substrate side, and a layer containing a hydrophilic high molecular compound as a major component is provided adjacent thereto on the polarizing film side. The —COOM group-having high molecular compound is, for example, a styrene-maleic acid copolymer having —COOM group, a vinyl acetate-maleic acid copolymer having —COOM group or a vinyl acetate-maleic acid-maleic anhydride copolymer. Use of a vinyl acetate-maleic acid copolymer having —COO group is particularly preferred. These high molecular compounds are used independently or in combination of two or more thereof, and the mass-average molecular mass thereof is preferably from about 500 to about 500,000. As particularly preferred examples of the —COOM group-having high molecular compound, those which are described in JP-A-6-094915 and JP-A-7-333436 are preferably used.

Also, preferred examples of the hydrophilic high molecular compound include hydrophilic cellulose derivatives (e.g., methyl cellulose, carboxymethyl cellulose and hydroxycellylose), polyvinyl alcohol derivatives (e.g., polyvinyl alcohol, vinyl acetate-vinyl alcohol copolymer, polyvinyl acetal, polyvinyl formal and polyvinyl benzal), natural high molecular compounds (e.g., gelatin, casein and gum arabi), hydrophilic polyester derivatives (e.g., partially sulfonated polyethylene terephthalate), and hydrophilic polyvinyl derivatives (e.g., poly-N-vinylpyrrolidone, polyacrylamide, polyvinylindazole and polyvinylpyrazole). These are used independently or in combination of two or more thereof.

The thickness of the readily adhering layer is in the range of preferably from 0.05 to 1.0 μm. Sufficient adhering properties can be obtained when the thickness is 0.05 μm or more. The effects of adhering properties are saturated when the thickness is more than 1.0 μm.

### 2-(9) Curl-Preventing Layer

The film of the invention can be subjected to curl-preventing processing. The curl-preventing processing is a processing of imparting such function that the film having been subjected to the processing tends to roll up with the processed surface inside. This processing serves to prevent, when one side of the transparent resin film is subjected to some surface processing to perform different degrees and different kinds of surface processing on both sides thereof, the film from curling with the surface subjected to some surface processing inside.

In one embodiment, the curl-preventing layer is provided on the opposite side of a transparent support (transparent resin film) to the side having the optical layer or, in another embodiment, a readily adhering layer, for example, is provided by coating on one side of the transparent support. In addition, there is an embodiment wherein the reverse side is to be subjected to the curl-preventing processing.

As specific methods for the curl-preventing processing, there are a method of coating a solvent and a method of coating a solvent and a transparent resin layer of cellulose triacetate, cellulose diacetate or cellulose acetate propionate. The method of coating a solvent is specifically conducted by coating a composition containing a solvent which can dissolve or swell a cellulose acylate film to be used as a protective film for a polarizing plate. Therefore, the coating solution for forming the layer having the curl-preventing ability preferably contains a ketone series or ester series organic solvent. Examples of preferred ketone series organic solvent include acetone, methyl ethyl ketone, methyl isobutyl ketone, cyclohexanone, ethyl lactate, acetylacetone, diacetone alcohol, isophorone, ethyl n-butyl ketone, diisopropyl ketone, diethyl ketone, di-n-propyl ketone, methylcyclohexanone, methyl n-butyl ketone, methyl n-propyl ketone, methyl n-hexyl ketone and methyl n-heptyl ketone, and preferred examples of ester series organic solvent include methyl acetate, ethyl acetate, butyl acetate, methyl lactate and ethyl lactate. However, as the solvent, non-dissolving solvents may be contained as well as mixtures of dissolving solvents and/or swelling solvents. These solvents are mixed with proper proportions and are used in proper amounts depending upon the curling degree of the transparent resin film or upon kinds of resins to perform the curl-preventing processing. Besides, curl-preventing function can be obtained by conducting transparent hard processing or antistatic processing.

### 2-(10) Water-Absorbing Layer

A water-absorbing agent may be used in the film of the invention. The water-absorbing agent can be selected from among compounds having water-absorbing function, mainly from among alkaline earth metals. For example, BaO, SrO, CaO and MgO can be mentioned. Further, the agent can be selected from among metal elements such as Ti, Mg, Ba and Ca. The particle size of the absorbing agent particles is preferably 100 nm or less. Particles of 50 nm or less in particle size are more preferred to use.

The layer containing these water-absorbing agents may be formed by employing the vacuum deposition method as is the same with the foregoing barrier layer, or nano particles may be formed by various methods to use. The thickness of the layer is preferably from 1 to 100 nm, more preferably from 1 to 10 nm. The layer containing the water-absorbing agent may be provided between the support and the laminate (laminate of the barrier layer and the organic layer), as the uppermost layer of the laminate, or between laminate layers. Or, the agents may be added to the organic layer or the barrier layer of the laminate. In the case of adding to the barrier layer, use of a vacuum co-deposition method is preferred.

### 2-(11) Primer Layer and Inorganic Thin Film Layer

In the film of the invention, a known primer layer or inorganic thin film layer may be provided between the support and the laminate to enhance gas barrier properties.

For such primer layer, an acryl resin, an epoxy resin, a urethane resin or a silicone resin may be used for instance. In the invention, however, an organic/inorganic hybrid layer is preferred as the primer layer, and an inorganic vacuum deposition layer or a dense inorganic coating thin film formed by the sol-gel process is preferred as the inorganic thin layer. As the inorganic vacuum deposition layer, a vacuum deposition layer of silica, zirconia or alumina is preferred. The inorganic vacuum deposition layer can be formed by the vacuum deposition method or the sputtering method.

### 3. Production Process

The film of the invention can be formed by the following process which, however, is not limitative at all.

### 3-(1) Preparation of a Coating Solution

### <Preparation>

First, coating solutions containing components for individual layers are prepared. In this occasion, an increase in water content of the coating solution can be suppressed by minimizing the evaporation amount of the solvent. The water content of the coating solution is preferably 5% or less, more preferably 2% or less. Suppression of evaporation of the solvent can be attained by improving tank tightness while stirring after charging individual materials to a tank and by minimizing the area of the coating solution in contact with air during solution-transporting work. It is also possible to provide means for reducing the water content of the coating solution during coating, or before or after coating.

### <Filtration>

The coating solution to be used for coating is preferably filtered before coating. As the filter, a filter having a pore size as mall as possible within the range of not removing components in the coating solution is preferred. A filter of from 0.1 to 50 μm in absolute filtration accuracy is used for the filtration. Further, a filter of from 0.1 to 40 μm in absolute filtration accuracy is more preferably used. The thickness of the filter is preferably from 0.1 to 10 mm, more preferably from 0.2 to 2 mm. In this occasion, the filtration pressure for filtration is preferably 1.5 MPa or less, more preferably 1.0 MPa or less, still more preferably 0.2 MPa or less.

The filter material for filtration is not particularly limited as long as it does not affect the coating solution.

It is also preferred to subject the filtered coating solution to ultrasonic dispersion immediately before coating to thereby aid to defoam and maintain dispersion state of the dispersion.

### 3-(2) Treatment Before Coating

The support to be used in the invention is preferably subjected to surface treatment prior to coating. Specific treating methods include corona discharge treatment, glow discharge treatment, flame treatment, acid treatment, alkali treatment and UV ray irradiation treatment. It is also preferably utilized to provide an undercoat layer as described in JP-A-7-333433.

Further, as a dust-removing method to be employed in the dust-removing step provided as a step prior to coating, there are illustrated dry type dust-removing methods such as a method of pressing unwoven fabric or a blade onto the film surface as described in JP-A-59-150571, a method of blowing a highly pure air at a high speed against the film surface to remove deposits from the surface and sucking the air through a sucking opening provided in the vicinity of the surface as described in JP-A-10-309553, and a method of blowing a compressed air having ultrasonic vibration against the film surface to remove and suck deposits as described in JP-A-7-333613 (e.g., New Ultra Cleaner manufactured by Shinko-sha).

Also, there may be employed wet type dust-removing methods such as a method of introducing the film into a washing tank and removing deposits by means of an ultrasonic wave oscillator, a method of supplying a washing solution to the film and blowing and sucking a high-speed air as described in JP-B-49-13020, and a method of continuously rubbing the web with a roll wetted with a liquid and jetting the liquid against the rubbed surface to wash as described in JP-A-2001-38306. Of these dust-removing methods, the method of removing dust by ultrasonic wave or the wet type dust-removing method is particularly preferred in view of dust-removing effect.

It is particularly preferred to remove static electricity on the film support before the dust-removing step in the point of enhancing dust-removing efficiency and suppressing deposition of dust. As to such static electricity-removing method, an ionizer of corona discharge type or an ionizer of irradiating light such as UV or soft X rays can be employed. The charged voltage of the film support before and after dust removal and coating is desirably 1,000 V or less, preferably 300 V or less, particularly preferably 100 V or less.

In view of maintaining flatness of the film, the temperature of the cellulose acylate film during these treatments is preferably kept at a level of Tg or less, specifically 150° C. or less.

In the case where the cellulose acylate film is adhered to a polarizing film as in the case of using the film of the invention as a protective film for a polarizing plate, acid treatment or alkali treatment, i.e., saponification treatment of cellulose acylate, is particularly preferably performed in view of adhesion to the polarizing film.

In view of adhesion properties, the surface energy of the cellulose acylate film is preferably 55 mN/m or more, more preferably from 60 mN/m to 75 mN/m, and can be adjusted by the above-mentioned surface treatments.

### 3-(3) Coating

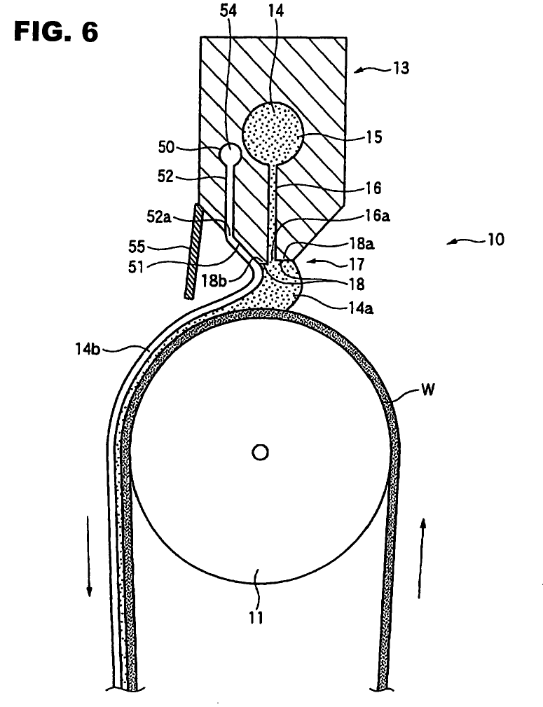

Embodiments of the invention will be described below by reference to drawings. FIG. 6 is a cross-sectional view showing a coater which can be used for performing the invention. In a coater 10 in FIG. 6, a web W of a transparent support continuously running in the state of being supported on a backup roll 11 is coated with a coating solution 14 for forming a lower layer through a slot die 13 with forming a bead 14a. A slide type coating head is provided in the vicinity of the tip of the slot die 13 (in FIG. 6, upward side of the slot die 13), and a coating solution for forming an upper layer flows down along a slide 51, thus the two layers including the lower layer being coated on the web W to form a coated film 14b. In the production of the anti-reflection film of the invention, the hard coat layer and the low refractive index layer can be formed at once without winding, thus this embodiment being preferred.

That is, the hard coat layer is coated on the transparent support by using the slot die 13 while the transparent support continuously running in a state of being supported on the backup roll 11 and, at the same time, the low refractive index layer is coated on the hard coat layer by using the slide type coating head disposed in the vicinity of the tip of the slot die.

Such coating method is particularly preferred for forming an upper layer of 200 nm or less, preferably from 10 to 120 nm, in the thickness after curing.

Pockets 15 and 50 and slots 16 and 52 are formed inside the slot die 13. The pockets 15 and 50 have cross-sections constituted by a curve and a straight line, and may have, for example, an approximately circular shape or a semicircular shape. The pockets 15 and 50 are liquid reservoir spaces extending in the width direction of the slot die with the cross-sectional shape, and their effective lengths are generally the same as, or slightly longer than, the coating width. Coating solutions are fed to the pockets 15 and 50 from the side surface of the slit die 13 or from the center of the opposite surface to the slot opening 16a. Also, the pockets 15 and 50 are equipped with stoppers for preventing leakage of the coating solutions.

A slot 16 is a flow path for a coating solution 14 from the pocket 15 to the web W, and extends in the width direction of the slot die 13 with the cross-sectional shape as is the same with the pocket 15. The opening 16a positioned on the web side is generally adjusted so that the width becomes about the same as the coating width by using a width-controlling plate or the like not shown. The angle between the slot 16 and the tangential line of the backup roll 11 in the web-running direction at the slot tip is preferably from 30° to 90°.

A slot 52 is a flow path for a coating solution 54 from the pocket 50 to the slide 51, and extends in the width direction of the slot die 13 with the cross-sectional shape as is the same with the pocket 15. The opening 52a positioned on the web side is generally adjusted so that the width becomes about the same as the coating width by using a width-controlling plate or the like not shown.

A tip lip 17 of the slot die 13 where the opening 16a of the slot 16 is positioned is tapered off, and the tip forms a flat portion 18 called land. With this land 18, an upstream side of the running direction of the web W with respect to the slot 16 is called an upstream side lip land 18a, and a downstream side is called a downstream side lip land 18b.

The slide 51 is positioned at the upper surface of the slot die 13, and a coating solution flows down from the pocket 50. The slide 51 is adjusted so that the width thereof becomes about the same as the coating width.

The length of the slide surface is in the range of preferably from 1.5 mm to 50 mm, more preferably from 1.5 mm to 20 mm, most preferably from 2 mm to 10 mm. The length of the slide surface is preferably adjusted according to the viscosity of the coating solution or the volatility of a solvent to be used.

The coating amount fed from the slide type coating head is preferably 100 m/m² or less, more preferably from 1 to 80 ml/m², still more preferably from 2 to 50 ml/m².

In order to prevent vaporization of the coating solution on the slide surface, it is desirable to provide a cover which covers the whole slide surface. The cross-sectional area surrounded by a cover 55, the slide 51 and the backup roll W is preferably 550 mm² or less, more preferably 250 mm² or less, most preferably 60 mm or less.

Additionally, the slide type coating head is known and is disclosed in, for example, JP-A-2003-164788.

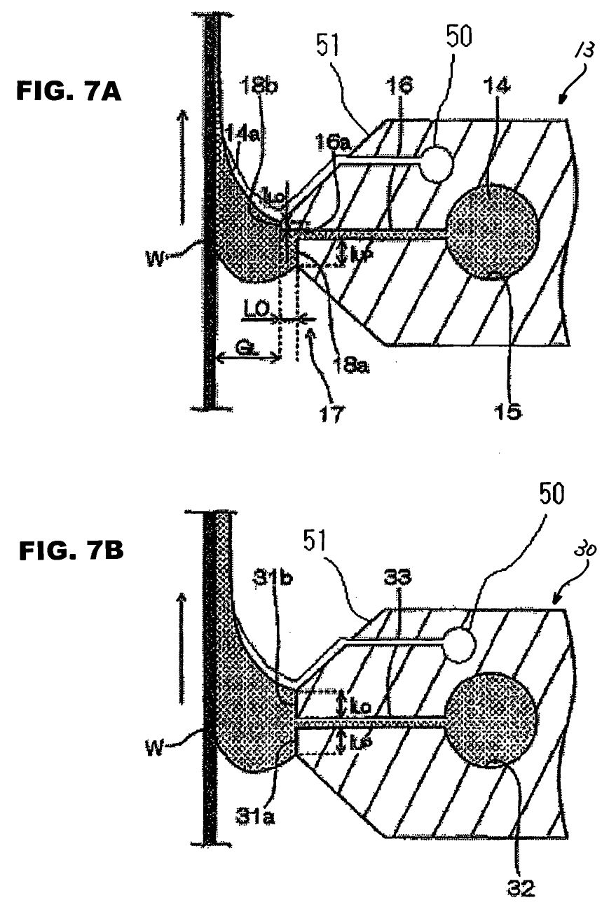

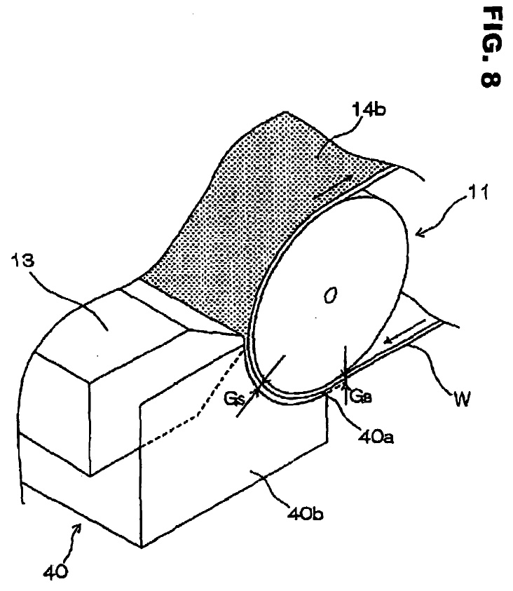

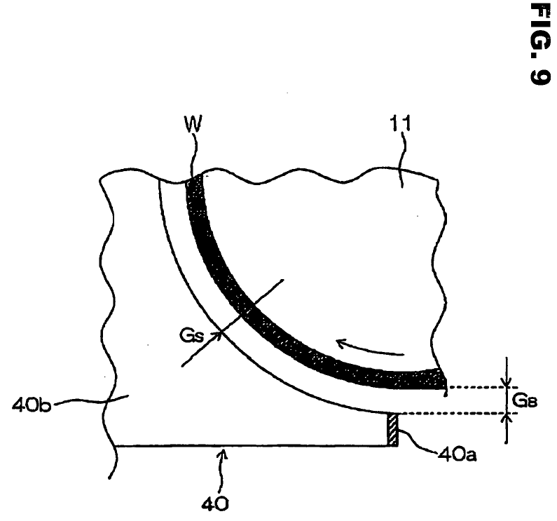

FIG. 7A is a view showing the cross-sectional shape of the slot die 13. In the slot die shown by FIG. 7B, the distance between the upstream lip land 31a and the web W is the same as the distance between the downstream lip land 31b and the web W. Additionally, numeral 32 designates a pocket, and numeral 33 designates a slot. On the other hand, in the slot die shown by FIG. 7A, the length of the downstream side lip land, I_{LO}, is made shorter, whereby coating with a wet film thickness of 20 μm or less being performed with good accuracy.

The length of the upstream side lip land 18a in the web W running direction, I_{UP}, is not particularly limited, and is preferably in the range of from 500 μm to 1 mm. The length of the downstream side lip land 18b in the web W running direction, I_{LO}, is from 30 μM to 100 μm, preferably from 30 μm to 80 μm, still more preferably from 30 μm to 60 μm. In the case where the downstream side lip land length I_{LO} is 30 μm or more, chipping of the edge of the tip lip or of the land and streaks in a coated film can be prevented. Also, it becomes easy to set up a position of wetting line on the downstream side, there does not arise the problem that the coating solution tends to spread on the downstream side. It has conventionally been known that this wetting spread of the coating solution on the downstream side means non-uniformity of the wetting line and leads to the problem of causing streaks or like troubles on the coated surface. On the other hand, in the case where the downstream side lip land length I_{LO} is 100 μm or less, there result good bead-forming properties which permit good coating of a thin layer.

Further, the downstream side lip land 18b has an over-bite shape of being closer to the web W than the upstream side lip land 18a, which serves to reduce the degree of pressure reduction to give a bead adapted for coating a thin film. The difference between the distance between the downstream side lip land 18b and the web W and the distance between the upstream side lip land 18a and the web W (hereinafter referred to as “over-bite length LO”) is preferably from 30 μm to 120 μm, more preferably from 30 μm to 100 μm, most preferably from 30 μm to 80 μm. In the case where the slot die 13 has the over-bite shape, a gap G_{L} between the tip lip 17 and the web W means the gap between the downstream side lip land 18b and the web W.

### <Coating Speed>

Use of the thickening agent of the invention ensures a high stability of film thickness upon coating at a high speed employing the coating system to be preferably used in the invention. Further, since the coating system is a pre-metering system, it is easy to ensure a stable film thickness even upon high-speed coating. With a coating solution to be coated in a small coating amount, the coating system can perform coating with a good stable film thickness at a high speed. Although coating can be performed by other coating system, a dip coating method can not avoid vibration of a coating solution in a liquid-receiving tank, and stepped unevenness tends to occur. With a reverse roll coating method, stepped unevenness tends to occur due to eccentricity or deflection of rolls participating in coating. Also, since these coating systems are post-metering systems, it is difficult to ensure a stable film thickness. In view of productivity, it is preferred to coat at a speed of 25 m/min or more by using the above-described coating method.

### 3-(4) Drying

Preferably, the film of the invention is coated on a support directly or via other layer, and then conveyed on a web to a heated zone for drying to remove a solvent.

As a method of removing the solvent by drying, various techniques can be utilized. As specific techniques, there can be illustrated those which are described in JP-A-2001-286817, JP-A-2001-314798, JP-A-2003-126768, JP-A-2003-315505 and JP-A-2004-34002.

The temperature in the drying zone is preferably from 25° C. to 140° C. Preferably, the temperature of the first half of the drying zone is comparatively low, whereas the temperature of the second half is comparatively high. However, the temperature is preferably lower than the temperature at which evaporation of other components than the solvent contained in the coating solution for forming each layer initiates. For example, with some of commercially available photo radical generators to be used in combination with UV ray-curable resins, about several ten % of them will evaporate within several minutes in a 120° C. warm air. Also, with some of the mono-functional or bi-functional acrylate monomers, evaporation proceeds in a 100° C. warm air. In such case, as described above, the drying temperature is preferably lower than the temperature at which evaporation of other components than the solvent contained in the coating solution for forming each layer initiates.

Also, with a drying air to be used after coating individual coating compositions on the support, the air velocity at the coated film is in the range of preferably from 0.1 to 2 m/sec during a period wherein the concentration of solids in the coating compositions is between 1 and 50% in order to prevent drying unevenness.

Also, after coating individual coating compositions for forming individual layers, the temperature difference between the support and conveying rolls in contact with the opposite side of the support to the coated side is preferably from 0° C. to 20° C. in the drying zone, whereby drying unevenness due to unevenness in heat transfer on the conveying rolls can be prevented.

### 3-(5) Curing

After removing the solvent by drying, the film of the invention is conveyed on a web through a zone where each coated film is cured by ionization radiation and/or heating to cure the coated films.

Kinds of ionization radiation in the invention are not particularly limited, and a proper one can properly be selected from among UV rays, electron beams, near-UV rays, visible light, near-infrared rays, infrared rays and X-rays. UV rays and electron beams are preferred, and UV rays are particularly preferred in the point that they are easy to handle and can give a high energy with ease.

As a source of UV rays for photo-polymerizing a UV ray-reactive compound, any source that generates UV rays can be employed. For example, a low-pressure mercury lamp, a middle-pressure mercury lamp, a high-pressure mercury lamp, an ultra-high-pressure mercury lamp, a carbon arc lamp, a metal halide lamp and a xenon lamp can be used. Also, an ArF exima laser, a KrF exima laser, an exima lamp or cynclotron radiation light can be used. Of these, an ultra-high-pressure mercury lamp, a high-pressure mercury lamp, a low-pressure mercury lamp, carbon arc, xenon arc and a metal halide lamp can preferably be utilized.

Electron beams can similarly be used. As electron beams, there are illustrated electron beams released from various electron beam accelerators such as Cockloftwalton accelerator, Vandegraph accelerator, resonant transformer accelerator, insulating-core transformer accelerator, linear accelerator, Dinamitron accelerator and high frequency accelerator having an energy of from 50 to 1,000 keV, preferably from 100 to 300 keV.

Irradiation conditions vary depending upon kind of the lamp, but the irradiation amount is preferably 10 mJ/cm² or more, more preferably from 50 mJ/cm² to 10,000 mJ/cm², particularly preferably from 50 mJ/cm² to 2,000 mJ/cm². Upon irradiation, with the irradiation amount distribution in the depth direction of the web, a distribution of from 50 to 100% based on the maximum irradiation amount at the center including both ends is preferred, with a distribution of from 80 to 100% being more preferred.

In the invention, it is preferred to cure at least one of the layers laminated on the support in the step where irradiation with ionization radiation is conducted in an atmosphere of 10% by volume or less in oxygen concentration, with heating the film surface to 60° C. or higher for 0.5 second or longer from the initiation of irradiation with ionization radiation.

It is also preferred to heat simultaneously with irradiation with ionization radiation and/or continuously in an atmosphere of 3% by volume or less in oxygen concentration.

It is particularly preferred to cure the outermost layer of the low refractive index layer having a small thickness by this method. In this method, the curing reaction is accelerated by heat to form a film excellent in physical strength and chemical resistance.

The period of irradiating with ionization radiation is preferably from 0.7 second to 60 seconds, more preferably from 0.7 second to 10 seconds. In case when the period is not longer than 0.5 second, the curing reaction can not be completed, thus sufficient curing not being performed. Also, to keep the low oxygen condition for a long period requires large-sized equipment and, therefore, requires a large amount of an inert gas, thus not being preferred.

The cross-linking reaction or polymerization reaction of the ionization radiation-curable compound is conducted in an atmosphere of preferably 6% by volume or less, more preferably 4% by volume or less, particularly preferably 2% by volume or less, most preferably 1% by volume or less, in oxygen concentration. To reduce the oxygen concentration more than is necessary requires a large amount of an inert gas such as nitrogen, thus not being preferred in view of production cost.

As a technique for reducing the concentration of oxygen to 10% by volume or less, it is preferred to replace the atmosphere (concentration of nitrogen: about 79% by volume; concentration of oxidation: about 21% by volume) by other gas, particularly preferably by nitrogen (nitrogen purge).

An air entrained by web conveyance can be removed to effectively reduce the oxygen concentration in an ionization radiation-irradiating chamber (hereinafter also referred to as “reaction chamber”) where the curing reaction by ionization radiation is performed, and the substantial oxygen concentration of the extreme surface where oxygen inhibition of curing can effectively be reduced by supplying an inert gas to the reaction chamber and slightly blowing toward the web inlet side of the reaction chamber. The direction of an inert gas on the web inlet side in the reaction chamber can be controlled by adjusting balance between suction and evacuation of the reaction chamber.

It is also preferably employed as a method for removing entrained air by directly blowing an inert gas to the surface of the web.

Also, curing can effectively be conducted by providing a previous room in front of the reaction chamber to previously remove oxygen on the web surface. In the side surface constituting the web inlet side of the reaction chamber or the previous room, the gap between the web surface and the inlet surface is preferably 0.2 to 15 mm, more preferably from 0.2 to 10 mm, most preferably from 0.2 to 5 mm, in order to effectively use the inert gas. However, for continuously producing a continuous web, it is necessary to join webs, and a method of sticking with a joining tape has widely been employed for joining webs. Therefore, in case when the gap between the inlet surface of the reaction chamber or previous chamber is too narrow, there arises a problem of the joining member such as a joining tape being caught. Therefore, in order to narrow the gap, it is preferred to make movable at least part of the inlet surface of the reaction chamber or previous chamber so that, when a joined portion of a web enters through the inlet, the gap can be enlarged by the thickness of the joined portion. In order to realize this, there can be employed a method wherein the inlet surface of the reaction chamber or previous chamber is made movable before and behind in the web-running direction so that the inlet surface can move before and behind upon passing of the joined portion to enlarge the gap, and a method wherein the inlet surface of the reaction chamber or previous chamber is made movable in the vertical direction with respect to the web surface so that, upon passage of the joined portion, the inlet surface can move vertically to enlarge the gap.

Upon curing, the film surface is preferably heated at 60° C. to 170° C. Heating effect can be obtained at a temperature of 60° C. or higher, and problems such as deformation of a substrate can be suppressed at a temperature of 170° C. or lower. A more preferred temperature is from 60° C. to 100° C. The film surface temperature means a film surface temperature of a layer to be cured. The time required for the film to reach the above-mentioned temperature is preferably from 0.1 second to 300 seconds from the initiation of irradiation with UV rays, with the upper limit being more preferably 10 seconds or less. A period of 0.1 second or longer can accelerate reaction of the curable composition, whereas a period of 300 seconds or shorter can prevent deterioration of optical performance of the film. In addition, there does not arise problem with production that large-sized equipment is required.

Heating methods are not particularly limited, but a method of bringing a film into contact with a heated roll, a method of blowing a heated nitrogen gas and a method of irradiating with far-infrared rays or infrared rays are preferred. A method of heating by allowing a medium such as warm water, vapor or oil to flow through a rotary metal roll as described in Japanese Patent 2,523,574 can also be employed. As heating means, dielectric heating rolls may also be used.

UV ray irradiation may be conducted every time one layer is provided for plural layers constituting the film or may be conducted after laminating them. Alternatively, a combination thereof may be employed to irradiate. In view of productivity, it is preferred to irradiate with UV rays after laminating multi-layers.

In the invention, at least one layer laminated on the surface can be cured by plural times of irradiation with ionization radiation. In this case, irradiation of at least two times with ionization radiation is preferably conducted in continuous reaction chambers where the oxygen concentration does not exceed 3% by volume. A reaction period necessary for curing can effectively be ensured by conducting plural-time irradiation with ionization radiation in a reaction chamber where the oxygen concentration is kept at the same level.

Particularly in the case of increasing the production speed for attaining a high productivity, plural-time irradiation with ionization radiation becomes necessary for ensuring energy of ionization radiation necessary for the curing reaction.

Also, in the case where the curing ratio (100-content of residual functional groups) reaches a certain level of less than 100%, adhesion between the lower layer and the upper layer can be improved by making, upon providing the upper layer on the lower layer and curing them by irradiation with ionization radiation and/or heating, the curing ratio of the lower layer higher than that before forming the upper layer, thus such technique being preferred.

### 3-(6) Handling

In order to continuously producing the film of the invention, a step of continuously feeding a support film from a roll-like support film, a step of coating and drying a coating solution, a step of curing the coated film and winding up the support film having thereon cured layers are conducted.

A film support is continuously fed from a roll-like film support to a clean room, and static electricity charged on the film support is removed by means of a static electricity removing apparatus provided in the clean room, and foreign matters deposited on the film support is removed by means of a dust-removing apparatus. Subsequently, coating solutions are applied onto the film support in a coating zone provided in the clean room, and the thus coated film support is fed to a drying chamber to dry.

The film support having the dried coated layers is fed from the drying chamber to a curing chamber, where monomers contained in the coated layers are polymerized to cure. Further, the film support having the cured layers is fed to a curing zone to complete curing, and the film support having the completely cured layers is wound up into a roll.

The above-described steps may be conducted for every time forming each layer or, alternatively, it is also possible to provide plural lines of coating zone-drying chamber-curing zone and continuously conduct formation of individual layers. In order to prepare the film of the invention, it is preferred as described above to conduct fine filtration operation of the coating solutions and, at the same time, conduct the coating step in the coating zone and the drying step conducted in the drying chamber under an atmosphere of highly pure air and, further, sufficiently remove dusts and dirt on the film. The degree of air cleanness in the coating step and the drying step according to the standard of degree of air cleanness described in US Standard 209E is preferably class 10 (number of particles of 0.5 μm or more being 353/m³ or less) or more, more preferably class 1 (number of particles of 0.5 μm or more being 35.5/m³ or less) or more. The degree of air cleanness is preferably at a high level in the film-feeding zone and the film-winding zone as well as the coating-drying steps.

In general, a polarizing plate is mainly constituted by two protective films sandwiching a polarizing film from both sides of the polarizing film. The optical film, particularly the anti-reflection film, of the invention is preferably used as at least one of the two protective films sandwiching the polarizing film from both sides. The production cost of the polarizing plate can be reduced by the optical film of the invention which also functions as a protective film. In particular, use of the anti-reflection film of the invention as the outermost layer serves to provide a polarizing plate which can prevent reflection of external light and which has excellent scratch resistance and stain-proof properties.

As the polarizing film, a polarizing film cut out from a continuous polarizing film whose absorption axis is neither parallel nor vertical to the longitudinal direction may be used. The polarizing film cut out from a continuous polarizing film whose absorption axis is neither parallel nor vertical to the longitudinal direction is prepared according to the following method.

That is, it can be produced by a stretching method wherein a continuously fed polymer film is held at both sides thereof by holding means to stretch, the stretch ratio in the film width direction is at least 1.1 to 20.0 times the original, the difference in proceeding speed in the longitudinal direction between the holding apparatuses on both sides is within 3%, and the film proceeding direction is bent with both sides of the film being held so that the angle between the film proceeding direction at the outlet of the step of holding both sides of the film and the substantial stretching direction of the film is inclined by 20 to 70°. The angle is preferably inclined by 45° in view of productivity.

Regarding the method of stretching a polymer film, detailed descriptions are given in JP-A-2002-86554, paragraphs [0020] to [0030].

It is also preferred that, of the two protective films for the polarizing plate, a film other than the anti-reflection film is an optically-compensatory film having an optically-compensatory layer containing an optical anisotropic layer. The optically-compensatory film (retardation film) can improve viewing angle properties of a liquid crystal display screen.

As the optically-compensatory film, known ones may be used but, in view of enlarging the viewing angle, an optically-compensatory film having an optically-compensatory layer comprising a compound having discotic structural units in which film the angle between the discotic compound and the support varies in the depth direction of the layer, as described in JP-A-2001-100042, is preferred.

The angle preferably increases with the increase in distance of the optically anisotropic layer from the support side.

Of the two protective films for a polarizer, at least one protective film preferably satisfies the following formulae (I) and (II) in view of enhancing display-improving effect in viewing a liquid crystal display screen from the inclined direction:

0≦Re₍₆₃₀₎≦10 and |Rth₍₆₃₀₎|≦25 (I):

|Re₍₄₀₀₎−Re₍₇₀₀₎|≦10 and |Rth₍₄₀₀₎−Rth₍₇₀₀₎|≦35 (II):

wherein Re(λ) represents an in-plane retardation value (nm), Rth(λ) is a retardation value in the thickness direction (nm), and λ is a measuring wavelength.

The optical film of the invention can be applied to an image display device such as a liquid crystal display device (LCD), a plasma display panel (PDP), an electroluminescence display (ELD) and a cathode ray tube display device (CRT). In particular, since the anti-reflection film of the invention has a transparent support, it is used by sticking the transparent support side thereof to the image display surface of an image display device.

The optical film of the invention can preferably be used as one side of a surface-protecting film for a polarizing film in transmission type, reflection type or semi-transmission type liquid crystal display devices of twisted nematic (TN) mode, super-twisted nematic (STN) mode, vertical alignment (VA) mode, in-plane switching (IPS) mode and optically-compensated bend cell (OCB) mode.

As a liquid crystal cell, known ones may be used. Examples of a VA mode liquid crystal cell include (1) a VA mode liquid crystal cell in the narrow sense wherein rod-like liquid crystalline molecules are aligned substantially vertically when no voltage is applied and are aligned substantially horizontally when voltage is applied (described in JP-A-2-176625) and, in addition, (2) an MVA mode liquid crystal cell wherein the VA mode is multidomained in order to enlarge the viewing angle (described in SID 97, Digest of tech. Papers 28 (1997) 845), (3) an n-ASM mode liquid crystal cell wherein rod-like liquid crystalline molecules are aligned substantially vertically when no voltage is applied and are aligned with a twisted multidomain alignment (described in Nippon Ekisho Toronkai, Yokoshu, pp. 58-59 (1998)) and (4) a SUVAIVAL mode liquid crystal cell (published in LCD International 98).

An OCB mode liquid crystal cell is a liquid crystal display device using a bend alignment mode liquid crystal cell wherein rod-like liquid crystalline molecules in the upper portion of the cell and rod-like liquid crystalline molecules in the lower portion of the cell are aligned in substantially reverse directions (symmetrically) to each other and which is disclosed in U.S. Pat. Nos. 4,583,825 and 5,410,422. Since the rod-like liquid crystalline molecules in the upper portion thereof and those in the lower portion are aligned symmetrically with each other, the bend mode liquid crystal cell has a self optically-compensatory function. Therefore, this liquid crystal mode is also called OCB (Optically Compensatory Bend) liquid crystal mode. A bend alignment mode liquid crystal display device has the advantage that response speed is large.

Further, the bend alignment mode liquid crystal cell, together with the polarizing plate including the optically anisotropic layer, preferably has optical properties satisfying the following formula (III) in all measurement conducted at wavelengths of 450 nm, 550 nm and 630 nm, which serves to enhance the effect of improving display when a liquid crystal display screen is viewed from an inclined direction. It is particularly preferred for the polarizing plate having the optical film of the invention as a protective film to satisfy the following formula (III).

0.05<(Δn×d)/(Re×Rth)<0.20 Formula (III):

In formula (III), Δn represents an intrinsic birefringence index of rod-like liquid crystalline molecules in the liquid crystal cell; d represents a thickness of a liquid crystal cell (unit: nm); Re represents an in-plane retardation value of the whole optically anisotropic layer; and Rth represents a retardation value of the whole optically anisotropic layer in the thickness direction.

In an ECB mode liquid crystal cell, rod-like liquid crystalline molecules are aligned substantially horizontally when no voltage is applied, and the cell is most popularly utilized as a color TFT liquid crystal display device and is described in many literatures. For example, it is described in EL, PDP, LCD Display published by Toray Research Center (2001).

With TN mode or IPS mode liquid crystal display devices, a polarizing plate having both anti-reflection effect and viewing angle-enlarging effect with a thickness of one polarizing plate can be obtained by using, as described in JP-A-2001-100043, an optically-compensatory film having the viewing angle-enlarging effect as one of the two protective films provided on both sides of the polarizing film, on the opposite side to the anti-reflection film of the invention, thus such structure being particularly preferred.

### EXAMPLES

The invention will be described in more detail by reference to Examples which, however, do not limit the invention in any way.

Additionally, in Examples, “parts” are by mass.

### Synthesis of Thickening Agent (V-1)

A solution of 1.32 g of sodium oleate and 0.18 g of sodium hydrogen carbonate in 332 g of distilled water was placed in a 1000-ml reactor equipped with a stirrer, a monomer-supplying tank, a thermometer, a cooling tube and a nitrogen gas-introducing tube, followed by heating to 65° C. in an atmosphere of nitrogen. Subsequently, 38 mg of potassium persulfate dissolved in 30 g of distilled water was added thereto, and the mixture was stirred for 30 minutes. Then, 132 g of ethyl methacrylate was dropwise added thereto over 5.5 hours and, after completion of the dropwise addition, the mixture was further heated for 6 hours under stirring. The mixture was then cooled to room temperature and, after filtering off insolubles, was dropwise added to 0.05 mol/dm³ of dilute sulfuric acid, followed by stirring for 1 hour. A solid product precipitated was collected by filtration, well washed with water, and dried under reduced pressure to obtain a thickening agent (V-1). Molecular mass measurement according to gel permeation chromatography (GPC) using tetrahydrofuran as a solvent revealed that the mass-average molecular mass of the product in terms of polystyrene is 2.0×10⁶. The viscosity of a 3% by mass solution of the thickening agent (V-1) in 2-butanone was found to be 20 [mPa·sec].

### (Preparation of a Sol Solution a-1)

187 g (0.80 mol) of acryloyloxypropyltrimethoxysilane, 29.0 g (0.21 mol) of methyltrimethoxysilane, 320 g (10 mols) of methanol and 0.06 g (0.001 mol) of KF were charged in a 1,000-ml reactor equipped with a thermometer, a nitrogen-introducing tube and a dropping funnel, and 17.0 g (0.94 mol) of water was slowly dropwise added thereto at room temperature under stirring. After completion of the dropwise addition, the mixture was heated for 2 hours while stirring under reflux of methanol. Then, low-boiling components were distilled off under reduced pressure, followed by filtering to obtain 120 g of a sol solution a-1. GPE measurement of the thus-obtained substance revealed that the mass-average molecular mass of the substance is 1500 and that, of the components having a molecular mass equal to or more than that of oligomer, components of 1000 to 20000 in molecular mass amount to 30%.

Also, from the results of measurement of 1H-NMR, the resulting substance was found to have the following composition formula.

Average composition formula:

(CH₂═COO—C₃H₆)_{0.8}(CH₃)_{0.2}SiO_{0.86}(OCH₃)_{1.28}

Further, the condensation ratio α determined by measurement of ²⁹Si-NMR was 0.59. This analytical result revealed that this silane coupling agent sol had a structure wherein straight-chain structure constitutes most portions thereof.

Also, gas chromatography analysis revealed that the remaining ratio of starting acryloxypropyltrimethoxysilane was 5% or less.

### (Preparation of a Sol Solution a-2)

119 Parts of methyl ethyl ketone, 101 parts of acryloyloxypropyltrimethoxysilane (KBM5103; manufactured by Shin-etsu Chemical Co., Ltd.) and 3 parts of diisopropoxyaluminum ethyl acetoacetate were added to a reactor equipped with a stirrer and a reflux condenser and, after mixing, 30 parts of ion-exchanged water was added thereto. After reacting at 60 C for 4 hours, the reaction solution was cooled to room temperature to obtain a sol solution a-2.

The mass-average molecular mass of the sol solution a-2 was 1600 and, of the components having a molecular mass equal to or more than that of oligomer, components of 1000 to 20000 in molecular mass amount to 100%. Also, gas chromatography analysis revealed that starting acryloxypropyltrimethoxysilane did not remain at all.

### (Synthesis of a Perfluoroolefin Copolymer (1))

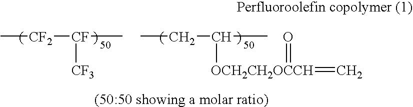

40 ml of ethyl acetate, 14.7 g of hydroxyethyl vinyl ether and 0.55 g of dilauroyl peroxide were charged in a stainless steel-made autoclave of 100 ml in the inside volume equipped with a stirrer, and the system was degassed and replaced by a nitrogen gas. Further, 25 g of hexafluoropropylene (HFP) was introduced into the autoclave, and the temperature was increased to 65° C. The pressure at the point where the temperature inside the autoclave reached 65° C. was 5.4 kg/cm². The reaction was continued for 8 hours with keeping the temperature at the level and, at the point where the pressure reached 3.2 kg/cm², heating was discontinued, and the reaction system was allowed to cool. At the point where the inside temperature decreased to room temperature, unreacted monomers were removed, and the autoclaved was opened to take out a reaction solution. The thus-obtained reaction solution was added to a large excess of hexane, and the solvent was removed by decantation to take out a precipitated polymer. This polymer was dissolved in a small amount of ethyl acetate and reprecipitated twice from hexane to completely remove remaining monomers. After drying, 28 g of the polymer was obtained. Next, 20 g of the polymer was dissolved in 100 ml of N,N-dimethylacetamide and, after dropwise adding thereto 11.4 g of acryl chloride under cooling in ice-water, the mixture was stirred for 10 hours at room temperature. Ethyl acetate was added to the reaction solution, and the mixture was washed with water. After extraction, the organic layer was concentrated, and the resulting polymer was reprecipitated from hexane to obtain 19 g of a perfluoroolefin copolymer (1). The refractive index of the thus-obtained polymer was 1.421.

### Examples 1-1 to 1-11 and Comparative Examples 1-1 to 1-5

### (Preparation of a Coating Solution for Forming a Hard Coat Layer)

Components described in the following Table 1 were mixed and then filtered through a polypropylene-made filter of 30 μm in pore size to prepare coating solutions for forming a hard coat layer, HL-1 to HL-14.

Additionally, in Table 1, the amount of each component is shown in part by mass.

TABLE 1

| | HL-1 | HL-2 | HL-3 | HL-4 | HL-5 | HL-6 | HL-7 |
|---|---|---|---|---|---|---|---|
| Thickening agent V-1 | 0.5 | 1.4 | 4.1 | 4.1 | 4.1 | | |
| STN | | | | | | 0.5 | 1.4 |
| Polymethyl methacrylate | | | | | | | |
| SAN | | | | | | | |
| PET-30 | 30.6 | 29.7 | 27.1 | 27.1 | 27.1 | 30.6 | 29.7 |
| DPHA | 1.6 | 1.6 | 1.4 | 1.4 | 1.4 | 1.6 | 1.6 |
| Sol solution a-1 | 8.1 | 8.1 | 8.1 | 8.1 | 8.1 | 8.1 | 8.1 |
| Irgacure 184 | 1.6 | 1.6 | 1.6 | 1.6 | 1.6 | 1.6 | 1.6 |
| Dispersion of 8-μm size cross- | 9.0 | 9.0 | 9.0 | | | 9.0 | 9.0 |
| linked polymethyl | | | | | | | |
| methacrylate particfles | | | | | | | |
| Dispersion of 3.5-μm size | | | | 9.0 | | | |
| cross-linked polymethyl | | | | | | | |
| methacrylate particfles | | | | | | | |
| Dispersion of 17-μm size | | | | | 9.0 | | |
| cross-linked polymethyl | | | | | | | |
| methacrylate particfles | | | | | | | |
| Methyl ethyl ketone | 15.7 | 15.7 | 15.7 | 15.7 | 15.7 | 15.7 | 15.7 |
| Methyl isobutyl ketone | 33.0 | 33.0 | 33.0 | 33.0 | 33.0 | 33.0 | 33.0 |
| | HL-8 | HL-9 | HL-10 | HL-11 | HL-12 | HL-13 | HL-14 |
| Thickening agent V-1 | | | 5.4 | | | | |
| STN | 4.1 | | | 5.4 | | | |
| Polymethyl methacrylate | | | | | 1.4 | 5.4 | |
| SAN | | | | | | | 1.4 |
| PET-30 | 27.1 | 31.0 | 25.9 | 25.9 | 29.7 | 25.9 | 29.7 |
| DPHA | 1.4 | 1.6 | 1.4 | 1.4 | 1.6 | 1.4 | 1.6 |
| Sol solution a-1 | 8.1 | 8.1 | 8.1 | 8.1 | 8.1 | 8.1 | 8.1 |
| Irgacure 184 | 1.6 | 1.6 | 1.6 | 1.6 | 1.6 | 1.6 | 1.6 |
| Dispersion of 8-μm size cross- | 9.0 | 9.0 | 9.0 | 9.0 | 9.0 | 9.0 | 9.0 |
| linked polymethyl | | | | | | | |
| methacrylate particfles | | | | | | | |
| Dispersion of 3.5-μm size | | | | | | | |
| cross-linked polymethyl | | | | | | | |
| methacrylate particfles | | | | | | | |
| Dispersion of 17-μm size | | | | | | | |
| cross-linked polymethyl | | | | | | | |
| methacrylate particfles | | | | | | | |
| Methyl ethyl ketone | 15.7 | 15.7 | 15.7 | 15.7 | 15.7 | 15.7 | 15.7 |
| Methyl isobutyl ketone | 33.0 | 33.0 | 33.0 | 33.0 | 33.0 | 33.0 | 33.0 |

### (Preparation of a Coating Solution for Forming a Low Refractive Index Layer LL-1)

| | |
|---|---|
| JTA-113 | 63.7 g |
| MEK-ST-L | 6.4 g |
| Sol solution a-2 | 2.9 g |
| Methyl ethyl ketone | 24.5 g |
| Cyclohexanone | 2.9 g |

The above-described components were mixed and filtered through a polypropylene-made filter of 1 μm in pore size to prepare a coating solution for forming a low refractive index layer LL-1. The refractive index of a layer formed from this coating solution was 1.45.

### (Preparation of a Coating Solution for Forming a Low Refractive Index Layer LL-2)

| | |
|---|---|
| Perfluoroolefin copolymer (1) | 15.0 g |
| described above (solid content: 39%) | |
| X-22-164C | 0.15 g |
| Irgacure 907 | 0.23 g |
| Sol solution a-2 | 0.6 g |
| Methyl ethyl ketone | 81.8 g |
| Cyclohexanone | 2.8 g |

The above-described components were mixed and filtered through a polypropylene-made filter of 1 μm in pore size to prepare a coating solution for forming a low refractive index layer LL-2. The refractive index of a layer formed from this coating solution was 1.43.

### (Preparation of a Coating Solution for Forming a Low Refractive Index Layer C-3)

| | |
|---|---|
| JTA-113 | 73.0 g |
| Hollow silica solution | 19.5 g |
| Sol solution a-2 | 1.7 g |
| Methyl ethyl ketone | 47.5 g |
| Cyclohexanone | 5.3 g |

The above-described components were mixed and filtered through a polypropylene-made filter of 1 μm in pore size to prepare a coating solution for forming a low refractive index layer LL-3. The refractive index of a layer formed from this coating solution was 1.39.

Components used are shown below.
KBM-5103: Silane coupling agent (acryloxypropyl-trimethoxysilane; manufactured by Shin-Etsu Chemical Co., Ltd.)
PET-30: Mixture of pentaerythritol triacrylate and pentaerythritol tetraacrylate (manufactured by Nippon Kayaku)
3.5 μm size cross-linked polymethyl methacrylate particles: Cross-linked polymethyl methacrylate particles of 3.5 μm in average particle size; 30% dispersion in methyl ethyl ketone; dispersed in a Polytron dispersing machine at 10000 rpm for 20 minutes before use
8 μm size cross-linked polymethyl methacrylate particles: Cross-linked polymethyl methacrylate particles of 8.0 μm in average particle size; 30% dispersion in methyl ethyl ketone; dispersed in a Polytron dispersing machine at 10000 rpm for 20 minutes before use
17 μm size cross-linked polymethyl methacrylate particles: Cross-linked polymethyl methacrylate particles of 17 μm in average particle size; 30% dispersion in methyl ethyl ketone; dispersed in a Polytron dispersing machine at 10000 rpm for 20 minutes before use
DPHA: Mixture of dipentaerythritol pentaacrylate and dipentaerythritol hexaacrylate (manufactured by Nippon Kayaku)
Irgacure 184: A polymerization initiator [manufactured by Ciba Specialty Chemicals]
STN: Synthesized smectite, Lucentite STN [manufactured by CO-OP CHEMICAL CO., LTD.], viscosity of 3% by mass dispersion in 2-butanone: 18 [mPa·sec]
SAN: Synthesized smectite, Lucentite SAN [manufactured by CO-OP CHEMICAL CO., LTD.], viscosity of 3% by mass dispersion in 2-butanone: 7 [mPa·sec]
Polymethyl methacrylate: Polymethyl methacrylate powder (mass-average molecular mass: 120000; manufactured by Aldrich), viscosity of 3% by mass dispersion in 2-butanone: 3 [mPa·sec]
MEK-ST-L: A dispersion of colloidal silica [different from MEK-ST in particle size; average particle size: 45 nm; content of solid components: 30%; manufactured by Nissan Chemical Industries, Ltd.]
Hollow silica dispersion: KBM-5103 surface-modified hollow silica sol [surface modification ratio based on silica: 30% by mass; CS-60 IPA; refractive index: 1.31; average particle size: 60 nm; shell thickness: 10 nm; content of solid components: 18.2%; manufactured by Shokubai Kasei Kogyo K.K.]
X-22-164C: Reactive silicone [Shin-Etsu Chemical Co., Ltd.]
JTA113: Thermally cross-linkable, fluorine-containing polymer of 1.44 in refractive index containing polysiloxane and hydroxyl group (content of solid components: 6%; manufactured by JSR)
Irgacure 907: A photo polymerization initiator (manufactured by Ciba Specialty Chemicals)

### (Preparation of Anti-Reflection Films B-1 to B-16)

### (1) Providing a Hard Coat Layer by Coating

A 80-μm thick triacetyl cellulose film (FUJITAC TD80UF; manufactured by Fuji Photo Film Co., Ltd.; Re=2 nm; Rth=48 nm) was unwound, and each of coating solutions HL-1 to HL-14 for forming a hard coat layer was coated thereon according to a die coating method under the following fundamental conditions using a coater shown in FIG. 6 and, after drying at 30° C. for 15 seconds, then at 90° C. for 20 seconds, was irradiated with UV rays under nitrogen purge in an irradiation amount of 60 mJ/cm² using a 160 W/cm air-cooled metal halide lamp (manufactured by Eye Graphics Co., Ltd.) to cure the coated layer, thus a hard coat layer being formed and wound up. Thus, triacetyl cellulose films A-1 to A-16 each having provided thereon a hard coat layer were prepared. The thickness of each hard coat layer was shown in Table 2.

### (2) Providing a Low Refractive Index Layer by Coating

Each of the triacetyl cellulose films A-1 to A-16 having provided thereon a hard coat layer was again unwound, and the coating solution LL-1 for forming a low refractive index layer was coated under the following fundamental conditions and, after drying at 120° C. for 150 seconds then at 100° C. for 8 minutes, was irradiated with UV rays under nitrogen purge in an irradiation amount of 300 mJ/cm² in an atmosphere of 0.1% in oxygen concentration using a 240 W/cm air-cooled metal halide lamp (manufactured by Eye Graphics Co., Ltd.) to cure the coated layer, thus a 95-nm thick low refractive index layer being formed and wound up. Thus, anti-reflection films B-1 to B-16 were prepared.

Fundamental conditions: The coating solution was fed from the pocket 15, and was applied through the slot 16. The slot 50 was not used. The slot die 13 used had an upstream side lip land length I_{UP} of 0.5 mm, a downstream side lip land length I_{LO} of 50 μm, an opening length of the slot 16 in the web-running direction of 150 μm, and a slot 16 length of 50 mm. The gap between the upstream side lip land 18 a and the web W was made longer by 50 μm than the gap between the downstream side lip land 18b and the web W, and the gap G_{L} between the downstream lip land 18b and the web W was adjusted to 50 μm. Also, the gap Gs between the side plate 40b of a pressure-reduced chamber 40 and the web W and the gap G_{B} between the back plate 40a and the web W were both adjusted to 200 μm. Coating conditions were selected according to the physical properties of the coating solutions. Coating of the hard coat layer was conducted at a coating speed of 30 m/min and a wet coated amount of 30 ml/m², whereas coating of the low refractive index layer was conducted at a coating speed of 30 m/min and a wet coated amount of 5.0 ml/m². Additionally, the coating width was 1300 mm, with the effective width being 1280 mm.

### (Evaluation of Optical Films)

These optical film samples thus obtained were evaluated with respect to the following items. Results are shown in Table 2.

### (1) Average Reflectance

The integrated spectral reflectance at an incident angle of 5° was measured by roughening the back side of a film with sand paper and then treating it with a black ink to remove back side reflection, and measuring the surface side in a wavelength region of from 380 to 780 nm using a spectrophotometer (manufactured by Nihon Bunko K.K.). The results were shown in terms of arithmetical means of the integrated reflectance values in the range of from 450 to 650 nm.

### (2) Haze

The internal haze (Hi) and the surface haze (Hs) of each of the resultant films were measured according to the following measurement.

### 1. The total haze value (H) of each of the resultant films was measured according to JIS-K7136.

2. Several drops of silicone oil were applied to the surface of each of the resultant films on the low refractive index layer side and to the back side thereof, and the film was sandwiched between two glass plates of 1 mm in thickness (micro slide glass; product No. S9111; manufactured by MATSUNAMI) to optically completely contact the two glass plates and the film and remove the surface haze. The haze was measured in this state. Separately, haze was measured by sandwiching only silicone oil between the two glass plates. A value obtained by subtracting the separately measured haze from the first measured haze, thus the internal haze (Hi) being calculated.

### 3. A value obtained by subtracting the internal haze (Hi) calculated in the above item 2 from the total haze (H) measured in the above item 1 was taken as the surface haze (Hs) of the film.

### (White Blurring)

The anti-reflection film on the viewing side of the polarizing plate on the surface side of an LCD television panel (VA mode) was replaced by each of the anti-reflection films B-1 to B-16 to give a black display all over the screen, an uncovered fluorescent lamp (8000 cd/m²) with no louvers was reflected in a dark room with an angle of 60 degrees from the left side, and white glistening state (white blurring) of the whole screen viewed with an angle of 45 degrees from the right side was evaluated according to the following standard. Samples of o level or more were evaluated as being acceptable.

oo: The screen gave a strong blackness and appeared tight.
o: The screen gave a black, but slightly grayish, color and appeared somewhat tight.

### Δ: The screen gave a black but grayish color, and appeared weakly tight.

x: The screen gave a considerably grayish color, and has no tightness.

### (5) Surface State

The side of the anti-reflection film on which side the hard coat layer and the low refractive index layer were not laminated was rubbed with a paper file, and then painted out by a black felt pen in an area of 40 cm×40 cm. The surface state of the anti-reflection film was visually observed by 5 observers. Samples with which all of 5 observers failed to find unevenness were ranked as oo, samples with which one or less obserbers could find unevenness were ranked as o, and samples with which two or more observers could find unevenness were ranked as x. Anti-reflection film samples ranked as o or higher involve no practical problems, and have a preferred surface state.

### (6) Pencil Hardness

In the invention, pencil hardness was measured as an index of scratch resistance. The pencil hardness is a value of pencil hardness of a testing pencil which does not scratch the anti-reflection film under a load of 9.8 N in the pencil hardness evaluating method described in JIS-K-5400 using testing pencils described in JIS-S-6006, said film having been conditioned for 2 hours at a temperature of 25° C. and a relative humidity of 60%.

### (7) Curling

A 20 cm×20 cm optical film sample was cut out, and was placed on a horizontal desk in an environment of 25° C. and 60% RH with the side whose 4 corners rose facing upward. After 24 hours, the distance of each corner having risen from the desk surface was measured using a ruler, and distances of the four corners were averaged. The average value was evaluated by classifying according to the following standard.

o: less than 20 mm
x: 20 mm or more

TABLE 2

| | Example | Compa-rative | Example | Example | Example | Example | Example | Example |
|---|---|---|---|---|---|---|---|---|
| | 1-1 | Example 1-1 | 1-2 | 1-3 | 1-4 | 1-5 | 1-6 | 1-7 |
| Anti-reflection film | B-1 | B-2 | B-3 | B-4 | B-5 | B-6 | B-7 | B-8 |
| Coating solution for | HL-1 | HL-2 | HL-2 | HL-2 | HL-3 | HL-4 | HL-5 | HL-6 |
| hard coat layer | | | | | | | | |
| Thickness of hard coat | 15 μm | 4 μm | 15 μm | 25 μm | 15 μm | 15 μm | 15 μm | 15 μm |
| layer | | | | | | | | |
| Surface haze | 3 | 12 | 4 | 5 | 4 | 2 | 6.8 | 5 |
| Internal haze | 20 | 20 | 20 | 20 | 20 | 20 | 20 | 20 |
| Average reflectance | 2.7% | 2.7% | 2.6% | 2.6% | 2.8% | 2.6% | 2.7% | 2.7% |
| Surface state | ∘∘ | ∘ | ∘∘ | ∘ | ∘∘ | ∘ | ∘ | ∘∘ |
| Pencil hardness | 5H | 2H | 5H | 6H | 5H | 5H | 5H | 5H |
| White blurring | ∘ | x | ∘ | ∘ | ∘ | ∘ | ∘ | ∘ |
| Curling | ∘ | ∘ | ∘ | x | ∘ | ∘ | ∘ | ∘ |
| | | | Comparative | | | Comparative | Comparative | Comparative |
| | Example | Example | Example | Example | Example | Example | Example | Example |
| | 1-8 | 1-9 | 1-2 | 1-10 | 1-11 | 1-3 | 1-4 | 1-5 |
| Anti-reflection film | B-9 | B-10 | B-11 | B-12 | B-13 | B-14 | B-15 | B-16 |
| Coating solution for hard | HL-7 | HL-8 | HL-9 | HL-10 | HL-11 | HL-12 | HL-13 | HL-14 |
| coat layer | | | | | | | | |
| Thickness of hard coat | 15 μm | 15 μm | 15 μm | 15 μm | 15 μm | 15 μm | 15 μm | 15 μm |
| layer | | | | | | | | |
| Surface haze | 6 | 3 | 3 | 4 | 5 | 7 | 6 | 4 |
| Internal haze | 20 | 20 | 20 | 20 | 20 | 20 | 20 | 20 |
| Average reflectance | 2.6% | 2.7% | 2.6% | 2.8% | 2.8% | 2.7% | 2.6% | 2.8% |
| Surface state | ∘∘ | ∘∘ | x | ∘ | ∘ | x | x | x |
| Pencil hardness | 5H | 5H | 5H | 2H | 2H | 5H | 2H | 5H |
| White blurring | ∘ | ∘ | ∘ | ∘ | ∘ | ∘ | ∘ | ∘ |
| Curling | ∘ | ∘ | ∘ | ∘ | ∘ | ∘ | ∘ | ∘ |

As is apparent from the results shown in Table 2, the anti-reflection films using the thickening agents of the invention do not generate surface state unevenness and have sufficiently ensured film hardness. Further surprisingly, white blurring was prevented, and curling was suppressed and, in addition, surface state is more improved, thus anti-reflection films having high quality being obtained, by adjusting the particle size of the particles and the thickness of the hard coat layer to those within the ranges of the invention. When the thus-obtained anti-reflection films of the invention are provided all over the surface of an image display device, no unevenness generates and white blurring is suppressed, and hence there can be obtained a display device having a high display quality and a high film hardness which serves to give excellent scratch resistance.

### Examples 2-1 to 2-15 and Comparative Examples 2-1 to 2-5

### (Preparation of Anti-Reflection Films C-1 to C-20 by Simultaneous Double-Layer Coating)

### (1) Providing a Hard Coat Layer by Coating

A 80-μm thick triacetyl cellulose film (FUJITAC TD80UF; manufactured by Fuji Photo Film Co., Ltd.; Re=2 nm; Rth=48 nm) was unwound, and each of coating solutions HL-1 to HL-14 for forming a hard coat layer and each of coating solutions LL-1 to LL-3 for forming a low refractive index layer were coated thereon according to a die coating method under the following conditions shown in Table 3 using a coater shown in FIG. 6 under the following fundamental conditions and, after drying at 30° C. for 15 seconds, then at 90° C. for 60 seconds, was irradiated with UV rays in an atmosphere of 0.1% in oxygen concentration under nitrogen purge in an irradiation amount of 300 mJ/cm² using a 240 W/cm air-cooled metal halide lamp (manufactured by Eye Graphics Co., Ltd.) and, further, dried for 8 minutes at 100 C to cure the coated layers, thus anti-reflection films C-1 to C-20 being prepared. However, in the case of using LL-2 as a coating solution for forming a low refractive index layer, drying at 100° C. for 8 minutes was omitted. Fundamental conditions: The coating solution for forming a hard coat layer was fed from the pocket 15, and was applied through the slot 16. The coating solution for forming a low refractive index layer was fed from the pocket 50 and was applied along the slide 51. The slot die 13 used had an upstream side lip land length I_{UP} of 0.5 mm, a downstream side lip land length I_{LO} of 50 μm, an opening length of the slot 16 in the web-running direction of 150 μm, and a slot 16 length of 50 mm. The gap between the upstream side lip land 18 a and the web W was made longer by 50 μm than the gap between the downstream side lip land 18b and the web W, and the gap G_{L} between the downstream lip land 18b and the web W was adjusted to 50 μm. Also, the gap G_{S} between the side plate 40b of a pressure-reduced chamber 40 and the web W and the gap G_{B} between the back plate 40a and the web W were both adjusted to 200 μm. The length of the slide 51 from the outlet 52a of the slot 52 to the coating zone was adjusted to 5 mm. A cover designated by 55 in FIG. 6 was provided over the slot die shown in FIG. 7A so that the cross-sectional area surrounded by a cover 55, the slide surface and the backup roll became 59.5 mm². Coating was conducted under the conditions of: coating speed=30 m/min; a wet coated amount of a coating solution for the hard coat layer=30 ml/m²; a wet coated amount of a coating solution for the low refractive index layer=5.0 ml/m². Additionally, the coating width was 1300 mm, with the effective width being 1280 mm.

The thus-obtained optical film samples were evaluated with respect to the same items as described above. Results are shown in Table 3.

TABLE 3

| | | Comparative | | | | | | |
|---|---|---|---|---|---|---|---|---|
| | Example | Example | Example | Example | Example | Example | Example | Example |
| | 2-1 | 2-1 | 2-2 | 2-3 | 2-4 | 2-5 | 2-6 | 2-7 |
| Anti-reflection film | C-1 | C-2 | C-3 | C-4 | C-5 | C-6 | C-7 | C-8 |
| Coating solution for | HL-1 | HL-2 | HL-2 | HL-2 | HL-2 | HL-2 | HL-3 | HL-4 |
| forming hard coat | | | | | | | | |
| layer | | | | | | | | |
| Coating solution for | LL-1 | LL-1 | LL-1 | LL-1 | LL-2 | LL-3 | LL-1 | LL-1 |
| forming low refractive | | | | | | | | |
| index layer | | | | | | | | |
| Thickness of hard coat | 15 μm | 4 μm | 15 μm | 25 μm | 15 μm | 15 μm | 15 μm | 15 μm |
| layer | | | | | | | | |
| Surface haze | 3 | 12 | 4 | 5 | 5 | 5 | 4 | 2 |
| Internal haze | 20 | 20 | 20 | 20 | 20 | 20 | 20 | 20 |
| Average reflectance | 2.7% | 2.7% | 2.9% | 2.7% | 2.9% | 2.0% | 2.7% | 2.7% |
| Surface state | ∘∘ | ∘ | ∘∘ | ∘ | ∘∘ | ∘∘ | ∘∘ | ∘ |
| Pencil hardness | 5H | 2H | 5H | 6H | 5H | 5H | 5H | 5H |
| White blurring | ∘∘ | x | ∘∘ | ∘ | ∘∘ | ∘∘ | ∘∘ | ∘ |
| Curling | ∘ | ∘ | ∘ | ∘ | ∘ | ∘ | ∘ | ∘ |
| | | | | | | | Comparative | |
| | Example | Example | Example | Example | Example | Example | Example | Example |
| | 2-8 | 2-9 | 2-10 | 2-11 | 2-12 | 2-13 | 2-2 | 2-14 |
| Anti-reflection film | C-9 | C-10 | C-11 | C-12 | C-13 | C-14 | C-15 | C-16 |
| Coating solution for | HL-5 | HL-6 | HL-7 | HL-7 | HL-7 | HL-8 | HL-9 | HL-10 |
| forming hard coat layer | | | | | | | | |
| Coating solution for | LL-1 | LL-1 | LL-1 | LL-2 | LL-3 | LL-1 | LL-1 | LL-1 |
| forming low refractive | | | | | | | | |
| index layer | | | | | | | | |
| Thickness of hard coat | 15 μm | 15 μm | 15 μm | 15 μm | 15 μm | 15 μm | 15 μm | 15 μm |
| layer | | | | | | | | |
| Surface haze | 6.8 | 5 | 6 | 6 | 6 | 3 | 3 | 4 |
| Internal haze | 20 | 20 | 20 | 20 | 20 | 20 | 20 | 20 |
| Average reflectance | 2.8% | 2.9% | 2.9% | 2.8% | 1.9% | 2.9% | 2.8% | 2.7% |
| Surface state | ∘ | ∘∘ | ∘∘ | ∘∘ | ∘∘ | ∘∘ | x | ∘ |
| Pencil hardness | 5H | 5H | 5H | 5H | 5H | 5H | 5H | 2H |
| White blurring | ∘ | ∘∘ | ∘∘ | ∘∘ | ∘∘ | ∘∘ | ∘ | ∘ |
| Curling | ∘ | ∘ | ∘ | x | ∘ | ∘ | ∘ | ∘ |

| | | Compara-tive | Compara-tive | Compara-tive |
|---|---|---|---|---|
| | Example 2-15 | Example 2-3 | Example 2-4 | Example 2-5 |
| Anti-reflection film | C-17 | C-18 | C-19 | C-20 |
| Coating solution for | HL-11 | HL-12 | HL-13 | HL-14 |
| forming hard coat layer | | | | |
| Coating solution for | LL-1 | LL-1 | LL-1 | LL-1 |
| forming low refractive | | | | |
| index layer | | | | |
| Thickness of hard coat | 15 μm | 15 μm | 15 μm | 15 μm |
| layer | | | | |
| Surface haze | 5 | 7 | 6 | 4 |
| Internal haze | 20 | 20 | 20 | 20 |
| Average reflectance | 2.8% | 2.8% | 2.6% | 2.8% |
| Surface state | ∘ | x | x | x |
| Pencil hardness | 2H | 5H | 2H | 5H |
| White blurring | ∘ | ∘ | ∘ | ∘ |
| Curling | ∘ | ∘ | ∘ | ∘ |

What is claimed is:

1. An optical film, which comprises:
a transparent support; and
an optical layer on or above the transparent support,
wherein the optical layer contains a thickening agent which shows a viscosity of 10 mPa·sec or more when added to 2-butanone in a content of 3% by mass, and
the optical layer has a thickness of 5 μm or more.

2. The optical film according to claim 1,
wherein the thickening agent is a thixotropic agent, and
the optical layer contains the thixotropic agent in a content of from 0.01 to 5% by mass.

3. The optical film according to claim 1,
wherein the thickening agent is a high molecular mass polymer of from 500,000 to 5,000,000 in mass-average molecular mass, and
the optical layer contains the high molecular polymer in a content of from 0.01 to 5% by mass.

4. The optical film according to claim 1,
wherein the optical layer contains light-transmitting particles having an average particle size of from 5 to 15 μm.

5. The optical film according to claim 1,
wherein the thickness of the optical layer is from 5 to 20 μm.

6. The optical film according to claim 1, which has a surface haze of 7% or less and an internal haze of 30% or less.

7. An anti-reflection film, which comprises:
an optical film according to claim 1 that comprises a hard coat layer as the optical layer; and
a low refractive index layer on or above the hard coat layer.

8. A process for producing an optical film, which comprises:
forming an optical film according to claim 1 by coating.

9. A process for producing an anti-reflection film, which comprises:
forming an anti-reflection film according to claim 7 by coating.

10. The process for producing an anti-reflection film according to claim 9,
wherein the hard coat layer and the low refractive index layer are formed at once without winding up.

11. The process for producing an anti-reflection film according to claim 10,
wherein the hard coat layer is coated on the transparent support using a slot die while the transparent support is allowed to run continuously on a supporting backup roller, and
the low refractive index layer is coated on the hard coat layer using a slide type coating head disposed in a vicinity of a tip of the slot die.

12. A polarizing plate, which comprises:
a pair of protective films; and
a polarizing film between the pair of protective films,
wherein at least one of the pair of protective films is an optical film according to claim 1.

13. A polarizing plate, which comprises:
a pair of protective films; and
a polarizing film between the pair of protective films,
wherein at least one of the pair of protective films is an anti-reflection film according to claim 7.

14. An image display device, which comprises an optical film according to claim 1 on a viewing side of a display screen.
